(19) United States
(12) Patent Application Publication
(10) Pub. No.: US 2026/0051440 A1
(43) Pub. Date: Feb. 19, 2026

(54) MULTILAYER CAPACITOR

(71) Applicant: Murata Manufacturing Co., Ltd., Nagaokakyo-shi (JP)

(72) Inventors: Yuu MIKAMI, Nagaokakyo-shi (JP); Yuichiro TANAKA, Nagaokakyo-shi (JP)

(21) Appl. No.: 19/366,820

(22) Filed: Oct. 23, 2025

Related U.S. Application Data
(63) Continuation of application No. PCT/JP2024/013792, filed on Apr. 3, 2024.

(30) Foreign Application Priority Data
Jun. 6, 2023 (JP) 2023-093217

(51) Int. Cl. H01G 4/012; H01G 4/008; H01G 4/18; H01G 4/232; H01G 4/33

(52) U.S. Cl. CPC H01G 4/012; H01G 4/008; H01G 4/18; H01G 4/2325; H01G 4/33

(57) ABSTRACT

A multilayer capacitor includes a multilayer body, and first and second outer electrodes on any one or more of first and second principal surfaces, first and second side surfaces, and first and second end surfaces of the multilayer body. The multilayer body includes an inner layer portion including inner resin layers, and first and second internal electrode layers each between two of the inner resin layers and exposed at any one or more of the first and second principal surfaces, the first and second side surfaces, and the first and second end surfaces.

### CROSS REFERENCE TO RELATED APPLICATIONS

This application claims the benefit of priority to Japanese Patent Application No. 2023-093217 filed on Jun. 6, 2023 and is a Continuation Application of PCT Application No. PCT/JP2024/013792 filed on Apr. 3, 2024. The entire contents of each application are hereby incorporated herein by reference.

### BACKGROUND OF THE INVENTION

### 1. Field of the Invention

The present invention relates to multilayer capacitors.

### 2. Description of the Related Art

With the advance of electronic devices, miniaturization, high performance, and mechanical strength of electronic components are desired. A multilayer ceramic capacitor described in, for example, Japanese Unexamined Patent Application Publication No. 2018-032788 is known as an electronic component. Japanese Unexamined Patent Application Publication No. 2018-032788 describes a multilayer ceramic capacitor that includes a multilayer body in which dielectric layers, including ceramic as a main component, and internal electrode layers are alternately laminated, and a pair of outer electrodes.

It is known that equivalent series resistance (ESR) and equivalent series inductance (ESL) influence the frequency characteristics of multilayer ceramic capacitors. In the multilayer ceramic capacitor described in Japanese Unexamined Patent Application Publication No. 2018-032788 or the like, the multilayer body and the outer electrodes are fired at the same time to improve the contact between the internal electrode layers of the multilayer body and the outer electrodes, thus reducing the ESR.

However, when the multilayer body and the outer electrodes are fired at the same time as in the case of Japanese Unexamined Patent Application Publication No. 2018-032788, there has been a risk that the shapes of the end portions of the internal electrode layers become irregular or voids occur in the internal electrode layers as a result of the over-sintering of metal components of the internal electrode layers having a lower sintering temperature due to the difference in sintering temperature between dielectric components included in the dielectric layer and metal components included in the internal electrode layers and the outer electrodes. When the shapes of the internal electrode layers become irregular, the current path extends, which leads to an inconvenience that the ESR increases.

### SUMMARY OF THE INVENTION

Example embodiments of the present invention provide multilayer capacitors each with reduced ESR and improved mechanical strength.

A multilayer capacitor according to an example embodiment of the present invention includes a multilayer body including a first principal surface and a second principal surface opposite to each other in a lamination direction, a first side surface and a second side surface opposite to each other in a width direction orthogonal or substantially orthogonal to the lamination direction, and a first end surface and a second end surface opposite to each other in a length direction orthogonal or substantially orthogonal to the lamination direction and the width direction, a first outer electrode on one or more of the first principal surface, the second principal surface, the first side surface, the second side surface, the first end surface, and the second end surface of the multilayer body, and a second outer electrode on one or more of the first principal surface, the second principal surface, the first side surface, the second side surface, the first end surface, and the second end surface of the multilayer body, wherein the multilayer body includes an inner layer portion including multiple inner resin layers laminated in the lamination direction, a first internal electrode layer between two of the multiple inner resin layers and exposed at any one or more of the first principal surface, the second principal surface, the first side surface, the second side surface, the first end surface, and the second end surface, and a second internal electrode layer between two of the multiple inner resin layers and exposed at any one or more of the first principal surface, the second principal surface, the first side surface, the second side surface, the first end surface, and the second end surface.

With the above configuration, when a multilayer body and base electrode layers are fired, it is possible to perform a baking process at a lower temperature than usual, such that it is possible to reduce or prevent excessive sintering of metal components of internal electrode layers. As a result, it is possible to reduce or prevent the formation of voids in the internal electrode layers and reduce the irregular shapes of end portions of the internal electrode layers. Furthermore, when the end portions of the internal electrode layers have regular shapes, that is, when the end portions of the internal electrode layers have linear shapes, the current path is shortened, which results in reduced ESR.

According to example embodiments of the present invention, multilayer capacitors each with reduced ESR and improved mechanical strength are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a multilayer capacitor according to a first example embodiment of the present invention.

FIG. 2 is a cross-sectional view taken along the line II-II in FIG. 1.

FIG. 3 is a cross-sectional view taken along the line III-III in FIG. 1.

FIG. 4 is a cross-sectional view taken along the line IV-IV in FIG. 2.

FIG. 5 is a cross-sectional view taken along the line V-V in FIG. 2.

FIG. 6A is an enlarged view of a portion a in FIG. 2.

FIG. 6B is an enlarged view of a portion β in FIG. 2.

FIG. 7 is a diagram that shows a measurement point in FIG. 4.

FIG. 8 is a cross-sectional view of a multilayer capacitor according to a second example embodiment of the present invention, corresponding to the line II-II in FIG. 1.

FIG. 9 is a cross-sectional view of the multilayer capacitor according to the second example embodiment of the present invention, corresponding to the line III-III in FIG. 1.

FIG. 10 is a cross-sectional view taken along the line X-X in FIG. 8.

FIG. 11 is a cross-sectional view taken along the line XI-XI in FIG. 8.

FIG. 12 is an external perspective view of a multilayer capacitor according to a third example embodiment of the present invention.

FIG. 13 is a front view of the multilayer capacitor according to the third example embodiment of the present invention.

FIG. 14 is a top view of the multilayer capacitor according to the third example embodiment of the present invention.

FIG. 15 is a cross-sectional view taken along the line XV-XV in FIG. 12.

FIG. 16 is a cross-sectional view taken along the line XVI-XVI in FIG. 12.

FIG. 17 is an exploded perspective view of a multilayer body shown in FIG. 12.

FIG. 18 is an external perspective view of a multilayer capacitor according to a fourth example embodiment of the present invention.

FIG. 19 is a front view of the multilayer capacitor according to the fourth example embodiment of the present invention.

FIG. 20 is a top view of the multilayer capacitor according to the fourth example embodiment of the present invention.

FIG. 21 is a cross-sectional view taken along the line XXI-XXI in FIG. 18.

FIG. 22 is a cross-sectional view taken along the line XXII-XXII in FIG. 18.

FIG. 23 is an external perspective view of a multilayer capacitor according to a fifth example embodiment of the present invention.

FIG. 24 is a cross-sectional view taken along the line XXIV-XXIV in FIG. 23.

FIG. 25 is a cross-sectional view taken along the line XXV-XXV in FIG. 23.

FIG. 26 is a cross-sectional view taken along the line XXVI-XXVI in FIG. 24.

FIG. 27 is an exploded perspective view of a multilayer body shown in FIG. 23.

FIG. 28 is an external perspective view of a multilayer capacitor according to a sixth example embodiment of the present invention.

FIG. 29 is a top view of the multilayer capacitor according to the sixth example embodiment of the present invention.

FIG. 30 is a front view of the multilayer capacitor according to the sixth example embodiment of the present invention.

FIG. 31 is a cross-sectional view taken along the line XXXI-XXXI in FIG. 28.

FIG. 32 is a cross-sectional view taken along the line XXXII-XXXII in FIG. 28.

FIG. 33 is a cross-sectional view taken along the line XXXIII-XXXIII in FIG. 31.

FIG. 34 is a cross-sectional view taken along the line XXXIV-XXXIV in FIG. 31.

FIG. 35 is an external perspective view of a multilayer capacitor according to a seventh example embodiment of the present invention.

FIG. 36 is a cross-sectional view taken along the line XXXVI-XXXVI in FIG. 35.

FIG. 37 is a cross-sectional view taken along the line XXXVII-XXXVII in FIG. 35.

FIG. 38 is a cross-sectional view taken along the line XXXVIII-XXXVIII in FIG. 35.

FIG. 39 is an exploded perspective view of a multilayer body shown in FIG. 35.

FIG. 40 is an external perspective view of a multilayer capacitor according to an eighth example embodiment of the present invention.

FIG. 41 is a cross-sectional view taken along the line XXXXI-XXXXI in FIG. 40.

FIG. 42 is a cross-sectional view taken along the line XXXXII-XXXXII in FIG. 40.

FIG. 43 is a cross-sectional view taken along the line XXXXIII-XXXXIII in FIG. 40.

FIG. 44 is an exploded perspective view of a multilayer body shown in FIG. 40.

### DETAILED DESCRIPTION OF THE EXAMPLE EMBODIMENTS

Example embodiments of the present invention will be described in detail below with reference to the drawings.

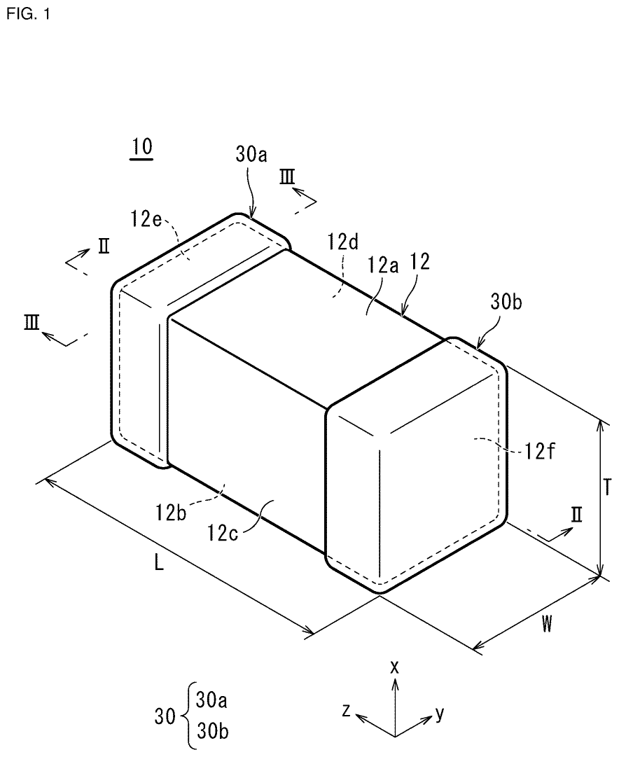

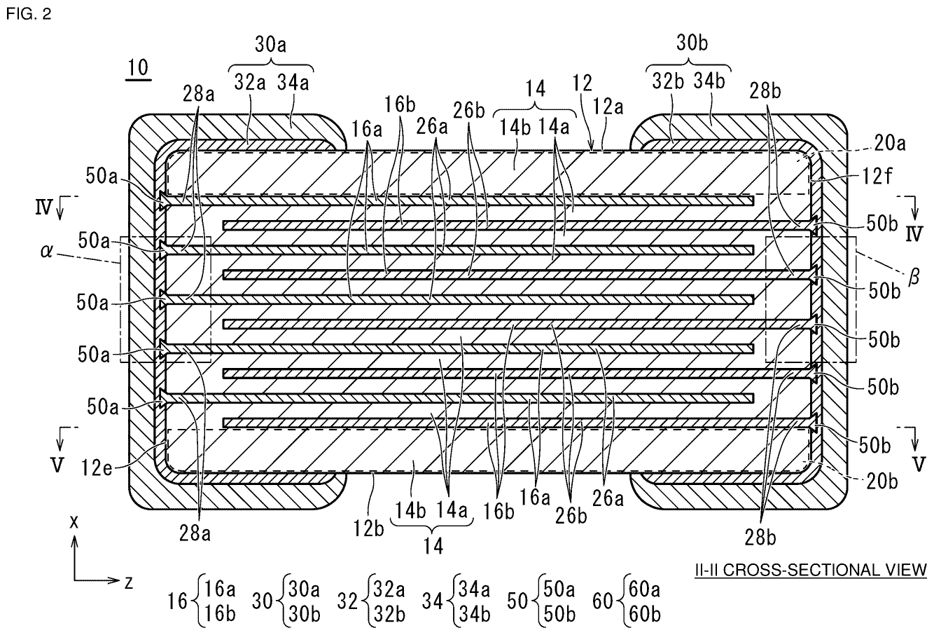

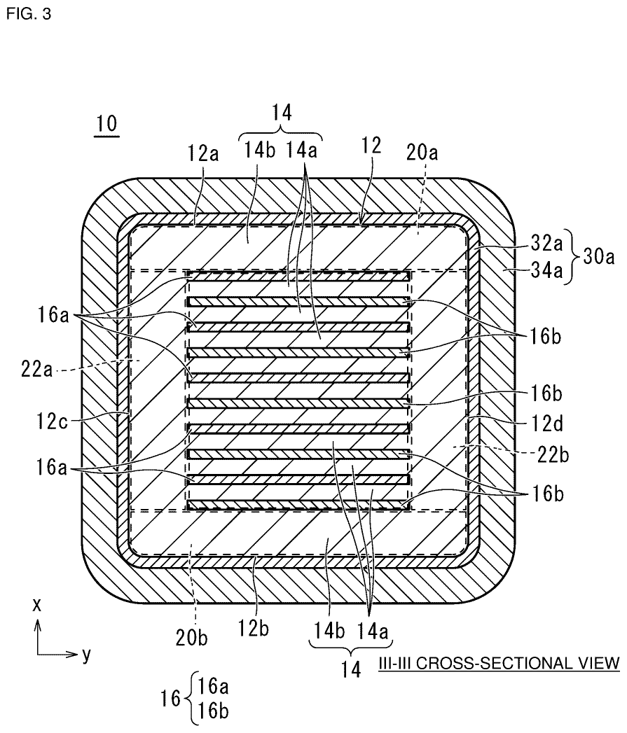

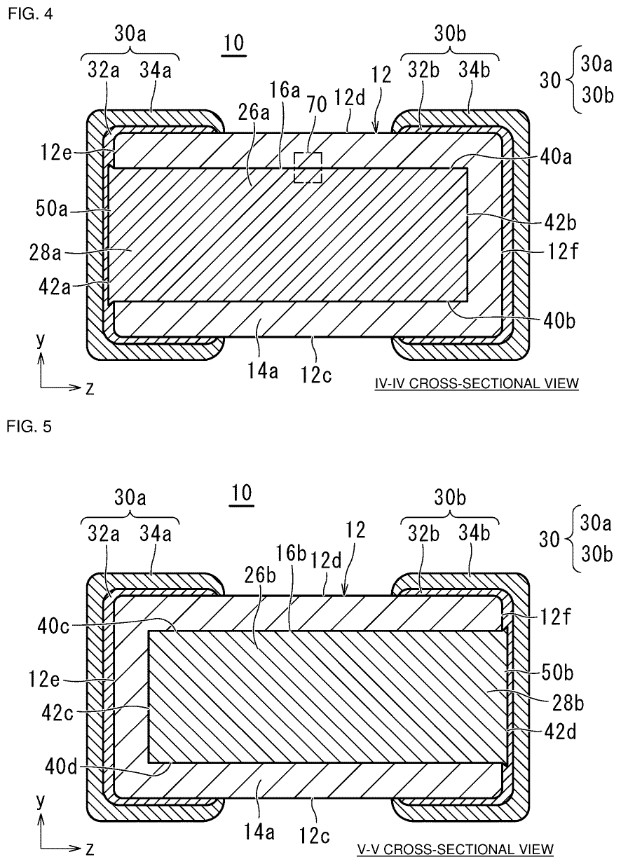

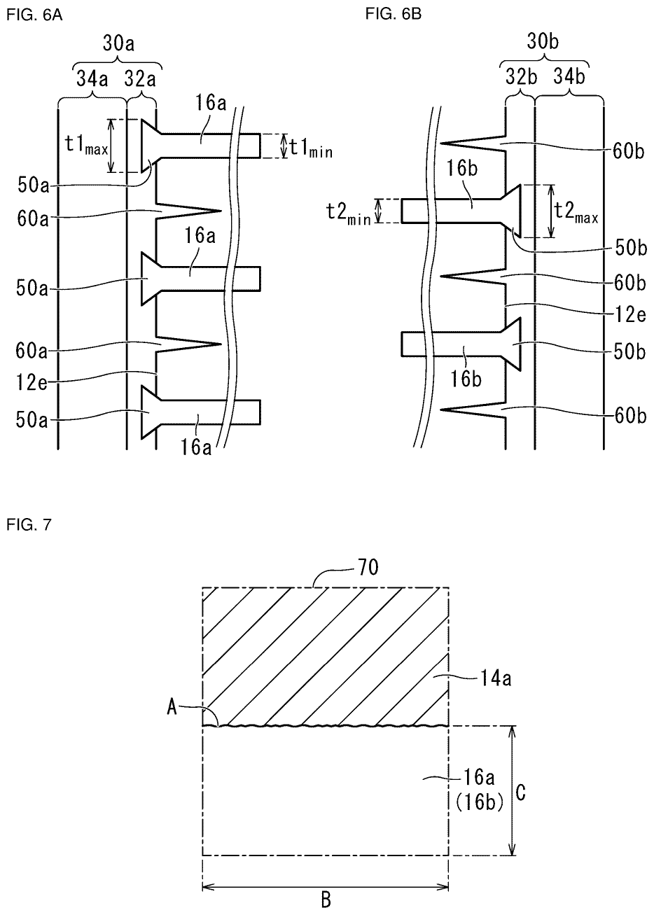

A multilayer capacitor 10 according to a first example embodiment of the present invention will be described. FIG. 1 is an external perspective view of the multilayer capacitor according to the first example embodiment of the present invention. FIG. 2 is a cross-sectional view taken along the line II-II in FIG. 1. FIG. 3 is a cross-sectional view taken along the line III-III in FIG. 1. FIG. 4 is a cross-sectional view taken along the line IV-IV in FIG. 2. FIG. 5 is a cross-sectional view taken along the line V-V in FIG. 2. FIG. 6A is an enlarged view of portion a in FIG. 2. FIG. 6B is an enlarged view of portion β in FIG. 2. FIG. 7 is a diagram that shows a measurement point in FIG. 4.

The multilayer capacitor 10 includes a multilayer body 12 and outer electrodes 30. Hereinafter, each component will be described in order of the multilayer body 12 and the outer electrodes 30.

The multilayer body 12 includes a first principal surface 12a and a second principal surface 12b opposite to each other in a lamination direction x, a first side surface 12c and a second side surface 12d opposite to each other in a width direction y orthogonal or substantially orthogonal to the lamination direction x, and a first end surface 12e and a second end surface 12f opposite to each other in a length direction z orthogonal or substantially orthogonal to the lamination direction x and the width direction y. The first principal surface 12a and the second principal surface 12b each extend in the width direction y and the length direction z. The first side surface 12c and the second side surface 12d each extend in the lamination direction x and the length direction z. The first end surface 12e and the second end surface 12f each extend in the lamination direction x and the width direction y. Therefore, the lamination direction x is a direction that connects the first principal surface 12a and the second principal surface 12b, the width direction y is a direction that connects the first side surface 12c and the second side surface 12d, and the length direction z is a direction that connects the first end surface 12e and the second end surface 12f. The surfaces of the first principal surface 12a and the second principal surface 12b, the first side surface 12c and the second side surface 12d, and the first end surface 12e and the second end surface 12f may include irregularities, and the surfaces may be roughened to be rough surfaces.

In the multilayer body 12, corner portions and ridge portions are preferably rounded. The corner portion refers to a portion where three adjacent sides of the multilayer body 12 intersect, and the ridge portion refers to a portion where two adjacent sides of the multilayer body 12 intersect. By rounding the corner portions and ridge portions of the multilayer body 12, it is possible to reduce or prevent chipping and cracking of the multilayer body 12.

The multilayer body 12 includes multiple resin layers 14 and multiple internal electrode layers 16, which are laminated. The resin layers 14 include inner resin layers 14a and outer resin layers 14b. The internal electrode layers 16 include first internal electrode layers 16a and second internal electrode layers 16b.

The multilayer body 12 includes an inner layer portion 18 and two outer layer portions 20a, 20b sandwiching the inner layer portion 18 in the lamination direction x. Of the two outer layer portions 20a, 20b, the outer layer portion on the first principal surface 12a side is referred to as a first principal surface-side outer layer portion 20a, and the outer layer portion on the second principal surface 12b side is referred to as a second principal surface-side outer layer portion 20b. The multilayer body 12 includes two outer layer portions 22a, 22b sandwiching the inner layer portion 18 in the width direction y. Between the two outer layer portions 22a, 22b on the side surface side, the outer layer portion on the first side surface 12c side is referred to as a first side surface-side outer layer portion 22a, and the outer layer portion on the second side surface 12d side is referred to as a second side surface-side outer layer portion 22b.

More specifically, the multilayer body 12 includes the inner layer portion 18 including one or more inner resin layers 14a and multiple internal electrode layers 16 disposed on top of them. The internal electrode layers 16 include first internal electrode layers 16a extended to the first end surface 12e and second internal electrode layers 16b extended to the second end surface 12f. In the inner layer portion 18, the multiple first internal electrode layers 16a and the multiple second internal electrode layers 16b are opposed to each other with the inner resin layer 14a interposed therebetween.

The multilayer body 12 includes the first principal surface-side outer layer portion 20a including multiple outer resin layers 14b positioned on the first principal surface 12a side between the first principal surface 12a and both the outermost surface of the inner layer portion 18 on the first principal surface 12a side and a straight line extending from the outermost surface.

Similarly, the multilayer body 12 includes the second principal surface-side outer layer portion 20b including multiple outer resin layers 14b positioned on the second principal surface 12b side between the second principal surface 12b and both the outermost surface of the inner layer portion 18 on the second principal surface 12b side and a straight line extending from the outermost surface.

The multilayer body 12 includes the first side surface-side outer layer portion 22a including multiple outer resin layers 14b positioned on the first side surface 12c side between the first side surface 12c and the outermost surface of the inner layer portion 18 on the first side surface 12c side.

Similarly, the multilayer body 12 includes the second side surface-side outer layer portion 22b including multiple outer resin layers 14b positioned on the second side surface 12d side between the second side surface 12d and the outermost surface of the inner layer portion 18 on the second side surface 12d side.

For example, resins, such as liquid crystal polymer (LCP) resin, epoxy resin, or polyimide resin, which are excellent in heat resistance, can be used as the components of the resin layers 14, that is, the inner resin layers 14a and the outer resin layers 14b. However, the components are not limited thereto.

The outer resin layers 14b of each of the first principal surface-side outer layer portion 20a, principal surface-side outer layer portion 20b, the first side surface-side outer layer portion 22a, and the second side surface-side outer layer portion 22b include the same type of resin material as the inner resin layers 14a. Each of the first principal surface-side outer layer portion 20a, the second principal surface-side outer layer portion 20b, the first side surface-side outer layer portion 22a, and the second side surface-side outer layer portion 22b may include multiple outer resin layers 14b or may include a single outer resin layer 14b.

The inner resin layers 14a and the outer resin layers 14b may include different components. For example, the inner resin layers 14a may include a resin with a high dielectric constant, and the outer resin layers 14b may include components with good moisture resistance, weather resistance, and strength.

The number of inner resin layers 14a and outer resin layers 14b laminated is not limited and is, for example, preferably greater than or equal to 15 and less than or equal to 200, including the outer resin layers 14b. The thickness of the inner resin layer 14a is, for example, preferably greater than or equal to about 0.2 μm and less than or equal to about 10.0 μm.

The internal electrode layers 16 include the first internal electrode layers 16a and the second internal electrode layers 16b. The first internal electrode layer 16a and the second internal electrode layer 16b are alternately laminated with the inner resin layer 14a interposed therebetween. Hereinafter, the internal electrode layers may be referred to as internal electrodes.

Each of the first internal electrode layers 16a is disposed between two of the multiple inner resin layers 14a and is exposed at at least one of the first principal surface 12a, the second principal surface 12b, the first side surface 12c, the second side surface 12d, the first end surface 12e, and the second end surface 12f. In the present example embodiment, each of the first internal electrode layers 16a is disposed between two of the inner resin layers 14a and is exposed at the first end surface 12e.

Each of the second internal electrode layers 16b is disposed between two of the multiple inner resin layers 14a and is exposed at at least one of the first principal surface 12a, the second principal surface 12b, the first side surface 12c, the second side surface 12d, the first end surface 12e, and the second end surface 12f. In the present example embodiment, each of the second internal electrode layers 16b is disposed between two of the inner resin layers 14a and is exposed at the second end surface 12f.

Each of the first internal electrode layers 16a is disposed on the surface of a corresponding one of the inner resin layers 14a. The first internal electrode layer 16a includes a first counter electrode portion 26a facing the second internal electrode layer 16b, and a first lead-out electrode portion 28a positioned at one end side of the first internal electrode layer 16a and extending from the first counter electrode portion 26a to the first end surface 12e of the multilayer body 12. An end portion of the first lead-out electrode portion 28a extends to and is exposed at the first end surface 12e.

The shape of the first counter electrode portion 26a of the first internal electrode layer 16a is not limited and is, for example, preferably a rectangular or substantially rectangular shape in plan view. However, the corner portions in plan view may be rounded or the corner portions may be chamfered in plan view (tapered). The corner portions may have a tapered shape in plan view so as to incline toward each side.

The shape of the first lead-out electrode portion 28a of the first internal electrode layer 16a is not limited and is, for example, preferably a rectangular or substantially rectangular shape in plan view. However, the corner portions in plan view may be rounded or the corner portions may be chamfered in plan view (tapered). The corner portions may have a tapered shape in plan view so as to incline toward each side.

The length of the first counter electrode portion 26a of the first internal electrode layer 16a in the width direction y and the length of the first lead-out electrode portion 28a of the first internal electrode layer 16a in the width direction y may be different, or the length in the width direction y may vary toward the first end surface 12e at which the first internal electrode layer 16a is exposed.

Each of the second internal electrode layers 16b is disposed on the surface of a corresponding one of the inner resin layers 14a, different from the inner resin layer 14a where the first internal electrode layer 16a is disposed. The second internal electrode layer 16b includes a second counter electrode portion 26b facing the first internal electrode layer 16a, and a second lead-out electrode portion 28b positioned at one end side of the second internal electrode layer 16b and extending from the second counter electrode portion 26b to the second end surface 12f of the multilayer body 12. An end portion of the second lead-out electrode portion 28b extends to and is exposed at the second end surface 12f.

The shape of the second counter electrode portion 26b of the second internal electrode layer 16b is not limited and is, for example, preferably a rectangular or substantially rectangular shape in plan view. However, the corner portions in plan view may be rounded or the corner portions may be chamfered in plan view (tapered). The corner portions may have a tapered shape in plan view so as to incline toward each side.

The shape of the second lead-out electrode portion 28b of the second internal electrode layer 16b is not limited and is, for example, preferably a rectangular or substantially rectangular shape in plan view. However, the corner portions in plan view may be rounded or the corner portions may be chamfered in plan view (tapered). The corner portions may have a tapered shape in plan view so as to incline toward each side.

The length of the second counter electrode portion 26b of the second internal electrode layer 16b in the width direction y and the length of the second lead-out electrode portion 28b of the second internal electrode layer 16b in the width direction y may be different, or the length in the width direction y may vary toward the second end surface 12f at which the second internal electrode layer 16b is exposed.

Each of the first internal electrode layers 16a and a corresponding one of the second internal electrode layers 16b are opposed to each other with the inner resin layer 14a interposed therebetween, so that capacitance is generated.

The first internal electrode layer 16a and the second internal electrode layer 16b can include a suitable conductive material, for example, a metal such as Ni, Cu, Ag, Pd, or Au or an alloy that includes one of these metals, such as Ag—Pd. However, the first internal electrode layer 16a and the second internal electrode layer 16b are not limited thereto. In the present example embodiment, the first internal electrode layer 16a and the second internal electrode layer 16b include Cu having high conductivity as a main component. Thus, it is possible to reduce the ESR of the multilayer capacitor 10.

The dielectric constant of the inner resin layer 14a is lower than those of dielectric materials used in existing multilayer capacitors. Thus, in order to provide a capacitor of the same capacitance, it is necessary to increase the areas of the counter electrode portions 26a, 26b accordingly. Therefore, it is necessary to increase the number of the first internal electrode layers 16a and the second internal electrode layers 16b. As a result, the total area of the internal electrode layers 16 is increased, such that it is possible to reduce the ESR of the multilayer capacitor 10. Furthermore, since the multilayer body 12 includes the inner resin layers 14a and the outer resin layers 14b, even when warpage occurs in the multilayer capacitor 10, the warpage can be absorbed by the inner resin layers 14a and the outer resin layers 14b, so the warpage strength can be improved. Therefore, compared to existing multilayer capacitors, the mechanical strength can be improved.

Furthermore, when a multilayer ceramic capacitor, which is an example of the existing multilayer capacitor, is manufactured, the sintering temperature of the dielectric ceramic is higher than the sintering temperature of the internal electrode 16 when the dielectric ceramic is fired. As a result, there is a risk that particles couple together due to over-sintering of the internal electrodes 16 to form voids in the internal electrodes 16, which may lead to a reduction in effective area and a decrease in the linearity of the end portions of the internal electrodes 16. However, since it is possible to form the multilayer capacitor 10 without including a firing process at a temperature exceeding the melting point of the inner resin layer 14a, there is no reduction in effective area or linearity due to over-sintering of the first internal electrode layer 16a and the second internal electrode layer 16b. Therefore, the area of the internal electrodes 16 per unit number of sheets can be maximized, so the maximum capacitance can be obtained. Furthermore, since the linearity of the end portions of the internal electrodes 16 can be improved, the ESR is reduced.

The first internal electrode layer 16a and the second internal electrode layer 16b preferably have no voids. Thus, the current path of the multilayer capacitor 10 is shortened, with the result that the ESR can be reduced.

Here, as shown in FIG. 4, the first internal electrode layer 16a includes an end portion 40a on the first side surface 12c side in the width direction y, an end portion 40b on the second side surface 12d side in the width direction y, an end portion 42a on the first end surface 12e side in the length direction z, and an end portion 42b on the second end surface 12f side in the length direction z. The first end surface 12e-side end portion 42a of the first internal electrode layer 16a is exposed from the multilayer body 12. The first side surface 12c-side end portion 40a, the second side surface 12d-side end portion 40b, and the second end surface 12f-side end portion 42b of the first internal electrode layer 16a are in contact with the inner resin layer 14a.

Similarly, as shown in FIG. 5, the second internal electrode layer 16b includes an end portion 40c on the first side surface 12c side in the width direction y, an end portion 40d on the second side surface 12d side in the width direction y, an end portion 42c on the first end surface 12e side in the length direction z, and an end portion 42d on the second end surface 12f side in the length direction z. The second end surface 12f-side end portion 42d of the second internal electrode layer 16b is exposed from the multilayer body 12. The first side surface 12c-side end portion 40c, the second side surface 12d-side end portion 40d, and the first end surface 12e-side end portion 42c of the second internal electrode layer 16b are in contact with the inner resin layer 14a.

The linearity of each of the end portions of the first internal electrode layer 16a or the second internal electrode layer 16b, where the first internal electrode layer 16a or the second internal electrode layer 16b is in contact with the inner resin layer 14a, is, for example, preferably greater than or equal to about 1.0 and less than or equal to about 1.5. Furthermore, the linearity of each of the end portions of the first internal electrode layer 16a or the second internal electrode layer 16b, where the first internal electrode layer 16a or the second internal electrode layer 16b is in contact with the inner resin layer 14a, is, for example, preferably about 1.0. Thus, the current path can be provided in a route close to the shortest path, so the ESR can be reduced.

The linearity of each of the end portions 40a, 40b of the first internal electrode layer 16a in the width direction y is calculated by the following method.

First, the multilayer capacitor 10 is ground in the length direction z and the width direction y (LW cross section) to expose the first internal electrode layer 16a.

Subsequently, an SEM image of the end portions 40a, 40b, in the width direction y, of the first internal electrode layer 16a exposed at the surface is taken using a scanning electron microscope (SEM) at a magnification of about 2000 times centered on about 1/2L of the multilayer capacitor 10, and the perimeter, average vertical chord length, and image width are measured. FIG. 7 is a diagram that shows a measurement point 70 in FIG. 4. In FIG. 7, the length of the end portion of the internal electrode layer is denoted by A, the image width is denoted by B, the average vertical chord length is denoted by C, and the perimeter is denoted by D. From the SEM image, the perimeter, average vertical chord length, and image width are measured, and the lengths <A> of the end portions 40a, 40b of the first internal electrode layer 16a are calculated using (Equation 1).

(The length of the end portion<A>)=(Perimeter<D>)−(Average vertical chord length<C>)×2−(Image width<B>) (Equation 1)

Finally, using (Equation 2), the linearity of each of the end portions 40a, 40b of the first internal electrode layer 16a is calculated.

(The linearity of the end portion)=(The length of the end portion<A>)/(image width<B>) (Equation 2)

The linearity of the end portion 42b of the first internal electrode layer 16a in the length direction Z is calculated by the following method.

First, the multilayer capacitor 10 is ground in the length direction z and the width direction y (LW cross section) to expose the first internal electrode layer 16a.

Subsequently, an SEM image of the end portion 42b, in the length direction z, of the first internal electrode layer 16a exposed at the surface is taken using a scanning electron microscope (SEM) at a magnification of about 2000 times centered on about 1/2W of the multilayer capacitor 10, and the perimeter, average vertical chord length, and image width are measured. The length of the end portion of the internal electrode layer is denoted by A, the image width is denoted by B, the average vertical chord length is denoted by C, and the perimeter is denoted by D. From the SEM image, the perimeter, average vertical chord length, and image width are measured, and the linearity of the end portion 42b of the first internal electrode layer 16a in the length direction z is calculated using the above (Equation 1) and (Equation 2).

The linearity of each of the end portions 40c, 40d of the second internal electrode layer 16b in the width direction y is calculated by the following method.

First, the multilayer capacitor 10 is ground in the length direction z and the width direction y (LW cross section) to expose the second internal electrode layer 16b.

Subsequently, an SEM image of the end portions 40c, 40d, in the width direction y, of the second internal electrode layer 16b exposed at the surface is taken using a scanning electron microscope (SEM) at a magnification of about 2000 times centered on about 1/2L of the multilayer capacitor 10, and the perimeter, average vertical chord length, and image width are measured. The length of the end portion of the internal electrode layer is denoted by A, the image width is denoted by B, the average vertical chord length is denoted by C, and the perimeter is denoted by D. From the SEM image, the perimeter, average vertical chord length, and image width are measured, and the linearity of each of the end portions 40c, 40d of the second internal electrode layer 16b in the width direction y is calculated using the above (Equation 1) and (Equation 2).

The linearity of the end portion 42c of the second internal electrode layer 16b in the length direction z is calculated by the following method.

First, the multilayer capacitor 10 is ground in the length direction z and the width direction y (LW cross section) to expose the second internal electrode layer 16b.

Subsequently, an SEM image of the end portion 42c, in the length direction z, of the second internal electrode layer 16b exposed at the surface is taken using a scanning electron microscope (SEM) at a magnification of about 2000 times centered on about 1/2W of the multilayer capacitor 10, and the perimeter, average vertical chord length, and image width are measured. The length of the end portion of the internal electrode layer is denoted by A, the image width is denoted by B, the average vertical chord length is denoted by C, and the perimeter is denoted by D. From the SEM image, the perimeter, average vertical chord length, and image width are measured, and the linearity of the end portion 42c of the second internal electrode layer 16b in the length direction z is calculated using the above (Equation 1) and (Equation 2).

Furthermore, as shown in FIGS. 2 and 6A, among the end portions 40a, 40b, 42a, 42b of the first internal electrode layer 16a, the first end surface 12e-side end portion 42a that is the end portion exposed at any of the first side surface 12c, the second side surface 12d, the first end surface 12e, and the second end surface 12f of the multilayer body 12 is reduced in thickness in the lamination direction x toward the surface (the second end surface 12f) opposite the surface at which the first internal electrode layer 16a is exposed. In other words, when the first internal electrode layer 16a is exposed at the first end surface 12e, the first internal electrode layer 16a is configured to have a triangular or substantially triangular shape that reduces in length in the lamination direction x from the first end surface 12e toward the second end surface 12f in the cross section of the lamination direction x and the length direction z (LT cross section). As a result, the bonding area between the first outer electrode 30a and the first internal electrode layer 16a increases, so the adhesion strength increases, and the ESR reduces.

Where a region in which, among the end portions 40a, 40b, 42a, 42b of the first internal electrode layer 16a, the first end surface 12e-side end portion 42a that is the end portion exposed at any of the first side surface 12c, the second side surface 12d, the first end surface 12e, and the second end surface 12f of the multilayer body 12 is reduced in thickness in the lamination direction x toward the surface (the second end surface 12f) opposite the surface at which the first internal electrode layer 16a is exposed is a first exposed end region 50a, the entire or substantially the entire first exposed end region 50a is preferably exposed from the multilayer body 12. In other words, among the end portions 40a, 40b, 42a, 42b of the first internal electrode layer 16a, the end portion 42a exposed at the first end surface 12e of the multilayer body 12 includes a first exposed end region 50a that is a region where the thickness reduces in the lamination direction x toward the second end surface 12f facing the first end surface 12e at which the first internal electrode layer 16a is exposed, and the entire or substantially the entire first exposed end region 50a is preferably exposed from the first end surface 12e. By exposing the entire or substantially the entire first exposed end region 50a from the multilayer body 12, the bonding area between the first outer electrode 30a and the first internal electrode layer 16a is increased, so the adhesion strength is increased, and the ESR is reduced.

At this time, among the thicknesses of the first internal electrode layer 16a in the lamination direction x, the thickest portion is denoted by t1ₘₐₓ, and the thinnest portion is denoted by t1ₘᵢₙ. Among the thicknesses of the first internal electrode layer 16a in the lamination direction x, the ratio between the thickest portion t1ₘₐₓ and the thinnest portion t1ₘᵢₙ is, for example, preferably such that the thickest portion t1ₘₐₓ is about 1.5 times or more and about 2.5 times or less the thinnest portion t1ₘᵢₙ. With such a configuration, the adhesion strength between the first outer electrode 30a and the first internal electrode layer 16a can be increased without increasing the thickness of the multilayer body 12 in the lamination direction x.

The first exposed end region 50a can be formed, for example, by immersing the first end surface 12e of the multilayer body 12 in an etchant to etch the inner resin layer 14a.

As shown in FIGS. 2 and 6B, among the end portions 40c, 40d, 42c, 42d of the second internal electrode layer 16b, the second end surface 12f-side end portion 42d that is the end portion exposed at any of the first side surface 12c, the second side surface 12d, the first end surface 12e, and the second end surface 12f of the multilayer body 12 is reduced in thickness in the lamination direction x toward the surface (the first end surface 12e) opposite the surface at which the second internal electrode layer 16b is exposed. In other words, when the second internal electrode layer 16b is exposed at the second end surface 12f, the second internal electrode layer 16b is configured to have a triangular or substantially triangular shape that reduces in length in the lamination direction x from the second end surface 12f toward the first end surface 12e in the cross section of the lamination direction x and the length direction z (LT cross section). As a result, the bonding area between the second outer electrode 30b and the second internal electrode layer 16b is increased, so the adhesion strength is increased, and the ESR is reduced.

Where a region in which, among the end portions 40c, 40d, 42c, 42d of the second internal electrode layer 16b, the second end surface 12f-side end portion 42d that is the end portion exposed at any of the first side surface 12c, the second side surface 12d, the first end surface 12e, and the second end surface 12f of the multilayer body 12 is reduced in thickness in the lamination direction x toward the surface (the first end surface 12e) opposite the surface at which the second internal electrode layer 16b is exposed is a second exposed end region 50b, the entire or substantially the entire second exposed end region 50b is preferably exposed from the multilayer body 12. In other words, among the end portions 40c, 40d, 42c, 42d of the second internal electrode layer 16b, the end portion 42d exposed at the second end surface 12f of the multilayer body 12 includes a second exposed end region 50b that is a region where the thickness reduces in the lamination direction x toward the first end surface 12e facing the second end surface 12f at which the second internal electrode layer 16b is exposed, and the entire or substantially the entire second exposed end region 50b is preferably exposed from the second end surface 12f. By exposing the entire or substantially the entire second exposed end region 50b from the multilayer body 12, the bonding area between the second outer electrode 30b and the second internal electrode layer 16b is increased, so the adhesion strength is increased, and the ESR is reduced.

At this time, among the thicknesses of the second internal electrode layer 16b in the lamination direction x, the thickest portion is denoted by t2ₘₐₓ, and the thinnest portion is denoted by t2ₘᵢₙ. Among the thicknesses of the second internal electrode layer 16b in the lamination direction x, the ratio between the thickest portion t2ₘₐₓ and the thinnest portion t2ₘᵢₙ is, for example, preferably such that the thickest portion t2ₘₐₓ is about 1.5 times or more and about 2.5 times or less the thinnest portion t2ₘᵢₙ. With such a configuration, the adhesion strength between the second outer electrode 30b and the second internal electrode layer 16b can be increased without increasing the thickness of the multilayer body 12 in the lamination direction x.

The second exposed end region 50b can be formed, for example, by immersing the second end surface 12f of the multilayer body 12 in an etchant to etch the inner resin layer 14a.

The thickness, in the lamination direction x, of each of the end portions 40a, 40b of the first internal electrode layer 16a in the width direction y is preferably thicker than the thickness, in the lamination direction x, of the center portion of the first internal electrode layer 16a in the width direction y. Similarly, the thickness, in the lamination direction x, of each of the end portions 40c, 40d of the second internal electrode layer 16b in the width direction y is preferably thicker than the thickness, in the lamination direction x, of the center portion of the second internal electrode layer 16b in the width direction y. Current flows along the end portions 40a, 40b of the first internal electrode layer 16a in the width direction y and the end portions 40c, 40d of the second internal electrode layer 16b in the width direction y, so, when the thickness, in the lamination direction x, of each of the end portions 40a, 40b, 40c, 40d of each of the internal electrode layers 16a, 16b in the width direction y is made thicker than the thickness, in the lamination direction x, of the center side of each of the internal electrode layers 16a, 16b, it is possible to allow more current to flow. Thus, the ESR can be reduced.

The number of the first internal electrode layers 16a and the second internal electrode layers 16b is, for example, preferably greater than or equal to 15 in total and less than or equal to 200 in total. The thickness of each of the first internal electrode layers 16a and the second internal electrode layers 16b is, for example, preferably greater than or equal to about 1 μm and less than or equal to about 12 μm.

As shown in FIGS. 6A and 6B, the multilayer body 12 may include first notches 60a extending from the first end surface 12e, at which the first internal electrode layers 16a are exposed, toward the second end surface 12f that is the opposite surface. Similarly, the multilayer body 12 may include second notches 60b extending from the second end surface 12f, at which the second internal electrode layers 16b are exposed, toward the first end surface 12e that is the opposite surface. As a result, the outer electrodes 30 can enter the first notches 60a and the second notches 60b to improve the adhesion strength between the multilayer body 12 and the outer electrodes 30 due to the anchor effect.

The first notches 60a and the second notches 60b can be formed, for example, by immersing the first end surface 12e and the second end surface 12f of the multilayer body 12 in an etchant to etch the inner resin layer 14a.

The outer electrodes 30 include the first outer electrode 30a and the second outer electrode 30b.

The first outer electrode 30a is disposed on one or more of the first principal surface 12a, the second principal surface 12b, the first side surface 12c, the second side surface 12d, the first end surface 12e, and the second end surface 12f of the multilayer body 12. In the present example embodiment, the first outer electrode 30a is connected to the first internal electrode layers 16a and extends from the first end surface 12e to a portion of the first principal surface 12a, the second principal surface 12b, the first side surface 12c, and the second side surface 12d. However, the first outer electrode 30a is not limited thereto and may be, for example, disposed so as not to extend from the first end surface 12e to the first side surface 12c and the second side surface 12d.

The second outer electrode 30b is disposed on one or more of the first principal surface 12a, the second principal surface 12b, the first side surface 12c, the second side surface 12d, the first end surface 12e, and the second end surface 12f of the multilayer body 12. In the present example embodiment, the second outer electrode 30b is connected to the second internal electrode layers 16b and extends from the second end surface 12f to a portion of the first principal surface 12a, the second principal surface 12b, the first side surface 12c, and the second side surface 12d. However, the second outer electrode 30b is not limited thereto and may be, for example, disposed so as not to extend from the second end surface 12f to the first side surface 12c and the second side surface 12d.

Each of the outer electrodes 30 includes a base electrode layer 32 disposed on at least one of the first principal surface 12a, the second principal surface 12b, the first side surface 12c, the second side surface 12d, the first end surface 12e, and the second end surface 12f, and a plating layer 34 that covers the base electrode layer 32.

The base electrode layers 32 include a first base electrode layer 32a and a second base electrode layer 32b.

In the present example embodiment, the first base electrode layer 32a extends from the first end surface 12e to a portion of the first principal surface 12a, the second principal surface 12b, the first side surface 12c, and the second side surface 12d. The second base electrode layer 32b extends from the second end surface 12f to a portion of the first principal surface 12a, the second principal surface 12b, the first side surface 12c, and the second side surface 12d.

The base electrode layer 32 includes, for example, at least one of a baked layer, a conductive resin layer, a thin film layer, or the like.

First, the case where the base electrode layer 32 includes a baked layer will be described. The baked layer includes a metal component and a glass component. The glass component includes, for example, at least one of B, Si, Ba, Mg, Al, Li, Zn, Ti, or the like. The metal component of the baked layer includes, for example, at least one of Cu, Ni, Ag, Pd, Ag—Pd alloy, Au, or the like. The metal component of the baked layer preferably includes a metal, such as Cu and Ni, for example. In the case of the baked layer, the metal component acts as a conductive component. Furthermore, the baked layer may include a plurality of layers.

The baked layer is formed by applying conductive paste including a glass component and a metal component onto the multilayer body 12 and then baking the conductive paste. The baked layer may be formed by simultaneously firing a multilayer chip including internal electrode layers 16 and inner resin layers 14a and conductive paste applied to the multilayer chip, or may be formed by firing a multilayer chip including internal electrode layers 16 and inner resin layers 14a to obtain a multilayer body 12 and then applying and baking conductive paste. The baking temperature is preferably a temperature lower than the melting point of the inner resin layer 14a. More specifically, for example, the baking temperature is preferably lower than or equal to about 200° C.

Each of the thickness of a first baked layer on the first end surface 12e and the thickness of a second baked layer on the second end surface 12f in the length direction z connecting the first end surface 12e of the first baked layer and the second end surface 12f of the second baked layer at the center portion in the lamination direction x connecting the first principal surface 12a and the second principal surface 12b (end surface center thickness) is preferably, for example, greater than or equal to about 5 μm and less than or equal to about 60 μm.

The thickness of each of the first baked layer and the second baked layer in the lamination direction x connecting the first principal surface 12a and the second principal surface 12b at the center portion, in the length direction z connecting the first end surface 12e and the second end surface 12f, of each of the first baked layer and the second baked layer positioned on the first principal surface 12a or the second principal surface 12b is preferably, for example, greater than or equal to about 0.5 μm and less than or equal to about 20 μm.

Next, the case where the base electrode layer 32 includes a conductive resin layer will be described.

The conductive resin layer includes thermosetting resin and metal. Since the conductive resin layer includes thermosetting resin, the conductive resin layer is more flexible than the baked layer made of, for example, a plating film or a fired product of conductive paste. Therefore, even when an impact due to a physical impact or a heat cycle is applied to the multilayer capacitor 10, the conductive resin layer defines and functions as a buffer layer, with the result that it is possible to further reduce or prevent the occurrence of cracks in the multilayer capacitor 10.

For example, Ag, Cu, Ni, Sn, Bi, or an alloy including any one or more of them can be used as metal included in the conductive resin layer. Metal powder in which the surfaces of metal powder are coated with Ag can also be used, for example. When metal powder of which the surfaces are coated with Ag is used, for example, Cu, Ni, Sn, Bi, or alloy powder of any one or more of them is preferably used as metal powder. The reason why Ag conductive metal powder is preferably used as conductive metal is that Ag has the lowest specific resistance among metals and is suitable for electrode materials and, in addition, Ag is a precious metal, does not oxidize, and has high weather resistance. The above characteristics of Ag can be maintained while a cheaper metal can be used for a base material. In the case of the conductive resin layer, conductive metal acts as a conductive component.

Furthermore, for example, Cu or Ni to which antioxidation treatment is applied can be used as metal included in the conductive resin layer. Metal powder of which the surfaces are coated with, for example, Sn, Ni, or Cu can be used as metal included in the conductive resin layer. When metal power of which the surfaces are coated with Sn, Ni, or Cu is used, for example, Ag, Cu, Ni, Sn, Bi, or alloy powder of any one or more of them is preferably used as metal powder.

The metal included in the conductive resin layer mainly provides electrical conductivity of the conductive resin layer. Specifically, a conductive path is provided inside the conductive resin layer by the contact between conductive fillers.

The metal included in the conductive resin layer can have a spherical shape, a flat shape, or the like, and a mixture of spherical metal powder and flat metal powder is preferably used.

Examples of the resin for the conductive resin layer include various known thermosetting resins, such as epoxy resin, phenolic resin, urethane resin, silicone resin, or polyimide resin. Among them, epoxy resin that excels in heat resistance, moisture resistance, and adhesion is an appropriate resin.

The conductive resin layer preferably includes a curing agent along with a thermosetting resin. As a curing agent, for example, when epoxy resin is used as a base resin, various known compounds, such as phenol-based compounds, amine-based compounds, anhydride-based compounds, imidazole-based compounds, reactive ester-based compounds, or amide-imide-based compounds, can be used as a curing agent for epoxy resin.

The thickness of the thickest portion of the conductive resin layer is preferably, for example, greater than or equal to about 5 μm and less than or equal to about 60 μm.

Next, the case where the base electrode layer 32 is a thin film layer will be described. When a thin film layer is provided as the base electrode layer 32, the thin film layer is formed by a thin film formation method, such as sputtering and evaporation, for example. The thin film layer is, for example, a layer of less than or equal to about 1 μm where metal particles are deposited.

The base electrode layer 32 may be a plating layer, for example. In other words, the multilayer capacitor 10 may have a structure that includes a plating layer that is directly electrically connected to the internal electrode layers 16. In such cases, after a catalyst is disposed on the surface of the multilayer body 12 as pre-treatment, a plating layer may be directly formed.

When a plating layer is directly formed, the plating layer defining the base electrode layer 32 preferably, for example, includes at least one type of metal among Cu, Ni, Sn, Pb, Au, Ag, Pd, Bi, or Zn, or an alloy including any one or more of the metals.

When a plating layer is directly formed, the plating layer formed as the base electrode layer 32 preferably does not include glass. The metal ratio per unit volume of a plating layer formed as the base electrode layer 32 is, for example, preferably higher than or equal to about 99 vol %.

When a plating layer is directly provided on the multilayer body 12, a low profile, that is, a slim design, can be achieved or the plating layer can be converted to the thickness of the multilayer body 12, that is, the thickness of the inner layer portion 18, so the design flexibility of thin chips can be improved.

Regarding the base electrode layer 32, the four configurations have been described above. The base electrode layer 32 may be configured with one of the four configurations or the base electrode layer 32 may be configured by combining the four configurations.

The plating layers 34 include a first plating layer 34a and a second plating layer 34b. The first plating layer 34a covers the first base electrode layer 32a. The second plating layer 34b covers the second base electrode layer 32b.

The plating layer 34 includes, for example, at least one of Cu, Ni, Sn, Ag, Pd, Ag—Pd alloy, Au, or the like.

The plating layer 34 preferably has at least a two-layer structure. When the plating layer 34 has a two-layer structure, for example, Ni plating and Sn plating are arranged in this order from the multilayer body 12 side. When the plating layer 34 has a three-layer structure, for example, Sn plating, Ni plating, and Sn plating are arranged in this order from the multilayer body 12 side. Ni plating can reduce or prevent erosion of the base electrode layer 32 by solder used when the multilayer capacitor 10 is mounted. Sn plating can improve the wettability of solder used when the multilayer capacitor 10 is mounted, to improve the mountability.

The thickness per layer of the plating layer 34 is, for example, preferably greater than or equal to about 1 μm and less than or equal to about 6 μm.

The dimension, in the length direction z, of the multilayer capacitor 10 that includes the multilayer body 12, the first outer electrode 30a, and the second outer electrode 30b is defined as dimension L, the dimension, in the width direction y, of the multilayer capacitor 10 that includes the multilayer body 12, the first outer electrode 30a, and the second outer electrode 30b is defined as dimension W, and the dimension, in the lamination direction x, of the multilayer capacitor 10 that includes the multilayer body 12, the first outer electrode 30a, and the second outer electrode 30b is defined as dimension T.

The dimensions of the multilayer capacitor 10 are not limited. For example, preferably, the dimension L in the length direction z is greater than or equal to about 0.20 mm and less than or equal to about 0.65 mm, the dimension W in the width direction y is greater than or equal to about 0.10 mm and less than or equal to about 0.35 mm, and the dimension T in the lamination direction x is greater than or equal to about 0.01 mm and less than or equal to about 0.35 mm.

With the multilayer capacitor 10 shown in FIG. 1, the inner layer portion 18 of the multilayer body 12 includes the multiple inner resin layers 14a and the multiple internal electrode layers 16 that are alternately laminated. With the above configuration, when the multilayer body 12 and the base electrode layers 32 are fired, the baking process can be performed at a lower temperature than usual, so over-sintering of the metal components of the internal electrode layers 16 can be suppressed. As a result, it is possible to reduce or prevent the occurrence of voids in the internal electrode layers 16 and reduce or prevent the irregular shapes of the end portions of the internal electrode layers 16. Furthermore, when the end portions of the internal electrode layers 16 have regular shapes, that is, when the end portions of the internal electrode layers 16 have linear shapes, the current path is shortened, with the result that the ESR can be decreased.

Hereinafter, an example of a manufacturing method for the multilayer capacitor 10 according to the first example embodiment will be described.

First, raw materials for the inner resin layers 14a and the outer resin layers 14b are prepared. The inner resin layers 14a and the outer resin layers 14b are resin sheets mainly made of thermoplastic resin, such as liquid crystal polymer (LCP), for example.

Subsequently, a conductor pattern that becomes the internal electrode layer 16 is formed on each of the resin sheets that become the multiple inner resin layers 14a. More specifically, a metal foil, such as Cu foil, is laminated on one side of the resin sheet that becomes the inner resin layer 14a, and the metal foil is patterned using, for example, photolithography and then laminated. At this time, the adhesion between the inner resin layer 14a and the internal electrode layer 16 may be improved, for example, by roughening in advance the surface of one side of the resin sheet that becomes the inner resin layer 14a and laminating a Cu foil on top of the resin sheet. Thus, a block for an inner layer portion is formed. Multiple or single block for a first principal surface-side outer layer portion and multiple or single block for a second principal surface-side outer layer portion are formed by laminating the resin sheets that become the outer resin layers 14b.

Subsequently, a multilayer body block is manufactured by laminating the block for an inner layer portion so as to be sandwiched between the block for a first principal surface-side outer layer portion and the block for a second principal surface-side outer layer portion and then applying hot press (simultaneous pressing).

The manufactured multilayer body block is divided into individual pieces, for example, by die cutting to form the multilayer body 12. To expose the end portions 42a, 42d of the internal electrode layers 16 on the multilayer body 12, for example, the first end surface 12e and the second end surface 12f of the multilayer body 12 may be immersed in an etchant. By doing it this way, the first exposed end regions 50a and the second exposed end regions 50b can be formed by etching the inner resin layers 14a to expose the end portions 42a, 42d of the internal electrode layers 16.

When baked layers are provided as the base electrode layers 32, the base electrode layers 32 are formed by applying low-temperature curable conductive paste to the first end surface 12e and the second end surface 12f of the obtained multilayer body 12, for example, by a dipping method and performing a baking process at a temperature higher than or equal to about 100° C. and lower than or equal to about 250° C. At this time, by changing the amount of pressing and the pressing time in dipping and the amount of conductive paste, it is possible to control the thickness of each of the base electrode layers 32 and the amount by which the base electrode layers 32 extend onto the first principal surface 12a, the second principal surface 12b, the first side surface 12c, and the second side surface 12d of the multilayer body 12. Not limited to this, conductive paste can also be applied using screen printing, for example.

When conductive resin layers are provided as the base electrode layers 32, the base electrode layers 32 are formed by applying conductive resin paste including thermosetting resin and metal components to the first end surface 12e and the second end surface 12f of the obtained multilayer body 12 and performing heat treatment at a temperature of, for example, lower than or equal to about 250° C. to cure the thermosetting resin. At this time, for example, a condition in an N₂ atmosphere is preferable as a heat treatment atmosphere, and the oxygen concentration is preferably to about 100 ppm or lower.

When thin film layers are provided as the base electrode layers 32, the base electrode layers 32 formed of deposited metal particles can be formed on the first end surface 12e and the second end surface 12f of the obtained multilayer body 12, for example, by sputtering. Thus, for example, thin films less than or equal to about 1.0 μm can be formed as the base electrode layers 32. At this time, by controlling the positional relationship such as the angle and distance with respect to the multilayer body 12, it is possible to control the thickness of each of the base electrode layers 32 and the amount by which the base electrode layers 32 extend onto the first principal surface 12a, the second principal surface 12b, the first side surface 12c, and the second side surface 12d of the multilayer body 12. It is also possible to apply sputtering not only to one surface but also individually to the surfaces, for example.

When thin film layers are provided as the base electrode layers 32, if the entire or substantially the entire first exposed end regions 50a and second exposed end regions 50b are exposed on the surface of the multilayer body 12, steps may occur in the base electrode layers 32 due to the first exposed end regions 50a and the second exposed end regions 50b, with the result that the base electrode layers 32 may be formed discontinuously in the lamination direction x. In other words, when a thin film layer is formed, metal particles are deposited from one side, such that portions occur where metal particles are obstructed by the first exposed end regions 50a and the second exposed end regions 50b and not deposited on the surfaces of the end surfaces 12e, 12f of the multilayer body 12, and the thin film layers can be not continuously formed. However, even when the thin film layers are formed in this way, there is no inconvenience because the internal electrode layers 16 and the outer electrodes 30 are electrically connected by the plating layers 34.

When plating layers are directly provided as the base electrode layers 32, for example, electrolytic plating, electroless plating, or the like, is used. Barrel plating, for example, is preferable for electrolytic plating.

Subsequently, plating layers 34 are respectively formed on the formed base electrode layers 32, for example, by barrel plating.

When each of the plating layers 34 has a two-layer structure, for example, Ni plating and Sn plating are arranged in this order from the multilayer body 12 side. However, the types of metal are not limited thereto. When each of the plating layers 34 has a three-layer structure, for example, Sn plating, Ni plating, and Sn plating are arranged in this order from the multilayer body 12 side.

In this way, the multilayer capacitor 10 according to the present example embodiment is manufactured.

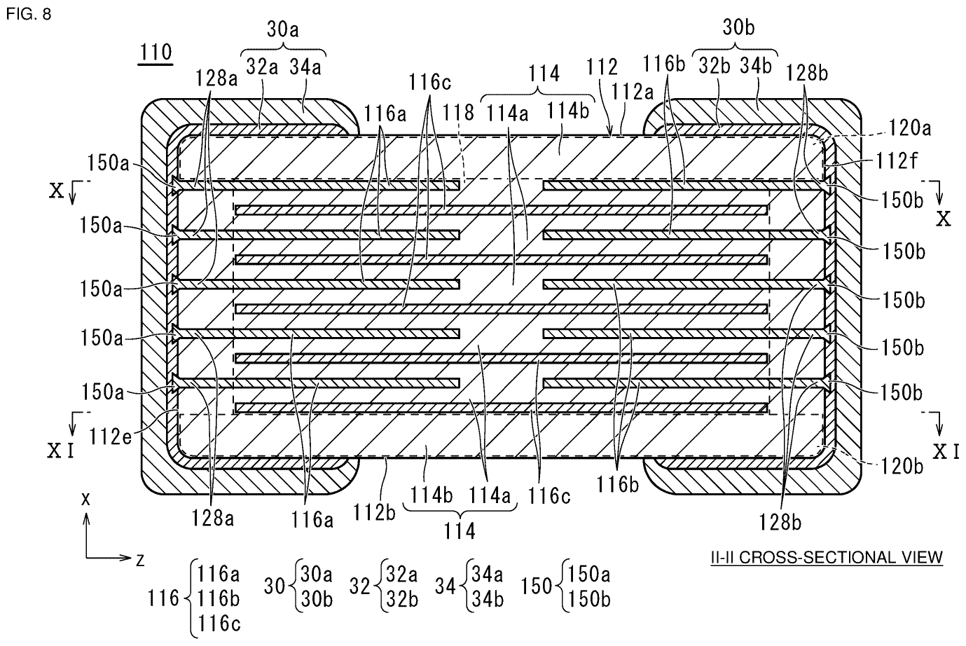

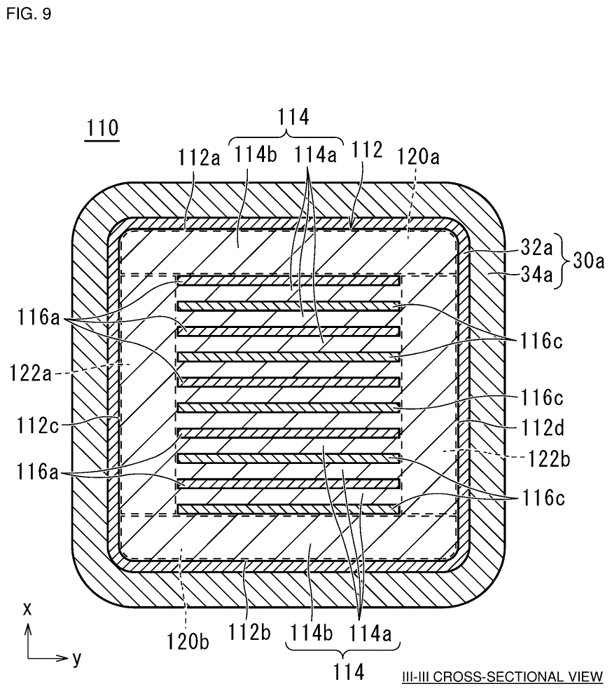

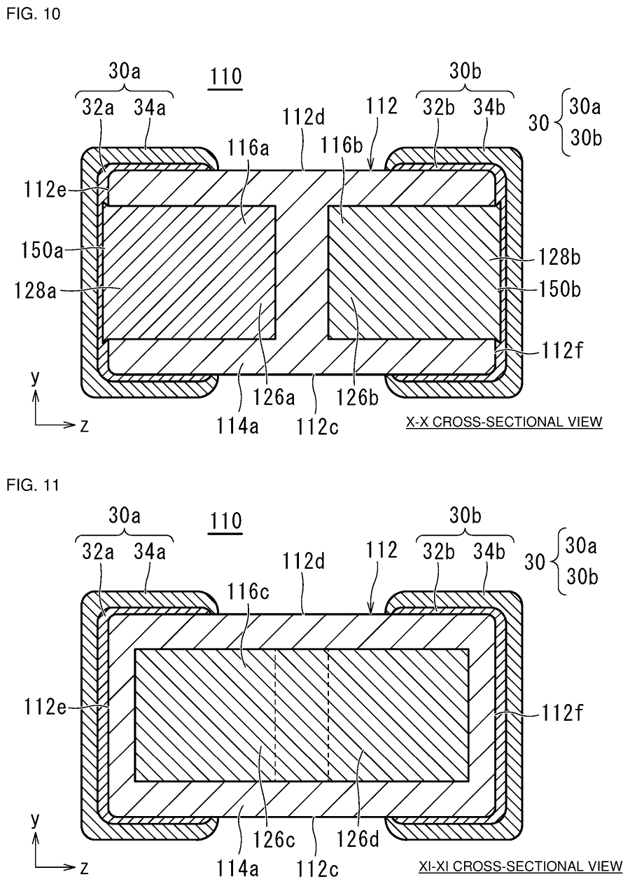

Next, a multilayer capacitor 110 according to a second example embodiment of the present invention will be described. FIG. 8 is a cross-sectional view of the multilayer capacitor according to the second example embodiment of the present invention, corresponding to the line II-II in FIG. 1. FIG. 9 is a cross-sectional view of the multilayer capacitor according to the second example embodiment of the present invention, corresponding to the line III-III in FIG. 1. FIG. 10 is a cross-sectional view taken along the line X-X in FIG. 8. FIG. 11 is a cross-sectional view taken along the line XI-XI in FIG. 8.

The multilayer capacitor 110 according to the second example embodiment includes a multilayer body 112 and outer electrodes 30 having a configuration the same as or similar to those of the first example embodiment. The multilayer body 112 differs from the multilayer body 12 according to the first example embodiment in the structure of internal electrode layers 116 of the multilayer body 112. Therefore, the same reference signs denote the components corresponding to the components of the multilayer capacitor 10 according to the first example embodiment, and the detailed description thereof is omitted.

As shown in FIGS. 8 to 11, the multilayer body 112 includes a first principal surface 112a and a second principal surface 112b opposite to each other in a lamination direction x, a first side surface 112c and a second side surface 112d opposite to each other in a width direction y orthogonal or substantially orthogonal to the lamination direction x, and a first end surface 112e and a second end surface 112f opposite to each other in a length direction z orthogonal or substantially orthogonal to the lamination direction x and the width direction y. The first principal surface 112a and the second principal surface 112b each extend in the width direction y and the length direction z. The first side surface 112c and the second side surface 112d each extend in the lamination direction x and the length direction z. The first end surface 112e and the second end surface 112f each extend in the lamination direction x and the width direction y. Therefore, the lamination direction x is a direction that connects the first principal surface 112a and the second principal surface 112b, the width direction y is a direction that connects the first side surface 112c and the second side surface 112d, and the length direction z is a direction that connects the first end surface 112e and the second end surface 112f. The surfaces of the first principal surface 112a and the second principal surface 112b, the first side surface 112c and the second side surface 112d, and the first end surface 112e and the second end surface 112f may include irregularities, and the surfaces may be roughened to be rough surfaces.

In the multilayer body 112, corner portions and ridge portions are preferably rounded. The corner portion refers to a portion where three adjacent sides of the multilayer body 112 intersect, and the ridge portion refers to a portion where two adjacent sides of the multilayer body 112 intersect. By rounding the corner portions and ridge portions of the multilayer body 112, it is possible to reduce or prevent chipping and cracking of the multilayer body 112.

The multilayer body 112 includes multiple resin layers 114 and multiple internal electrode layers 116, which are laminated. The resin layers 114 include inner resin layers 114a and outer resin layers 114b. The internal electrode layers 116 include first internal electrode layers 116a, second internal electrode layers 116b, and floating internal electrode layers 116c.

The multilayer body 112 includes an inner layer portion 118 and two outer layer portions 120a, 120b sandwiching the inner layer portion 118 in the lamination direction x. Between the two outer layer portions 120a, 120b, the outer layer portion on the first principal surface 112a side is referred to as a first principal surface-side outer layer portion 120a, and the outer layer portion on the second principal surface 112b side is referred to as a second principal surface-side outer layer portion 120b. The multilayer body 112 includes two outer layer portions 122a, 122b sandwiching the inner layer portion 118 in the width direction y. Between the two outer layer portions 122a, 122b on the side surface side, the outer layer portion on the first side surface 112c side is referred to as a first side surface-side outer layer portion 122a, and the outer layer portion on the second side surface 112d side is referred to as a second side surface-side outer layer portion 122b.

More specifically, the multilayer body 112 includes the inner layer portion 118 including one or more inner resin layers 114a and multiple internal electrode layers 116 disposed on top of them. The internal electrode layers 116 include first internal electrode layers 116a extending to the first end surface 112e and second internal electrode layers 116b extending to the second end surface 112f. In the inner layer portion 118, the multiple first internal electrode layers 116a and the multiple second internal electrode layers 116b are opposed to each other with the inner resin layer 114a interposed therebetween.

The multilayer body 112 includes the first principal surface-side outer layer portion 120a including multiple outer resin layers 114b positioned on the first principal surface 112a side between the first principal surface 112a and both the outermost surface of the inner layer portion 118 on the first principal surface 112a side and a straight line extending from the outermost surface.

Similarly, the multilayer body 112 includes the second principal surface-side outer layer portion 120b including multiple outer resin layers 114b positioned on the second principal surface 112b side between the second principal surface 112b and both the outermost surface of the inner layer portion 118 on the second principal surface 112b side and a straight line extending from the outermost surface.

The multilayer body 112 includes the first side surface-side outer layer portion 122a including multiple outer resin layers 114b positioned on the first side surface 112c side between the first side surface 112c and the outermost surface of the inner layer portion 118 on the first side surface 112c side.

Similarly, the multilayer body 112 includes the second side surface-side outer layer portion 122b including multiple outer resin layers 114b positioned on the second side surface 112d side between the second side surface 112d and the outermost surface of the inner layer portion 118 on the second side surface 112d side.

For example, resins, such as liquid crystal polymer (LCP) resin, epoxy resin, and polyimide resin, which are excellent in heat resistance, can be used as the components of the resin layers 114, that is, the inner resin layers 114a and the outer resin layers 114b. However, the components are not limited thereto.

The outer resin layers 114b of each of the first principal surface-side outer layer portion 120a, the second principal surface-side outer layer portion 120b, the first side surface-side outer layer portion 122a, and the second side surface-side outer layer portion 122b include the same type of resin material as the inner resin layers 114a. Each of the first principal surface-side outer layer portion 120a, the second principal surface-side outer layer portion 120b, the first side surface-side outer layer portion 122a, and the second side surface-side outer layer portion 122b may include multiple outer resin layers 114b or may include a single outer resin layer 114b.

The inner resin layers 114a and the outer resin layers 114b may include different components. For example, the inner resin layers 114a may include a resin with a high dielectric constant, and the outer resin layers 114b may include components with good moisture resistance, weather resistance, and strength.

The number of inner resin layers 114a and outer resin layers 114b laminated is not limited and is, for example, preferably greater than or equal to 15 and less than or equal to 200, including the outer resin layers 114b. The thickness of the inner resin layer 114a is, for example, preferably greater than or equal to about 0.2 μm and less than or equal to about 10.0 μm.

The internal electrode layers 116 include the first internal electrode layers 116a, the second internal electrode layers 116b, and the floating internal electrode layers 116c. The first internal electrode layer 116a and the second internal electrode layer 116b and the floating internal electrode layer 116c are alternately laminated with the inner resin layer 114a interposed therebetween.

Each of the first internal electrode layers 116a is disposed on the surface of a corresponding one of the inner resin layers 114a. The first internal electrode layer 116a includes a first counter electrode portion 126a facing the floating internal electrode layer 116c, and a first lead-out electrode portion 128a positioned at one end side of the first internal electrode layer 116a and extending from the first counter electrode portion 126a to the first end surface 112e of the multilayer body 112. The first lead-out electrode portion 128a includes an end portion extending to and exposed at the first end surface 112e.

The shape of the first counter electrode portion 126a of the first internal electrode layer 116a is not limited and is preferably a rectangular or substantially rectangular shape in plan view. However, the corner portions in plan view may be rounded or the corner portions may be chamfered in plan view (tapered). The corner portions may have a tapered shape in plan view so as to incline toward each side.

The shape of the first lead-out electrode portion 128a of the first internal electrode layer 116a is not limited and is preferably a rectangular or substantially rectangular shape in plan view. However, the corner portions in plan view may be rounded or the corner portions may be chamfered in plan view (tapered). The corner portions may have a tapered shape in plan view so as to incline toward each side.

The length of the first counter electrode portion 126a of the first internal electrode layer 116a in the width direction y and the length of the first lead-out electrode portion 128a of the first internal electrode layer 116a in the width direction y may be different, or the length in the width direction y may vary toward the first end surface 112e at which the first internal electrode layer 116a is exposed.

Each of the second internal electrode layers 116b is disposed on the surface of a corresponding one of the inner resin layers 114a, which is the same as the inner resin layer 114a where the first internal electrode layer 116a is disposed. The second internal electrode layer 116b includes a second counter electrode portion 126b facing the floating internal electrode layer 116c, and a second lead-out electrode portion 128b positioned at one end side of the second internal electrode layer 116b and extending from the second counter electrode portion 126b to the second end surface 112f of the multilayer body 112. The second lead-out electrode portion 128b includes an end portion extending to and exposed at the second end surface 112f.

The shape of the second counter electrode portion 126b of the second internal electrode layer 116b is not limited and is preferably a rectangular or substantially rectangular shape in plan view. However, the corner portions in plan view may be rounded or the corner portions may be chamfered in plan view (tapered). The corner portions may have a tapered shape in plan view so as to incline toward each side.

The shape of the second lead-out electrode portion 128b of the second internal electrode layer 116b is not limited and is preferably a rectangular or substantially rectangular shape in plan view. However, the corner portions in plan view may be rounded or the corner portions may be chamfered in plan view (tapered). The corner portions may have a tapered shape in plan view so as to incline toward each side.

The length of the second counter electrode portion 126b of the second internal electrode layer 116b in the width direction y and the length of the second lead-out electrode portion 128b of the second internal electrode layer 116b in the width direction y may be different, or the length in the width direction y may vary toward the second end surface 112f at which the second internal electrode layer 116b is exposed.

Each of the floating internal electrode layers 116c is disposed on the surface of a corresponding one of the inner resin layers 114a, different from the inner resin layer 114a where the first internal electrode layer 116a and the second internal electrode layer 116b are disposed. The floating internal electrode layer 116c includes a third counter electrode portion 126c facing the first internal electrode layer 116a and a fourth counter electrode portion 126d facing the second internal electrode layer 116b. The third counter electrode portion 126c and the fourth counter electrode portion 126d of the floating internal electrode layer 116c are continuous. The floating internal electrode layer 116c does not extend to any of the first end surface 112e and the second end surface 112f. In FIGS. 8 and 11, the third counter electrode portion 126c and the fourth counter electrode portion 126d of the floating internal electrode layer 116c are formed to be continuous. Alternatively, the third counter electrode portion 126c and the fourth counter electrode portion 126d may be separated from each other.

The shape of each of the third counter electrode portion 126c and the fourth counter electrode portion 126d of the floating internal electrode layer 116c is not limited and is preferably a rectangular or substantially rectangular shape in plan view. However, the corner portions in plan view may be rounded or the corner portions may be chamfered in plan view (tapered). The corner portions may have a tapered shape in plan view so as to incline toward each side.

In the present example embodiment, in addition to the first internal electrode layers 116a and the second internal electrode layers 116b, the floating internal electrode layers 116c not extending to any of the first end surface 112e and the second end surface 112f are provided, and the counter electrode portions are divided into two by the floating internal electrode layers 116c (two-portion structure). However, the configuration is not limited thereto. Of course, for example, a three-portion structure, a four-portion structure, or a four or more portion structure may be provided.

In this way, with the structure in which the counter electrode portions are divided into multiple portions, multiple capacitor components are provided between the facing internal electrode layers 116a, 116b, 116c, and these capacitor components are connected in series. As a result, the voltage applied to each capacitor component is reduced, so the withstand voltage of the multilayer capacitor 110 can be increased.

The first internal electrode layer 116a, the second internal electrode layer 116b, and the floating internal electrode layer 116c can include a suitable conductive material, for example, a metal such as Ni, Cu, Ag, Pd, or Au or an alloy that includes one of these metals, such as Ag—Pd. However, the first internal electrode layer 116a, the second internal electrode layer 116b, and the floating internal electrode layer 116c are not limited thereto. In the present example embodiment, the first internal electrode layer 116a, the second internal electrode layer 116b, and the floating internal electrode layer 116c include, for example, Cu having high conductivity as a main component. Thus, it is possible to reduce the ESR of the multilayer capacitor 110.

The dielectric constant of the inner resin layer 114a is lower than those of dielectric materials used in existing multilayer capacitors, so, in order to provide a capacitor of the same capacitance, it is necessary to increase the areas of the counter electrode portions 126a, 126b, 126c, 126d accordingly. Therefore, it is necessary to increase the number of the first internal electrode layers 116a, the second internal electrode layers 116b, and the floating internal electrode layers 116c. As a result, the total area of the internal electrode layers 116 increases, so it is possible to reduce the ESR of the multilayer capacitor 110. Furthermore, since the multilayer body 112 includes the inner resin layers 114a and the outer resin layers 114b, even when warpage occurs in the multilayer capacitor 110, the warpage can be absorbed by the inner resin layers 114a and the outer resin layers 114b, so the warpage strength can be improved. Therefore, compared to the existing multilayer capacitors, the mechanical strength can be improved.

Furthermore, when a multilayer ceramic capacitor, which is an example of the existing multilayer capacitor, is manufactured, the sintering temperature of the dielectric ceramic is higher than the sintering temperature of the internal electrode 116 when the dielectric ceramic is fired. As a result, there is a risk that particles couple together due to over-sintering of the internal electrodes 116 to form voids in the internal electrodes 116, which may lead to a reduction in effective area and a decrease in the linearity of the end portions of the internal electrodes 116. However, since it is possible to form the multilayer capacitor 110 without including a firing process at a temperature exceeding the melting point of the inner resin layer 114a, there is no reduction in effective area or linearity due to over-sintering of the first internal electrode layer 116a, the second internal electrode layer 116b, and the floating internal electrode layer 116c. Therefore, the area of the internal electrodes 116 per unit number of sheets can be maximized, so the maximum capacitance can be obtained. Furthermore, since the linearity of the end portions of the internal electrodes 116 can be improved, the ESR reduces.

The first internal electrode layer 116a, the second internal electrode layer 116b, and the floating internal electrode layer 116c preferably have no voids. Thus, the current path of the multilayer capacitor 110 shortens, with the result that the ESR can be reduced.

The linearity of each of the end portions of the first internal electrode layer 116a or the second internal electrode layer 116b, where the first internal electrode layer 116a or the second internal electrode layer 116b is in contact with the inner resin layer 114a, is, for example, preferably greater than or equal to about 1.0 and less than or equal to about 1.5. Furthermore, the linearity of each of the end portions of the first internal electrode layer 116a or the second internal electrode layer 116b, where the first internal electrode layer 116a or the second internal electrode layer 116b is in contact with the inner resin layer 114a, is, for example, preferably about 1.0. Thus, the current path can be provided in a route close to the shortest path, so the ESR can be reduced.

Here, the linearity of each of the end portions in the width direction y, where the first internal electrode layer 116a and the second internal electrode layer 116b are in contact with the inner resin layer 114a, can be calculated using, for example, a method the same as or similar to a calculation method for the linearity of each of the end portions, in the width direction y, of the internal electrode layer 16 according to the first example embodiment.

The linearity of each of the end portions in the length direction z, where the first internal electrode layer 116a and the second internal electrode layer 116b are in contact with the inner resin layer 114a, can be calculated using, for example, a method the same as or similar to a calculation method for the linearity of each of the end portions, in the length direction z, of the internal electrode layer 16 according to the first example embodiment.

Furthermore, as shown in FIG. 8, among the end portions of the first internal electrode layer 116a, the first end surface 112e-side end portion that is the end portion exposed at any of the first side surface 112c, the second side surface 112d, the first end surface 112e, and the second end surface 112f of the multilayer body 112 is reduced in thickness in the lamination direction x toward the surface (the second end surface 112f) opposite the surface at which the first internal electrode layer 116a is exposed. In other words, when the first internal electrode layer 116a is exposed at the first end surface 112e, the first internal electrode layer 116a is configured to have a triangular or substantially triangular shape that reduces in length in the lamination direction x from the first end surface 112e toward the second end surface 112f in the cross section of the lamination direction x and the length direction z (LT cross section). As a result, the bonding area between the first outer electrode 30a and the first internal electrode layer 116a is increased, such that the adhesion strength is increased, and the ESR is reduced.

Where a region in which, among the end portions of the first internal electrode layer 116a, the first end surface 112e-side end portion that is the end portion exposed at any of the first side surface 112c, the second side surface 112d, the first end surface 112e, and the second end surface 112f of the multilayer body 112 is reduced in thickness in the lamination direction x toward the surface (the second end surface 112f) opposite the surface at which the first internal electrode layer 116a is exposed is a first exposed end region 150a, the entire or substantially the entire first exposed end region 150a is preferably exposed from the multilayer body 112. By exposing the entire or substantially the entire first exposed end region 150a from the multilayer body 112, the bonding area between the first outer electrode 30a and the first internal electrode layer 116a is increased, so the adhesion strength is increased, and the ESR is reduced.

At this time, among the thicknesses of the first internal electrode layer 116a in the lamination direction x, the ratio between the thickest portion and the thinnest portion is, for example, preferably such that the thickest portion is about 1.5 times or more and about 2.5 times or less the thinnest portion. With such a configuration, the adhesion strength between the first outer electrode 30a and the first internal electrode layer 116a can be increased without increasing the thickness of the multilayer body 112 in the lamination direction x.

The first exposed end region 150a can be formed, for example, by immersing the first end surface 112e of the multilayer body 112 in an etchant to etch the inner resin layer 114a.

Furthermore, as shown in FIG. 8, among the end portions of the second internal electrode layer 116b, the second end surface 112f-side end portion that is the end portion exposed at any of the first side surface 112c, the second side surface 112d, the first end surface 112e, and the second end surface 112f of the multilayer body 112 is reduced in thickness in the lamination direction x toward the surface (the first end surface 112e) opposite the surface at which the second internal electrode layer 116b is exposed. In other words, when the second internal electrode layer 116b is exposed at the second end surface 112f, the second internal electrode layer 116b is configured to have a triangular or substantially triangular shape that reduces in length in the lamination direction x from the second end surface 112f toward the first end surface 112e in the cross section of the lamination direction x and the length direction z (LT cross section). As a result, the bonding area between the second outer electrode 30b and the second internal electrode layer 116b is increased, so the adhesion strength is increased, and the ESR is reduced.

Where a region in which, among the end portions of the second internal electrode layer 116b, the second end surface 112f-side end portion that is the end portion exposed at any of the first side surface 112c, the second side surface 112d, the first end surface 112e, and the second end surface 112f of the multilayer body 112 is reduced in thickness in the lamination direction x toward the surface (the first end surface 112e) opposite the surface at which the second internal electrode layer 116b is exposed is a second exposed end region 150b, the entire or substantially the entire second exposed end region 150b is preferably exposed from the multilayer body 112. By exposing the entire or substantially the entire second exposed end region 150b from the multilayer body 112, the bonding area between the second outer electrode 30b and the second internal electrode layer 116b is increased, so the adhesion strength is increased, and the ESR is reduced.

At this time, among the thicknesses of the second internal electrode layer 116b in the lamination direction x, the ratio between the thickest portion and the thinnest portion is, for example, preferably such that the thickest portion is about 1.5 times or more and about 2.5 times or less the thinnest portion. With such a configuration, the adhesion strength between the second outer electrode 30b and the second internal electrode layer 116b can be increased without increasing the thickness of the multilayer body 112 in the lamination direction x.

The second exposed end region 150b can be formed, for example, by immersing the second end surface 112f of the multilayer body 112 in an etchant to etch the inner resin layer 114a.

The thickness, in the lamination direction x, of each of the end portions of the first internal electrode layer 116a in the width direction y is preferably thicker than the thickness, in the lamination direction x, of the center portion of the first internal electrode layer 116a in the width direction y. Similarly, the thickness, in the lamination direction x, of each of the end portions of the second internal electrode layer 116b in the width direction y is preferably thicker than the thickness, in the lamination direction x, of the center portion of the second internal electrode layer 116b in the width direction y. Current flows along the end portions of the first internal electrode layer 116a in the width direction y and the end portions of the second internal electrode layer 116b in the width direction y, so, when the thickness, in the lamination direction x, of each of the end portions of each of the internal electrode layers 116a, 116b in the width direction y is made thicker than the thickness, in the lamination direction x, of the center side of each of the internal electrode layers 116a, 116b, it is possible to allow more current to flow. Thus, the ESR can be reduced.

The number of the first internal electrode layers 116a and the second internal electrode layers 116b is, for example, preferably greater than or equal to 15 in total and less than or equal to 200 in total. The number of the floating internal electrode layers 116c is, for example, preferably greater than or equal to 15 and less than or equal to 200.

The multilayer body 112 may include first notches extending from the first end surface 112e, at which the first internal electrode layers 116a are exposed, toward the second end surface 112f that is the opposite surface. Similarly, the multilayer body 112 may include second notches extending from the second end surface 112f, at which the second internal electrode layers 116b are exposed, toward the first end surface 112e that is the opposite surface. As a result, the outer electrodes 30 can enter the first notches and the second notches to improve the adhesion strength between the multilayer body 112 and the outer electrodes 30 due to the anchor effect.

The first notches and the second notches can be formed, for example, by immersing the first end surface 112e and the second end surface 112f of the multilayer body 112 in an etchant to etch the inner resin layer 114a.

The manufacturing method for the multilayer capacitor 110 according to the second example embodiment is, for example, the same or substantially the same as the manufacturing method for the multilayer capacitor 10 according to the first example embodiment, except for the point that the first internal electrode layer 116a and the second internal electrode layer 116b are disposed on the same inner resin layer 114a and the first internal electrode layer 116a and the second internal electrode layer 116b and the floating internal electrode layer 116c are alternately laminated.

The multilayer capacitor 110 according to the second example embodiment with the configuration as described above provides advantageous effects the same as or similar to those of the multilayer capacitor 10 according to the first example embodiment in addition to the above-described advantageous effects.

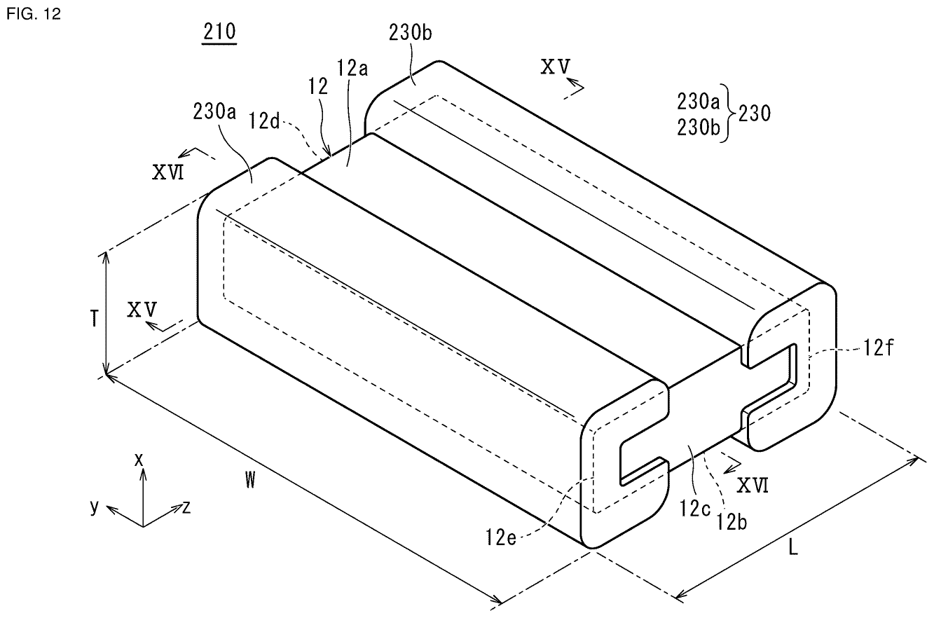

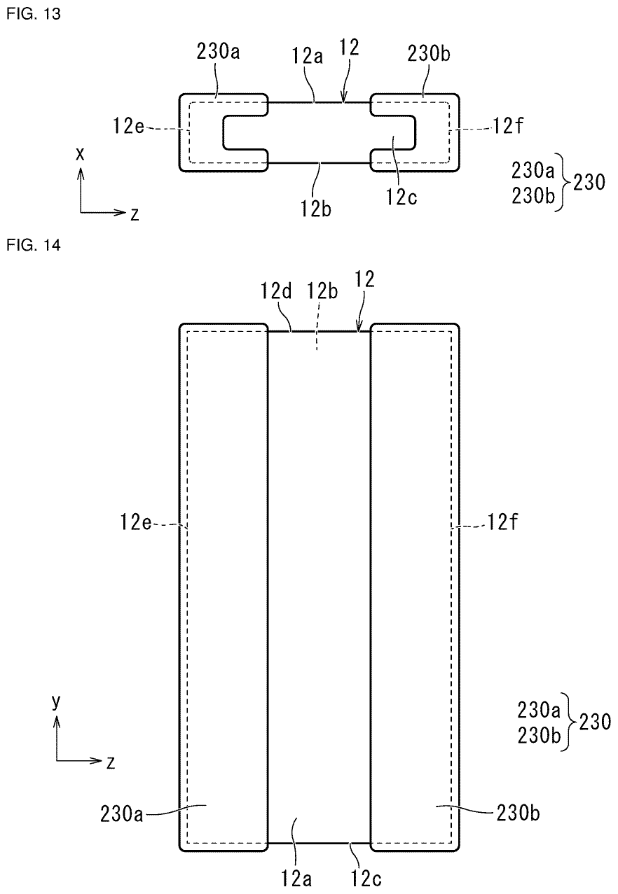

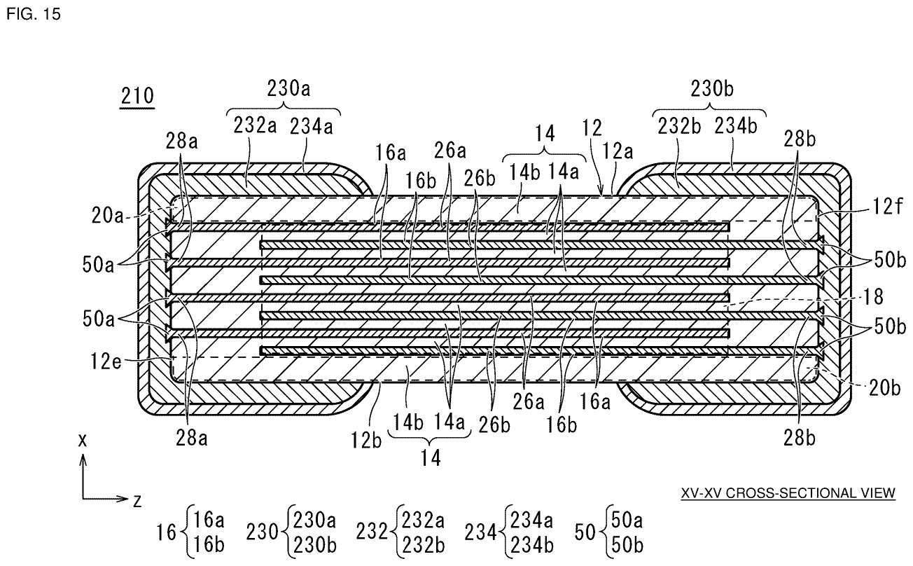

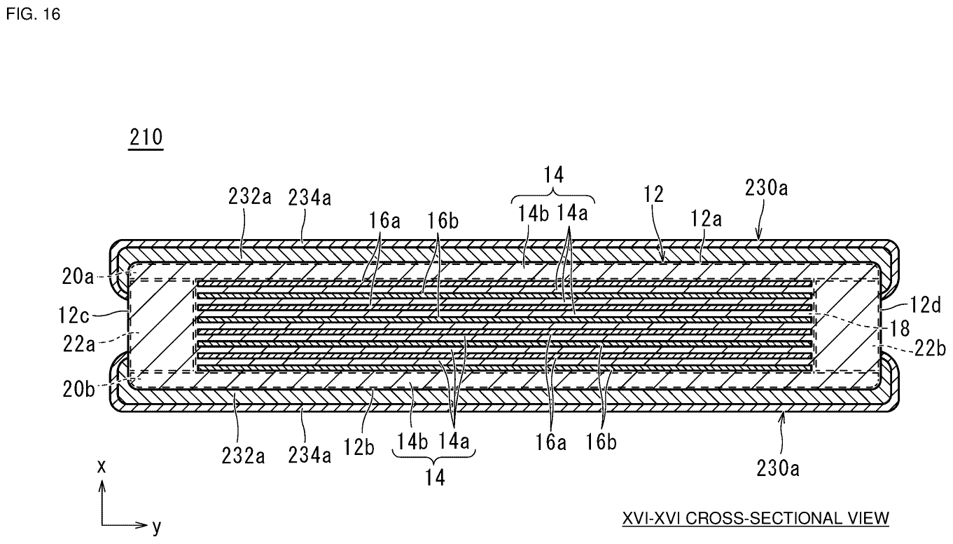

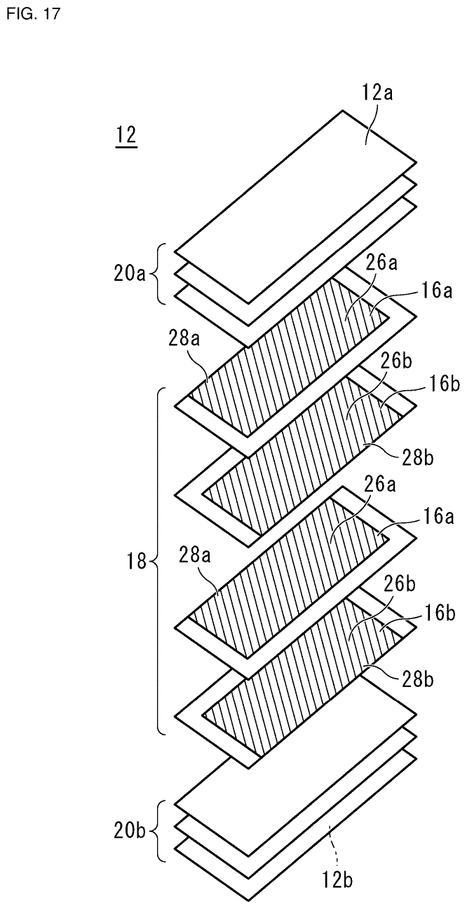

Next, a multilayer capacitor 210 according to a third example embodiment of the present invention will be described. FIG. 12 is an external perspective view of the multilayer capacitor according to the third example embodiment of the present invention. FIG. 13 is a front view of the multilayer capacitor according to the third example embodiment of the present invention. FIG. 14 is a top view of the multilayer capacitor according to the third example embodiment of the present invention. FIG. 15 is a cross-sectional view taken along the line XV-XV in FIG. 12. FIG. 16 is a cross-sectional view taken along the line XVI-XVI in FIG. 12. FIG. 17 is an exploded perspective view of a multilayer body shown in FIG. 12.

The multilayer capacitor 210 according to the third example embodiment includes a multilayer body 12 having a configuration the same as or similar to that of the multilayer capacitor 10 according to the first example embodiment, and outer electrodes 230. However, the multilayer capacitor 210 has a dimension L and a dimension W that are interchanged from the multilayer capacitor 10 according to the first example embodiment. Therefore, the same reference signs denote the components corresponding to the components of the multilayer capacitor 10 according to the first example embodiment, and the detailed description thereof is omitted.

In the multilayer capacitor 210 according to the third example embodiment, the outer electrodes 230 are disposed on the first end surface 12e side and the second end surface 12f side of the multilayer body 12. The outer electrodes 230 include a first outer electrode 230a and a second outer electrode 230b.

The first outer electrode 230a is disposed on one or more of the first principal surface 12a, the second principal surface 12b, the first side surface 12c, the second side surface 12d, the first end surface 12e, and the second end surface 12f of the multilayer body 12. In the present example embodiment, the first outer electrode 230a is connected to the first internal electrode layers 16a and is disposed so as to extend from the first and the second principal surface 12b.

The second outer electrode 230b is disposed on one or more of the first principal surface 12a, the second principal surface 12b, the first side surface 12c, the second side surface 12d, the first end surface 12e, and the second end surface 12f of the multilayer body 12. In the present example embodiment, the second outer electrode 230b is connected to the second internal electrode layers 16b and is disposed so as to extend from the second end surface 12f to portion of the first principal surface 12a and the second principal surface 12b.

As shown in FIG. 12, the shape of each of the first outer electrode 230a and the second outer electrode 230b is a square U-shape in front view. However, not limited to this configuration, the shape of each of the first outer electrode 230a and the second outer electrode 230b can also be, for example, a V-shape or U-shape in front view.

Each of the outer electrodes 230 includes a base electrode layer 232 disposed on at least one of the first principal surface 12a, the second principal surface 12b, the first end surface 12e, and the second end surface 12f, and a plating layer 234 that covers the base electrode layer 232.

The base electrode layers 232 include a first base electrode layer 232a and a second base electrode layer 232b. In the present example embodiment, the first base electrode layer 232a is disposed so as to extend from the first and the second principal surface 12b. The second base electrode layer 232b is disposed so as to extend from the second end surface 12f to a portion of the first principal surface 12a and the second principal surface 12b.

The base electrode layer 232 includes, for example, at least one of a baked layer, a conductive resin layer, a thin film layer, or the like. The base electrode layer 232 corresponds to the base electrode layer 32 of the first example embodiment. The material of the base electrode layer 232 and a manufacturing method for the base electrode layer 232 are, for example, the same or substantially the same as those of the base electrode layer 32 of the first example embodiment, so the description is omitted.

The plating layers 234 include a first plating layer 234a and a second plating layer 234b. The first plating layer 234a is disposed so as to cover the first base electrode layer 232a. The second plating layer 234b is disposed so as to cover the second base electrode layer 232b.

The plating layer 234 corresponds to the plating layer 34 of the first example embodiment. The material of the plating layer 234 and a manufacturing method for the plating layer 234 are, for example, the same or substantially the same as those of the plating layer 34 of the first example embodiment, so the description is omitted.

The manufacturing method for the multilayer capacitor according to the third example embodiment is, for example, the same or substantially the same as the manufacturing method for the multilayer capacitor 10 according to the first example embodiment. However, the multilayer capacitor is manufactured so as to have a dimension L and a dimension W that are interchanged from the multilayer capacitor 10 according to the first example embodiment.

The multilayer capacitor 210 according to the third example embodiment with the configuration as described above achieves advantageous effects the same as or similar to those of the multilayer capacitor 10 according to the first example embodiment.

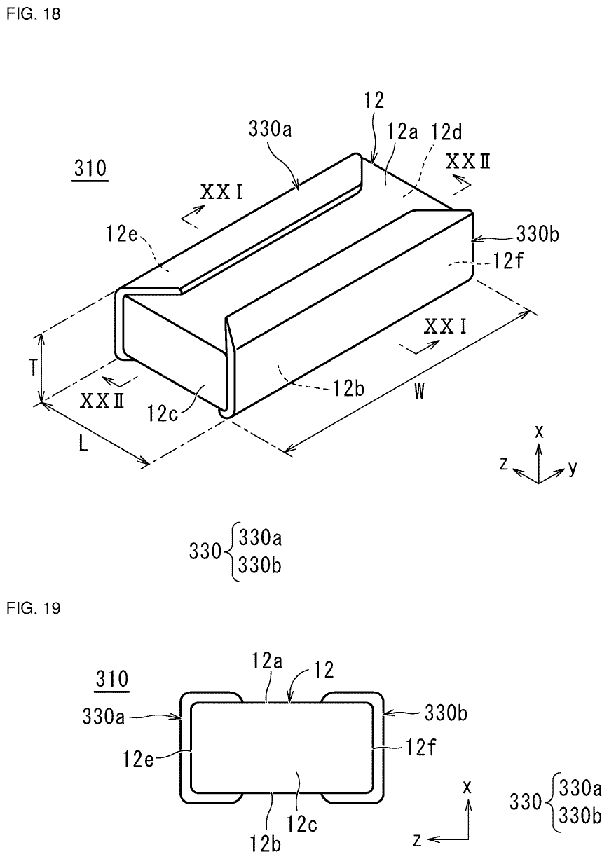

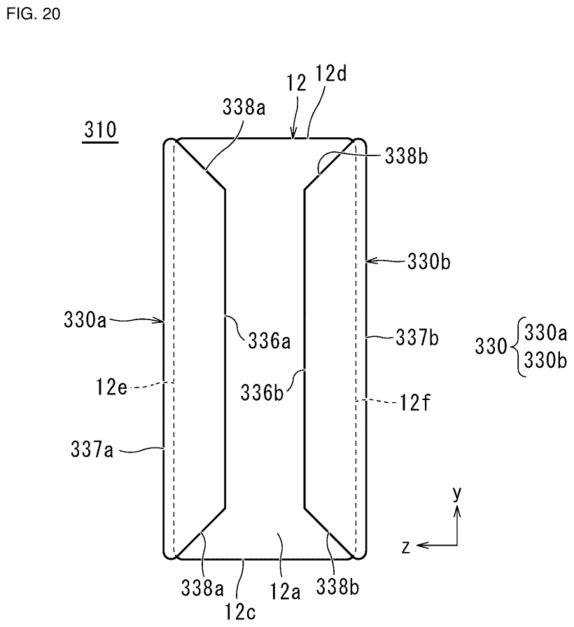

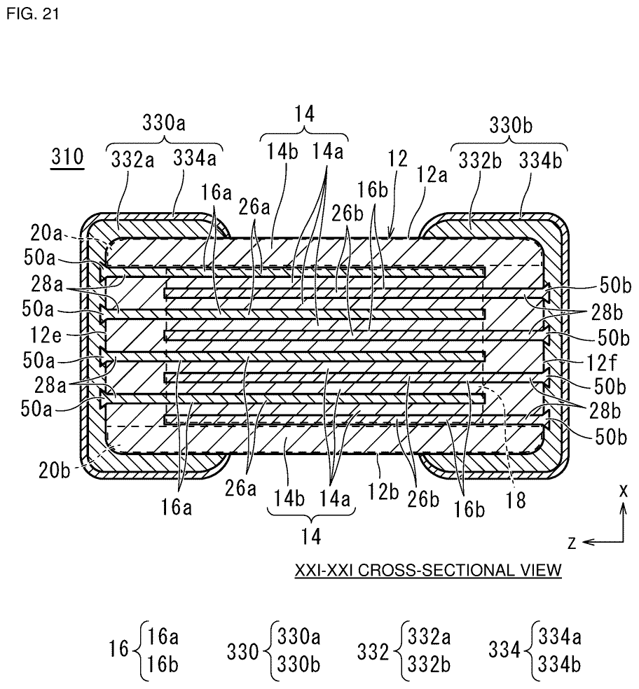

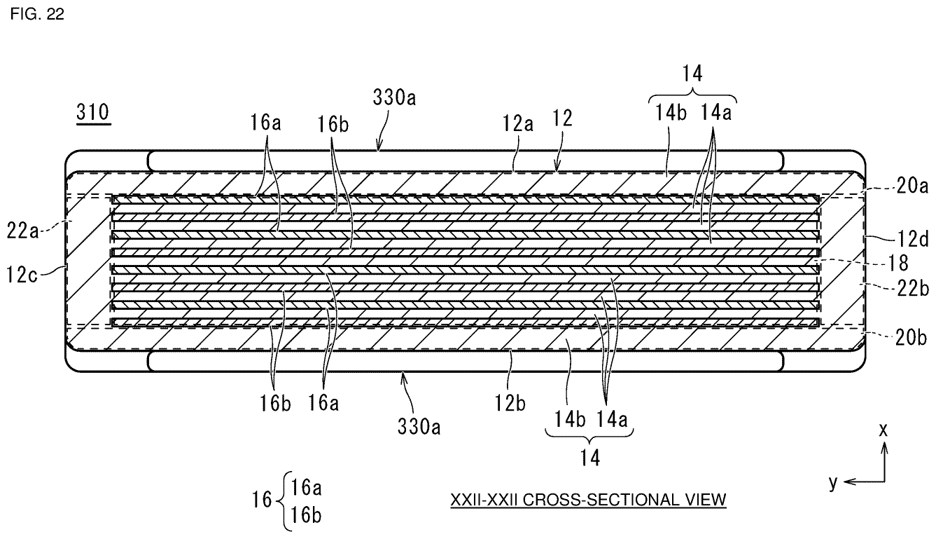

Next, a multilayer capacitor 310 according to a fourth example embodiment of the present invention will be described. FIG. 18 is an external perspective view of the multilayer capacitor according to the fourth example embodiment of the present invention. FIG. 19 is a front view of the multilayer capacitor according to the fourth example embodiment of the present invention. FIG. 20 is a top view of the multilayer capacitor according to the fourth example embodiment of the present invention. FIG. 21 is a cross-sectional view taken along the line XXI-XXI in FIG. 18. FIG. 22 is a cross-sectional view taken along the line XXII-XXII in FIG. 18.

The multilayer capacitor 310 according to the fourth example embodiment multilayer body 12 having a configuration the same as or similar to that of the multilayer capacitor 10 according to the first example embodiment, and outer electrodes 330. However, the multilayer capacitor 310 has a dimension L and a dimension W that are interchanged from the multilayer capacitor 10 according to the first example embodiment. Therefore, the same reference denote the components corresponding to the components of the multilayer capacitor 10 according to the first example embodiment, and the detailed description thereof is omitted.

In the multilayer capacitor 310 according to the fourth example embodiment, the outer electrodes 330 are disposed on the first end surface 12e side and the second end surface 12f side of the multilayer body 12. The outer electrodes 330 include a first outer electrode 330a and a second outer electrode 330b.

The first outer electrode 330a is disposed on one or more of the first principal surface 12a, the second principal surface 12b, the first side surface 12c, the second side surface 12d, the first end surface 12e, and the second end surface 12f of the multilayer body 12. In the present example embodiment, the first outer electrode 330a is connected to the first internal electrode layers 16a and is disposed so as to extend from the first end surface 12e to a portion of the first principal surface 12a and the second principal surface 12b.

The second outer electrode 330b is disposed on one or more of the first principal surface 12a, the second principal surface 12b, the first side surface 12c, the second side surface 12d, the first end surface 12e, and the second end surface 12f of the multilayer body 12. In the present example embodiment, the second outer electrode 330b is connected to the second internal electrode layers 16b and is disposed so as to extend from the second end surface 12f to a portion of the first principal surface 12a and the second principal surface 12b.

On the surface of the first principal surface 12a, the first outer electrode 330a includes a first edge 336a facing the second outer electrode 330b, a second edge 337a that is in contact with the first end surface 12e, and fifth edges 338a connecting the first edge 336a and the second edge 337a on both of the first side surface 12c side and the second side surface 12d side. The first outer electrode 330a is similarly provided on the second principal surface 12b. Furthermore, the length of the first edge 336a of the first outer electrode 330a is shorter than the length of the second edge 337a of the first outer electrode 330a.

On the surface of the first principal surface 12a, the second outer electrode 330b includes a third edge 336b facing the first outer electrode 330a, a fourth edge 337b that is in contact with the second end surface 12f, and sixth edges 338b connecting the third edge 336b and the fourth edge 337b on both the first side surface 12c side and the second side surface 12d side. The second outer electrode 330b is similarly provided on the second principal surface 12b. Furthermore, the length of the third edge 336b of the second outer electrode 330b is shorter than the length of the fourth edge 337b of the second outer electrode 330b.

With the above configuration, the fifth edges 338a connecting the first edge 336a and the second edge 337a of the first outer electrode 330a and the sixth edges 338b connecting the third edge 336b and the fourth edge 337b of the second outer electrode 330b can reduce or prevent the regions that are in contact with a ridge portion where the first principal surface 12a and the first side surface 12c intersect and a ridge portion where the first principal surface 12a and the second side surface 12d intersect. As a result, the multilayer capacitor 310 can reduce or prevent the concentration of the bending stress generated by the linear expansion and contraction of a mounting substrate and the tensile stress applied to the outer electrodes 330 at the corner portions where the first principal surface 12a and the second principal surface 12b of the multilayer body 12 intersect. As a result, it is possible to reduce or prevent the stress transmitted from the outer electrodes 330 to the multilayer body 12. Therefore, it is possible to reduce or prevent the occurrence of cracks in the multilayer capacitor 310.

Each of the outer electrodes 330 includes a base electrode layer 332 disposed on at least one of the first principal surface 12a, the second principal surface 12b, the first end surface 12e, and the second end surface 12f, and a plating layer 334 that covers the base electrode layer 332. In the present example embodiment, the shape of the outer electrode 330 (base electrode layer 332) is controlled by the design of a mask.

The base electrode layers 332 include a first base electrode layer 332a and a second base electrode layer 332b. In the present example embodiment, the first base electrode layer 332a is disposed so as to extend from the first and the second principal surface 12b. The second base electrode layer 332b is disposed so as to extend from the second end surface 12f to a portion of the first principal surface 12a and the second principal surface 12b.

The base electrode layer 332 includes, for example, at least one of a baked layer, a conductive resin layer, a thin film layer, and the like. The base electrode layer 332 corresponds to the base electrode layer 32 of the first example embodiment. The material of the base electrode layer 332 and a manufacturing method for the base electrode layer 332 are, for example, the same or substantially the same as those of the base electrode layer 32 of the first example embodiment, so the description is omitted.

The plating layers 334 include a first plating layer 334a and a second plating layer 334b. The first plating layer 334a is disposed so as to cover the first base electrode layer 332a. The second plating layer 334b is disposed so as to cover the second base electrode layer 332b.

The plating layer 334 corresponds to the plating layer 34 of the first example embodiment. The material of the plating layer 334 and a manufacturing method for the plating layer 334 are, for example, the same or substantially the same as those of the plating layer 34 of the first example embodiment, so the description is omitted.

The manufacturing method for the multilayer capacitor 310 according to the fourth example embodiment is, for example, the same or substantially the same as the manufacturing method for the multilayer capacitor 10 according to the first example embodiment. However, the multilayer capacitor is manufactured so as to have a dimension L and a dimension W that are interchanged from the multilayer capacitor 10 according to the first example embodiment. The shape of the outer electrode 330 can be controlled by the design of the mask and formed.

The multilayer capacitor 310 according to the fourth example embodiment with the configuration as described above provides advantageous effects the same as or similar to those of the multilayer capacitor 10 according to the first example embodiment in addition to the above-described advantageous effects.

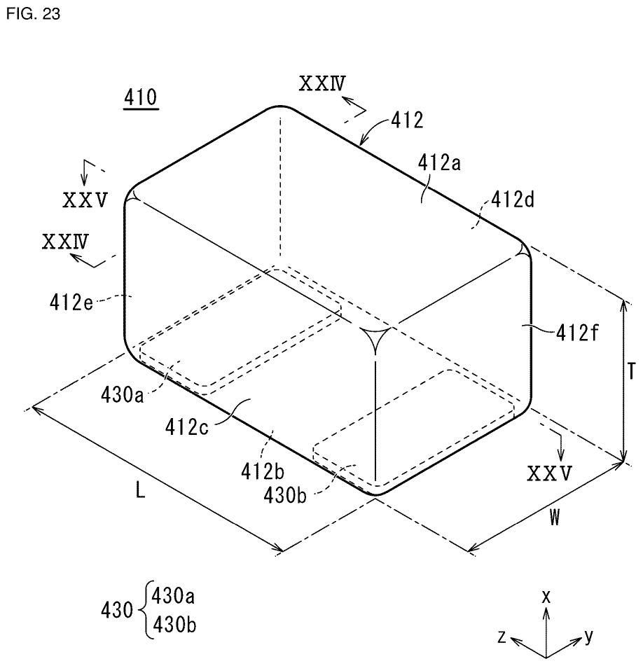

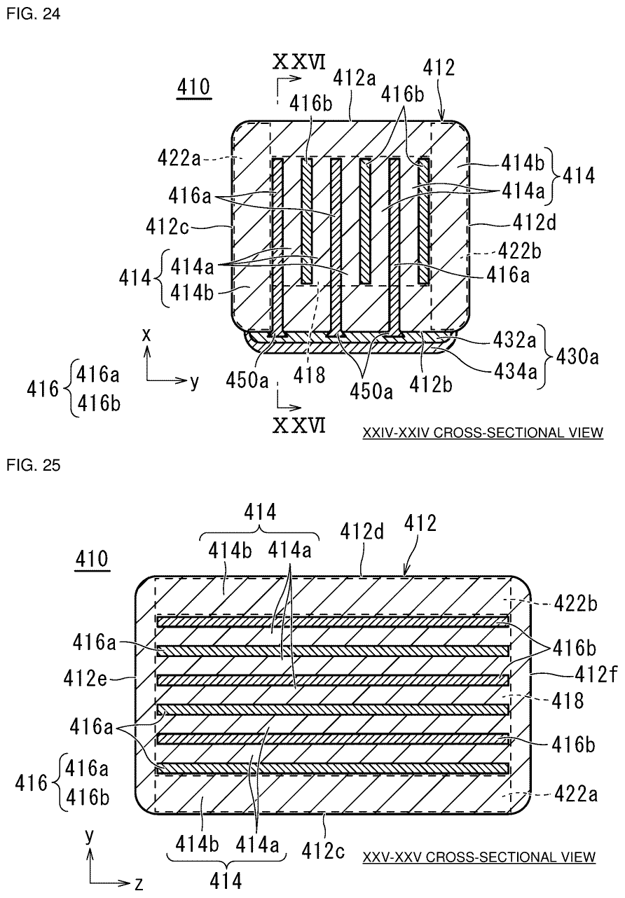

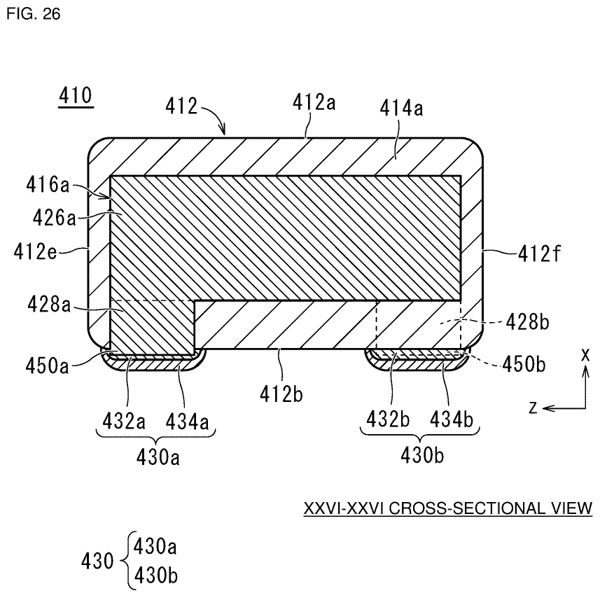

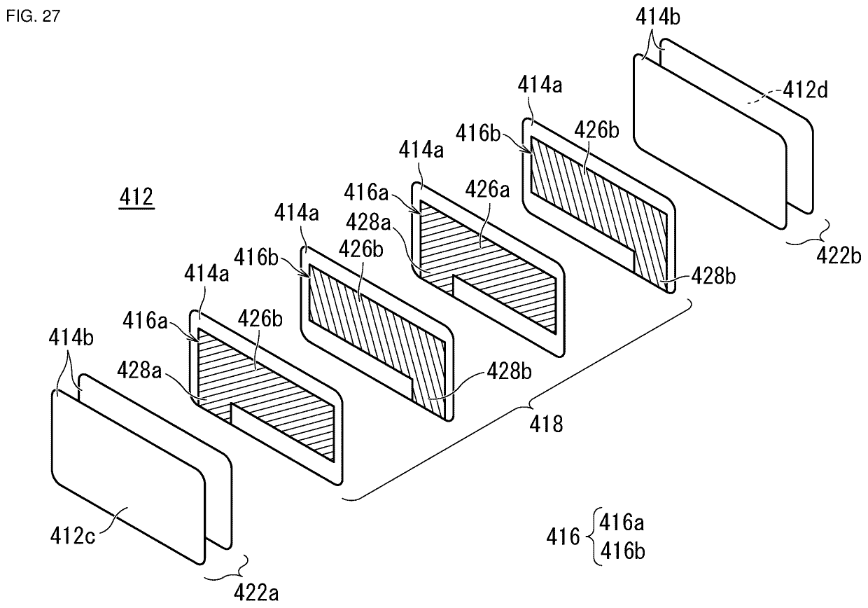

Next, a multilayer capacitor 410 according to a fifth example embodiment of the present invention will be described. FIG. 23 is an external perspective view of the multilayer capacitor according to the fifth example embodiment of the present invention. FIG. 24 is a cross-sectional view taken along the line XXIV-XXIV in FIG. 23. FIG. 25 is a cross-sectional view taken along the line XXV-XXV in FIG. 23. FIG. 26 is a cross-sectional view taken along the line XXVI-XXVI in FIG. 23. FIG. 27 is an exploded perspective view of a multilayer body shown in FIG. 23.

The multilayer capacitor 410 includes a multilayer body 412 and outer electrodes 430.

The multilayer body 412 includes a first principal surface 412a and a second principal surface 412b opposite to each other in a height direction x, a first side surface 412c and a second side surface 412d opposite to each other in a width direction y orthogonal or substantially orthogonal to the height direction x, and a first end surface 412e and a second end surface 412f opposite to each other in a length direction z orthogonal or substantially orthogonal to the height direction x and the width direction y. The first principal surface 412a and the second principal surface 412b each extend in the width direction y and the length direction z. The first side surface 412c and the second side surface 412d each extend in the height direction x and the length direction z. The first end surface 412e and the second end surface 412f each extend in the height direction x and the width direction y. Therefore, the height direction x is a direction connecting the first principal surface 412a and the second principal surface 412b, the width direction y is a direction connecting the first side surface 412c and the second side surface 412d, and the length direction z is a direction connecting the first end surface 412e and the second end surface 412f. The first principal surface 412a and the second principal surface 412b are parallel to the surface (mounting surface) on which the multilayer capacitor 410 is mounted.

The multilayer body 412 includes multiple resin layers 414 and multiple internal electrode layers 416, which are laminated. The resin layers 414 include inner resin layers 414a and outer resin layers 414b. The internal electrode layers 416 include first internal electrode layers 416a and second internal electrode layers 416b. In the present example embodiment, the resin layers 414 and the internal electrode layers 416 are laminated in the width direction y.

The multilayer body 412 includes an inner layer portion 418 and two outer layer portions 422a, 422b sandwiching the inner layer portion 418 in the width direction y. Between the two outer layer portions 422a, 422b, the outer layer portion on the first side surface 412c side is referred to as a first side surface-side outer layer portion 422a, and the outer layer portion on the second side surface 412d side is referred to as a second side surface-side outer layer portion 422b.

More specifically, the multilayer body 412 includes the inner layer portion 418 including one or more inner resin layers 414a and multiple internal electrode layers 416 disposed on top of them. The internal electrode layers 416 include first internal electrode layers 416a extending to the second principal surface 412b on the first end surface 412e side and second internal electrode layers 416b extending to the second principal surface 412b on the second end surface 412f side. In the inner layer portion 418, the multiple first internal electrode layers 416a and the multiple second internal electrode layers 416b are opposed to each other with the inner resin layer 414a interposed therebetween.

The multilayer body 412 includes the first side surface-side outer layer portion 422a including multiple outer resin layers 414b positioned on the first side surface 412c side between the first side surface 412c and both of the outermost surface of the first side surface 412c-side inner layer portion 418 and a straight line extending from the outermost surface.

Similarly, the multilayer body 412 includes the second side surface-side outer layer portion 422b including multiple outer resin layers 414b positioned on the second side surface 412d side between the second side surface 412d and both of the outermost surface of the second side surface 412d-side inner layer portion 418 and a straight line extending from the outermost surface.

For example, resins, such as liquid crystal polymer (LCP) resin, epoxy resin, or polyimide resin, which are excellent in heat resistance, can be used as the components of the resin layers 414, that is, the inner resin layers 414a and the outer resin layers 414b. However, the components are not limited thereto.

The outer resin layers 414b of each of the first side surface-side outer layer portion 422a and the second side surface-side outer layer portion 422b include the same type of resin material as the inner resin layers 414a. Each of the first side surface-side outer layer portion 422a and the second side surface-side outer layer portion 422b may include multiple outer resin layers 414b or may include a single outer resin layer 414b.

The inner resin layers 414a and the outer resin layers 414b may include different components. For example, the inner resin layers 414a may include a resin with a high dielectric constant, and the outer resin layers 414b may include components with good moisture resistance, weather resistance, and strength. The number of inner resin layers 414a and outer resin layers 414b laminated is not limited and is, for example, preferably greater than or equal to 15 and less than or equal to 200, including the outer resin layers 414b. The thickness of the inner resin layer 414a is, for example, preferably greater than or equal to about 0.2 μm and less than or equal to about 10.0 μm.

The multilayer body 412 includes multiple first internal electrode layers 416a and multiple second internal electrode layers 416b as the multiple internal electrode layers 416.

Each of the first internal electrode layers 416a is disposed on the surface of a corresponding one of the inner resin layers 414a. The first internal electrode layer 416a includes a first counter electrode portion 426a facing the first side surface 412c and the second side surface 412d, and a first lead-out electrode portion 428a extending from the first counter electrode portion 426a to the second principal surface 412b. The first lead-out electrode portion 428a includes an end portion extending to and exposed at the second principal surface 412b.

Each of the second internal electrode layers 416b is disposed on the surface of a corresponding one of the inner resin layers 414a, different from the inner resin layer 414a where the first internal electrode layer 416a is disposed. The second internal electrode layer 416b includes a second counter electrode portion 426b facing the first side surface 412c and the second side surface 412d, and a second lead-out electrode portion 428b extending from the second counter electrode portion 426b to the second principal surface 412b. The second lead-out electrode portion 428b includes an end portion extending to and exposed at the second principal surface 412b.

The first internal electrode layers 416a and the second internal electrode layers 416b are not exposed at the first principal surface 412a, both side surfaces 412c, 412d, and both end surfaces 412e, 412f of the multilayer body 412. Each of the first internal electrode layers 416a and the second internal electrode layers 416b has an L-shaped.

Each of the first internal electrode layers 416a and the second internal electrode layers 416b is disposed perpendicular or substantially perpendicular to the first principal surface 412a and the second principal surface 412b of the multilayer body 412. The first counter electrode portion 426a of the first internal electrode layer 416a and the second counter electrode portion 426b of the second internal electrode layer 416b are disposed so as to face each other.

The first internal electrode layer 416a and the second internal electrode layer 416b can include a suitable conductive material, for example, a metal such as Ni, Cu, Ag, Pd, or Au or an alloy that includes one of these metals, such as Ag—Pd, However, the first internal electrode layer 416a and the second internal electrode layer 416b are not limited thereto. In the present example embodiment, the first internal electrode layer 416a and the second internal electrode layer 416b include, for example, Cu having high conductivity as a main component. Thus, it is possible to reduce the ESR of the multilayer capacitor 410.

The dielectric constant of the inner resin layer 414a is lower than those of dielectric materials used in existing multilayer capacitors, so, in order to provide a capacitor of the same capacitance, it is necessary to increase the areas of the counter electrode portions 426a, 426b accordingly. Therefore, it is necessary to increase the number of the first internal electrode layers 416a and the second internal electrode layers 416b. As a result, the total area of the internal electrode layers 416 increases, so it is possible to reduce the ESR of the multilayer capacitor 410. Furthermore, since the multilayer body 412 includes the inner resin layers 414a and the outer resin layers 414b, even when warpage occurs in the multilayer capacitor 410, the warpage can be absorbed by the inner resin layers 414a and the outer resin layers 414b, so the warpage strength can be improved. Therefore, compared to the existing multilayer capacitors, the mechanical strength can be improved.

Furthermore, when a multilayer ceramic capacitor, which is an example of the existing multilayer capacitor, is manufactured, the sintering temperature of the dielectric ceramic is higher than the sintering temperature of the internal electrode 416 when the dielectric ceramic is fired. As a result, there is a risk that particles couple together due to over-sintering of the internal electrodes 416 to form voids in the internal electrodes 416, which may lead to a reduction in effective area and a decrease in the linearity of the end portions of the internal electrodes 416. However, since it is possible to form the multilayer capacitor 410 without including a firing process at a temperature exceeding the melting point of the inner resin layer 414a, there is no reduction in effective area or linearity due to over-sintering of the first internal electrode layer 416a and the second internal electrode layer 416b. Therefore, the area of the internal electrodes 416 per unit number of sheets can be maximized, so the maximum capacitance can be obtained. Furthermore, since the linearity of the end portions of the internal electrodes 416 can be improved, the ESR is reduced.

The first internal electrode layer 416a and the second internal electrode layer 416b preferably have no voids. Thus, the current path of the multilayer capacitor 410 shortens, with the result that the ESR can be reduced.

The linearity of each of the end portions of the first internal electrode layer 416a or the second internal electrode layer 416b, where the first internal electrode layer 416a or the second internal electrode layer 416b is in contact with the inner resin layer 414a, is, for example, preferably greater than or equal to about 1.0 and less than or equal to about 1.5. Furthermore, the linearity of each of the end portions of the first internal electrode layer 416a or the second internal electrode layer 416b, where the first internal electrode layer 416a or the second internal electrode layer 416b is in contact with the inner resin layer 414a, is, for example, preferably about 1.0. Thus, the current path can be provided in a route close to the shortest path, so the ESR can be reduced.

Here, the linearity of each of the end portions of the first internal electrode layer 416a in the height direction x is calculated by the following method.

First, the multilayer capacitor 410 is ground in the length direction z and the height direction x (LT cross section) to expose the first internal electrode layer 416a.

Subsequently, an SEM image of the end portions, in the height direction x, of the first internal electrode layer 416a exposed at the surface is taken using a scanning electron microscope (SEM) at a magnification of about 2000 times centered on about 1/2L of the multilayer capacitor 410, and the perimeter, average vertical chord length, and image width are measured. The length of the end portion of the internal electrode layer is denoted by A, the image width is denoted by B, the average vertical chord length is denoted by C, and the perimeter is denoted by D. From the SEM image, the perimeter, average vertical chord length, and image width are measured, and the lengths <A> of the end portions of the first internal electrode layer 416a are calculated using (Equation 1).

(The length of the end portion<A>)=(Perimeter<D>)−(Average vertical chord length<C>)×2−(Image width<B>) (Equation 1)

Finally, using (Equation 2), the linearity of each of the end portions of the first internal electrode layer 416a is calculated.

(The linearity of the end portion)=(The length of the end portion<A>)/(image width<B>) (Equation 2)

The linearity of each of the end portions of the first internal electrode layer 416a in the length direction z is calculated by the following method.

First, the multilayer capacitor 410 is ground in the length direction z and the height direction x (LT cross section) to expose the first internal electrode layer 416a.

Subsequently, an SEM image of the end portions, in the length direction z, of the first internal electrode layer 416a exposed at the surface is taken using a scanning electron microscope (SEM) at a magnification of about 2000 times centered on about 1/2T of the multilayer capacitor 410, and the perimeter, average vertical chord length, and image width are measured. The length of the end portion of the internal electrode layer is denoted by A, the image width is denoted by B, the average vertical chord length is denoted by C, and the perimeter is denoted by D. From the SEM image, the perimeter, average vertical chord length, and image width are measured, and the linearity of each of the end portions of the first internal electrode layer 416a in the length direction z is calculated using the above (Equation 1) and (Equation 2).

The linearity of each of the end portions of the second internal electrode layer 416b in the height direction x is calculated by the following method.

First, the multilayer capacitor 410 is ground in the length direction z and the height direction x (LT cross section) to expose the second internal electrode layer 416b.

Subsequently, an SEM image of the end portions, in the height direction x, of the second internal electrode layer 416b exposed at the surface is taken using a scanning electron microscope (SEM) at a magnification of about 2000 times centered on about 1/2L of the multilayer capacitor 410, and the perimeter, average vertical chord length, and image width are measured. The length of the end portion of the internal electrode layer is denoted by A, the image width is denoted by B, the average vertical chord length is denoted by C, and the perimeter is denoted by D. From the SEM image, the perimeter, average vertical chord length, and image width are measured, and the linearity of each of the end portions of the second internal electrode layer 416b in the height direction x is calculated using the above (Equation 1) and (Equation 2).

The linearity of each of the end portions of the second internal electrode layer 416b in the length direction z is calculated by the following method.

First, the multilayer capacitor 410 is ground in the length direction z and the height direction x (LT cross section) to expose the second internal electrode layer 416b.

Subsequently, an SEM image of the end portions, in the length direction z, of the second internal electrode layer 416b exposed at the surface is taken using a scanning electron microscope (SEM) at a magnification of about 2000 times centered on about 1/2T of the multilayer capacitor 410, and the perimeter, average vertical chord length, and image width are measured. The length of the end portion of the internal electrode layer is denoted by A, the image width is denoted by B, the average vertical chord length is denoted by C, and the perimeter is denoted by D. From the SEM image, the perimeter, average vertical chord length, and image width are measured, and the linearity of each of the end portions of the second internal electrode layer 416b in the length direction z is calculated using the above (Equation 1) and (Equation 2).

Furthermore, as shown in FIG. 24, among the end portions of the first internal electrode layer 416a, the second principal surface 412b-side end portion that is the end portion exposed at one of the surfaces of the multilayer body 412 is reduced in thickness in the lamination direction toward the surface (the first principal surface 412a) opposite the surface at which the first internal electrode layer 416a is exposed. In other words, when the first internal electrode layer 416a is exposed at the second principal surface 412b, the first internal electrode layer 416a is configured to have a triangular or substantially triangular shape that reduces in length in the width direction y (the lamination direction in the present example embodiment) from the second principal surface 412b toward the first principal surface 412a in the cross section of the height direction x and the width direction y (WT cross section). As a result, the bonding area between the first outer electrode 430a and the first internal electrode layer 416a is increased, so the adhesion strength is increased, and the ESR is reduced.

Where a region in which, among the end portions of the first internal electrode layer 416a, the second principal surface 412b-side end portion that is the end portion exposed at one of the surfaces of the multilayer body 412 is reduced in thickness in the lamination direction toward the surface (the first principal surface 412a) opposite the surface at which the first internal electrode layer 416a is exposed is a first exposed end region 450a, the entire or substantially the entire first exposed end region 450a is preferably exposed from the multilayer body 412. By exposing the entire or substantially the entire first exposed end region 450a from the multilayer body 412, the bonding area between the first outer electrode 430a and the first internal electrode layer 416a is increased, so the adhesion strength is increased, and the ESR is reduced.

At this time, among the thicknesses of the first internal electrode layer 416a in the width direction y, the ratio between the thickest portion and the thinnest portion is, for example, preferably such that the thickest portion is about 1.5 times or more and about 2.5 times or less the thinnest portion.

The first exposed end region 450a can be formed, for example, by immersing the second principal surface 412b of the multilayer body 412 in an etchant to etch the inner resin layer 414a.

Furthermore, among the end portions of the second internal electrode layer 416b, the second principal surface 412b-side end portion that is the end portion exposed at one of the surfaces of the multilayer body 412 is reduced in thickness in the lamination direction toward the surface (the first principal surface 412a) opposite the surface at which the second internal electrode layer 416b is exposed. In other words, when the second internal electrode layer 416b is exposed at the second principal surface 412b, the second internal electrode layer 416b is configured to have a triangular or substantially triangular shape that reduces in length in the width direction y (the lamination direction in the present example embodiment) from the second principal surface 412b toward the first principal surface 412a in the cross section of the height direction x and the width direction y (WT cross section). As a result, the bonding area between the second outer electrode 430b and the second internal electrode layer 416b is increased, so the adhesion strength is increased, and the ESR is reduced.

Where a region in which, among the end portions of the second internal electrode layer 416b, the second principal surface 412b-side end portion that is the end portion exposed at one of the surfaces of the multilayer body 412 is reduced in thickness in the lamination direction toward the surface (the first principal surface 412a) opposite the surface at which the second internal electrode layer 416b is exposed is a second exposed end region 450b, the entire or substantially the entire second exposed end region 450b is preferably exposed from the multilayer body 412. By exposing the entire or substantially the entire second exposed end region 450b from the multilayer body 412, the bonding area between the second outer electrode 430b and the second internal electrode layer 416b is increased, so the adhesion strength is increased, and the ESR is reduced.

At this time, among the thicknesses of the second internal electrode layer 416b in the width direction y, the ratio between the thickest portion and the thinnest portion is preferably such that the thickest portion is, for example, about 1.5 times or more and about 2.5 times or less the thinnest portion.

The second exposed end region 450b can be formed, for example, by immersing the second principal surface 412b of the multilayer body 412 in an etchant to etch the inner resin layer 414a.

The thickness, in the width direction y, of each of the end portions of the first internal electrode layer 416a in the height direction x is preferably thicker than the thickness, in the width direction y, of the center portion of the first internal electrode layer 416a in the height direction x. The thickness, in the width direction y, of each of the end portions of the second internal electrode layer 416b in the height direction x is preferably thicker than the thickness, in the width direction y, of the center portion of the second internal electrode layer 416b in the height direction x. Current flows along the end portions of the first internal electrode layer 416a in the height direction x and the end portions of the second internal electrode layer 416b in the height direction x, so, when the thickness, in the width direction y, of each of the end portions of each of the internal electrode layers 416a, 416b in the height direction x is made thicker than the thickness, in the width direction y, of the center side of each of the internal electrode layers 416a, 416b, it is possible to allow more current to flow. Thus, the ESR can be reduced.

The number of the first internal electrode layers 416a and the second internal electrode layers 416b is, for example, preferably greater than or equal to 15 in total and less than or equal to 200 in total.

The multilayer body 412 may include notches extending from the second principal surface 412b, at which the first internal electrode layers 416a are exposed, toward the first principal surface 412a that is the opposite surface. As a result, the outer electrodes 430 can enter the notches to improve the adhesion strength between the multilayer body 412 and the outer electrodes 430 due to the anchor effect.

The notches can be formed, for example, by immersing the second principal surface 412b of the multilayer body 412 in an etchant to etch the inner resin layer 414a.

The outer electrodes 430 are provided on the second principal surface 412b of the multilayer body 412. At this time, the outer electrodes 430 may be disposed so as to extend from the second principal surface 412b to the first side surface 412c and the second side surface 412d. The outer electrodes 430 include the first outer electrode 430a electrically connected to the first lead-out electrode portions 428a and the second outer electrode 430b electrically connected to the second lead-out electrode portions 428b.

In the multilayer body 412, each of the first counter electrode portions 426a and a corresponding one of the second counter electrode portions 426b face each other with the inner resin layer 414a interposed therebetween, so electrical characteristics (for example, capacitance) are generated. Therefore, it is possible to obtain capacitance between the first outer electrode 430a connected to the first internal electrode layers 416a and the second outer electrode 430b connected to the second internal electrode layers 416b. As a result, the multilayer capacitor 410 with the above structure defines and functions as a capacitor.

Each of the outer electrodes 430 includes a base electrode layer 432 and a plating layer 434 in order from the multilayer body 412 side.

The base electrode layers 432 include a first base electrode layer 432a and a second base electrode layer 432b. The base electrode layer 432 corresponds to the base electrode layer 32 of the multilayer capacitor 10 according to the first example embodiment. The material of the base electrode layer 432 and a manufacturing method for the base electrode layer 432 are the same or substantially the same as those of the base electrode layer 32 of the first example embodiment, so the description is omitted. The plating layers 434 include a first plating layer 434a and a second plating layer 434b. The plating layer 434 corresponds to the plating layer 34 of the multilayer capacitor 10 according to the first example embodiment. The material of the plating layer 434 and a manufacturing method for the plating layer 434 are the same or substantially the same as those of the plating layer 34 of the first example embodiment, so the description is omitted.

Hereinafter, an example of a manufacturing method for the multilayer capacitor 410 according to the fifth example embodiment will be described.

First, raw materials for the inner resin layers 414a and the outer resin layers 414b are prepared. The inner resin layers 414a and the outer resin layers 414b are resin sheets mainly including thermoplastic resin, such as liquid crystal polymer (LCP), for example.

Subsequently, a conductor pattern that becomes the internal electrode layer 416 is formed on each of the resin sheets that become the multiple inner resin layers 414a. More specifically, a metal foil, such as Cu foil, for example, is laminated on one side of the resin sheet that becomes the inner resin layer 414a, and the metal foil is patterned using, for example, photolithography and then laminated. At this time, the adhesion between the inner resin layer 414a and the internal electrode layer 416 may be improved, for example, by roughening in advance the surface of one side of the resin sheet that becomes the inner resin layer 414a and laminating a Cu foil on top of the resin sheet. Thus, a block for an inner layer portion is formed. Multiple or single block for a first side surface-side outer layer portion and multiple or single block for a second side surface-side outer layer portion are formed by laminating the resin sheets that become the outer resin layers 414b.

Subsequently, a multilayer body block is manufactured by laminating the block for an inner layer portion so as to be sandwiched between the block for a first side surface-side outer layer and the block for a second side surface-side outer layer and then applying hot press (simultaneous pressing).

The manufactured multilayer body block is divided into individual pieces, for example, by die cutting to form the multilayer body 412. To expose the end portions of the internal electrode layers 416 on the multilayer body 412, for example, the second principal surface 412b of the multilayer body 412 may be immersed in an etchant. In this way, the first exposed end regions 450a and the second exposed end regions 450b can be formed by etching the inner resin layers 414a to expose the end portions of the internal electrode layers 416.

When baked layers are formed as the base electrode layers 432, the base electrode layers 432 are formed by applying low-temperature curable conductive paste to the second principal surface 412b of the obtained multilayer body 412 and performing a baking process, for example, at a temperature higher than or equal to about 100° C. and lower than or equal to about 250° C. Various methods can be used as a method to apply low-temperature curing conductive paste. For example, a method of applying conductive paste to the second principal surface 412b of the obtained multilayer body 412 by extruding the conductive paste through a slit can be used. In this method, by increasing the amount of extrusion of the conductive paste, it is possible to form the base electrode layers 432 not only on the second principal surface 412b but also on a portion of the first side surface 412c and a portion of the second side surface 412d. The base electrode layers 432 can also be formed using a roller transfer method, for example. In the case of the roller transfer method, it is possible to form the base electrode layers 432 on a portion of the first side surface 412c and a portion of the second side surface 412d by increasing the pressing pressure during roller transfer. Not limited to this, conductive paste can also be applied using screen printing, for example.

When conductive resin layers are formed as the base electrode layers 432, the base electrode layers 432 are formed by applying conductive resin paste including thermosetting resin and metal components to the second principal surface 412b of the obtained multilayer body 412 and performing heat treatment, for example, at a temperature of lower than or equal to about 250° C. to cure the thermosetting resin. At this time, for example, a condition in an N₂ atmosphere is preferable as a heat treatment atmosphere, and the oxygen concentration is preferably about 100 ppm or lower.

When thin film layers are formed as the base electrode layers 432, the base electrode layers 432 formed of deposited metal particles can be formed on the second principal surface 412b of the obtained multilayer body 412, for example, by sputtering. Thus, for example, thin films less than or equal to about 1.0 μm can be formed as the base electrode layers 432. At this time, by controlling the positional relationship such as the angle and distance with respect to the multilayer body 412, it is possible to control the thickness of each of the base electrode layers 432 and the amount by which the base electrode layers 432 extend onto the first side surface 412c and the second side surface 412d of the multilayer body 412. It is also possible to apply sputtering not only to one surface but also individually to the surfaces.

When plating layers are directly formed as the base electrode layers 432, for example, electrolytic plating, electroless plating, or the like, is performed. For example, barrel plating is preferable for electrolytic plating.

Subsequently, plating layers 434 are formed on the formed base electrode layers 432, for example, by barrel plating.

When each of the plating layers 434 has a two-layer structure, for example, Ni plating and Sn plating are arranged in this order from the multilayer body 412 side. However, the types of metal are not limited thereto. When each of the plating layers 434 has a three-layer structure, for example, Sn plating, Ni plating, and Sn plating are arranged in this order from the multilayer body 412 side.

In this way, the multilayer capacitor 410 according to the present example embodiment is manufactured.

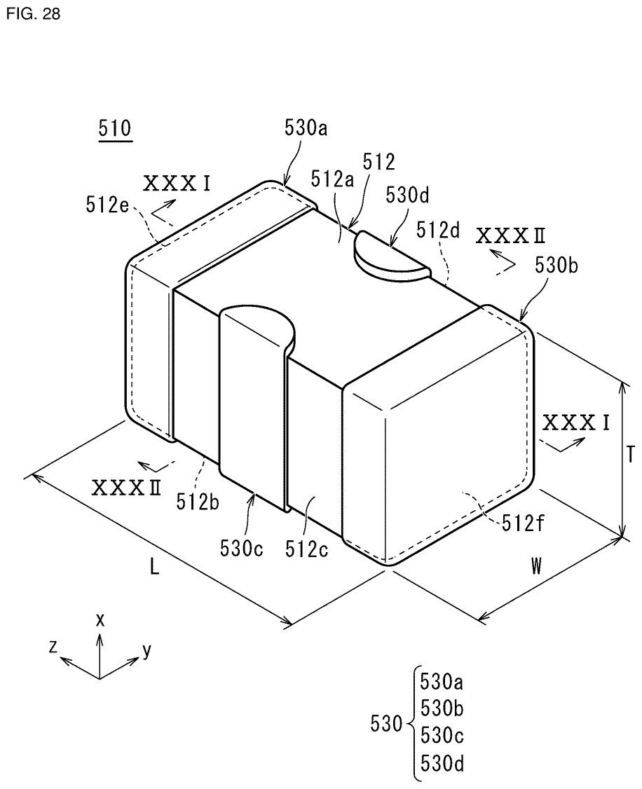

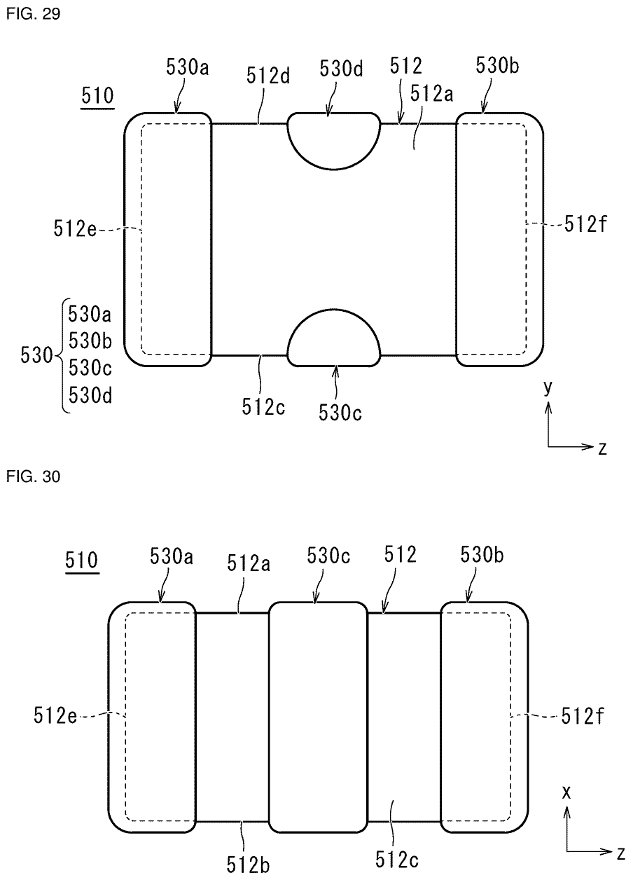

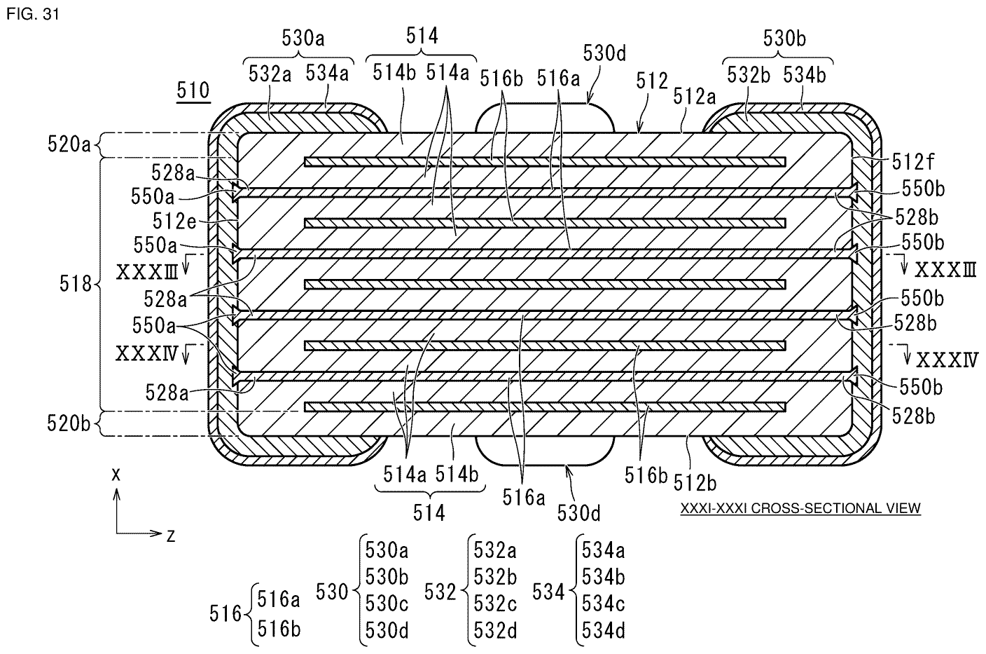

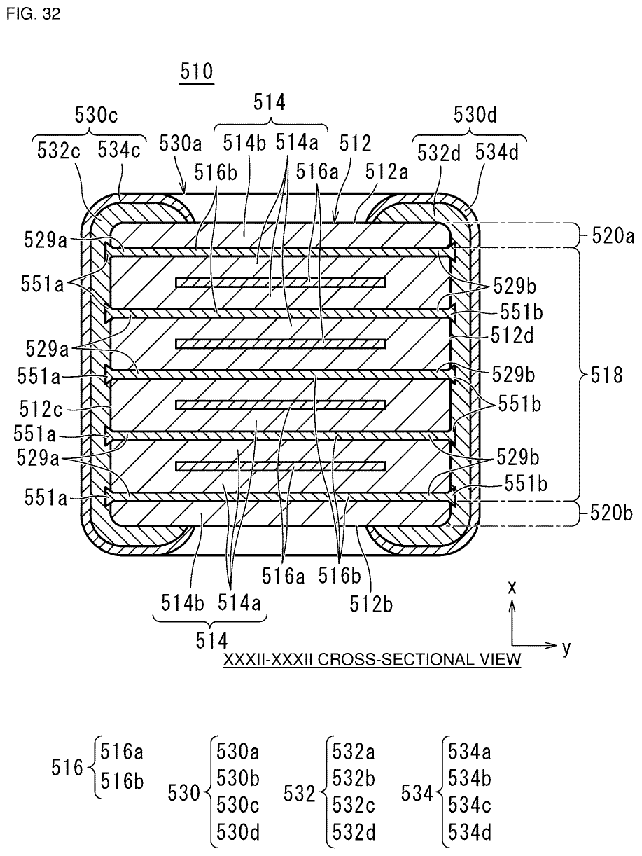

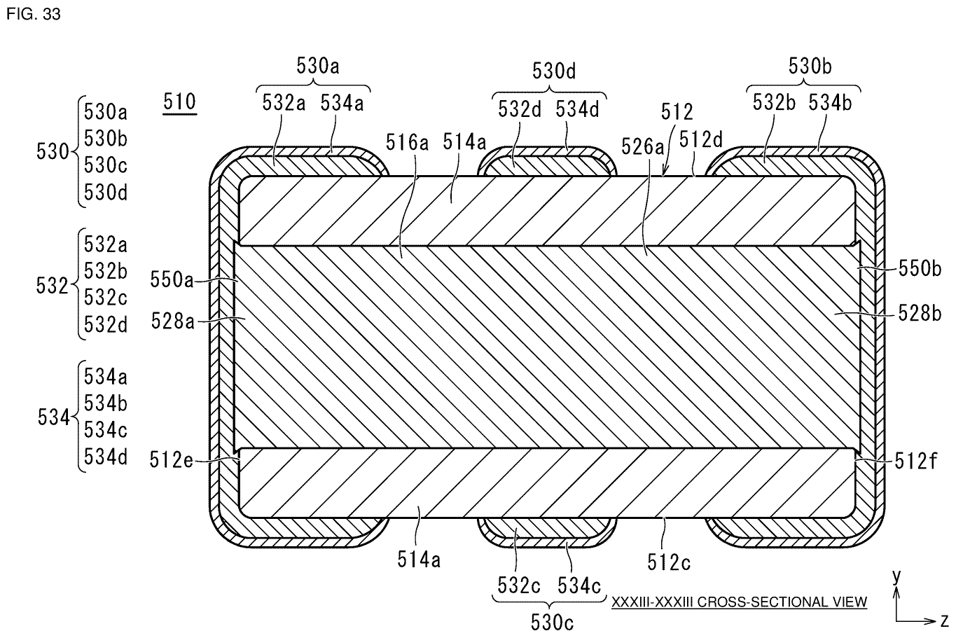

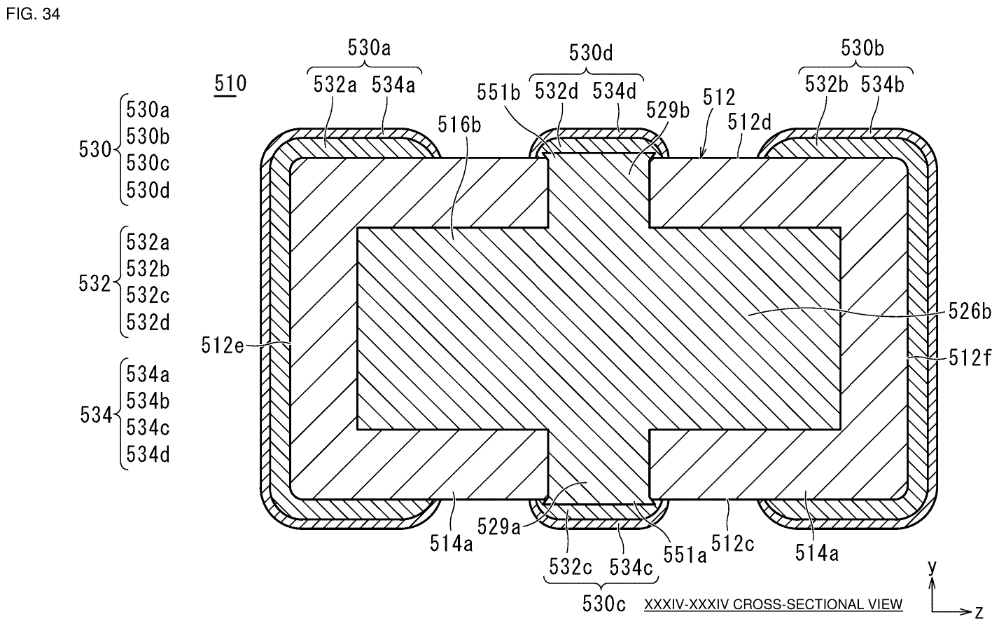

Next, a multilayer capacitor 510 according to a sixth example embodiment of the present invention will be described. FIG. 28 is an external perspective view of the multilayer capacitor according to the sixth example embodiment of the present invention. FIG. 29 is a top view of the multilayer capacitor according to the sixth example embodiment of the present invention. FIG. 30 is a front view of the multilayer capacitor according to the sixth example embodiment of the present invention. FIG. 31 is a cross-sectional view taken along the line XXXI-XXXI in FIG. 28. FIG. 32 is a cross-sectional view taken along the line XXXII-XXXII in FIG. 28. FIG. 33 is a cross-sectional view taken along the line XXXIII-XXXIII in FIG. 31. FIG. 34 is a cross-sectional view taken along the line XXXIV-XXXIV in FIG. 31.

The multilayer capacitor 510 according to the sixth example embodiment includes a multilayer body 512 and four outer electrodes 530.

The multilayer body 512 includes a first principal surface 512a and a second principal surface 512b opposite to each other in a lamination direction x, a first side surface 512c and a second side surface 512d opposite to each other in a width direction y orthogonal or substantially orthogonal to the lamination direction x, and a first end surface 512e and a second end surface 512f opposite to each other in a length direction z orthogonal or substantially orthogonal to the lamination direction x and the width direction y. The first principal surface 512a and the second principal surface 512b each extend in the width direction y and the length direction z. The first side surface 512c and the second side surface 512d each extend in the lamination direction x and the length direction z. The first end surface 512e and the second end surface 512f each extend in the lamination direction x and the width direction y. Therefore, the lamination direction x is a direction that connects the first principal surface 512a and the second principal surface 512b, the width direction y is a direction that connects the first side surface 512c and the second side surface 512d, and the length direction z is a direction that connects the first end surface 512e and the second end surface 512f. The surfaces of the first principal surface 512a and the second principal surface 512b, the first side surface 512c and the second side surface 512d, and the first end surface 512e and the second end surface 512f may include irregularities, and the surfaces may be roughened to be rough surfaces.

In the multilayer body 512, corner portions and ridge portions are preferably rounded. The corner portion refers to a portion where three adjacent sides of the multilayer body 512 intersect, and the ridge portion refers to a portion where two adjacent sides of the multilayer body 512 intersect. By rounding the corner portions and ridge portions of the multilayer body 512, it is possible to reduce or prevent chipping and cracking of the multilayer body 512.

The multilayer body 512 includes multiple resin layers 514 and multiple internal electrode layers 516, which are laminated. The resin layers 514 include inner resin layers 514a and outer resin layers 514b. The internal electrode layers 516 include first internal electrode layers 516a and second internal electrode layers 516b.

The multilayer body 512 includes an inner layer portion 518 and two outer layer portions 520a, 520b sandwiching the inner layer portion 518 in the lamination direction x. Between the two outer layer portions 520a, 520b, the outer layer portion on the first principal surface 512a side is referred to as a first principal surface-side outer layer portion 520a, and the outer layer portion on the second principal surface 512b side is referred to as a second principal surface-side outer layer portion 520b.

More specifically, the multilayer body 512 includes the first principal surface-side outer layer portion 520a formed of multiple outer resin layers 514b positioned on the first principal surface 512a side between the first principal surface 512a and both the outermost surface of the first principal surface 512a-side inner layer portion 518 and a straight line extended from the outermost surface.

Similarly, the multilayer body 512 includes the second principal surface-side outer layer portion 520b including multiple outer resin layers 514b positioned on the second principal surface 512b side between the second principal surface 512b and both the outermost surface of the second principal surface 512b-side inner layer portion 518 and a straight line extended from the outermost surface.

The inner layer portion 518 includes first internal electrode layers 516a with both ends exposed on the first end surface 512e and the second end surface 512f, second internal electrode layers 516b with both ends exposed on the first side surface 512c and the second side surface 512d, and inner resin layers 514a that are alternately laminated with the internal electrode layers 516.

For example, resins, such as liquid crystal polymer (LCP) resin, epoxy resin, or polyimide resin, which are excellent in heat resistance, can be used as the components of the resin layers 514, that is, the inner resin layers 514a and the outer resin layers 514b. However, the components are not limited thereto.

The outer resin layers 514b of each of the first principal surface-side outer layer portion 520a and the second principal surface-side outer layer portion 520b include the same type of resin material as the inner resin layers 514a. Each of the first principal surface-side outer layer portion 520a and the second principal surface-side outer layer portion 520b may include multiple outer resin layers 514b or may include a single outer resin layer 514b.

The inner resin layers 514a and the outer resin layers 514b may include different components. For example, the inner resin layers 514a may include a resin with a high dielectric constant and the outer resin layers 514b may include components with good moisture resistance, weather resistance, and strength.

The number of inner resin layers 514a and outer resin layers 514b laminated is not limited and is, for example, preferably greater than or equal to 15 and less than or equal to 200, including the outer resin layers 514b. The thickness of the inner resin layer 514a is, for example, preferably greater than or equal to about 0.2 μm and less than or equal to about 10.0 μm.

The internal electrode layers 516 include the first internal electrode layers 516a and the second internal electrode layers 516b. The first internal electrode layer 516a and the second internal electrode layer 516b are alternately laminated with the inner resin layer 514a interposed therebetween.

Each of the first internal electrode layers 516a is disposed on the surface of a corresponding one of the inner resin layers 514a. The first internal electrode layer 516a includes a first counter electrode portion 526a positioned inside the multilayer body 512, a first lead-out electrode portion 528a connected to the first counter electrode portion 526a and extending to the first end surface 512e, and a second lead-out electrode portion 528b extending to the second end surface 512f.

The shape of the first counter electrode portion 526a of the first internal electrode layer 516a is not limited and is preferably a rectangular or substantially rectangular shape in plan view. However, the corner portions in plan view may be rounded or the corner portions may be chamfered in plan view (tapered). The corner portions may have a tapered shape in plan view so as to incline toward each side.

The shape of each of the first lead-out electrode portion 528a and second lead-out electrode portion 528b of the first internal electrode layer 516a is not limited and is preferably a rectangular or substantially rectangular shape in plan view. However, the corner portions in plan view may be rounded or the corner portions may be chamfered in plan view (tapered). The corner portions may have a tapered shape in plan view so as to incline toward each side.

Each of the second internal electrode layers 516b is disposed on the surface of a corresponding one of the inner resin layers 514a, different from the inner resin layer 514a where the first internal electrode layer 516a is disposed. The second internal electrode layer 516b includes a second counter electrode portion 526b facing the first internal electrode layer 516a, a third lead-out electrode portion 529a connected to the second counter electrode portion 526b and extending to the first side surface 512c, and a fourth lead-out electrode portion 529b extending to the second side surface 512d.

The shape of the second counter electrode portion 526b of the second internal electrode layer 516b is not limited and is preferably a rectangular or substantially rectangular shape in plan view. However, the corner portions in plan view may be rounded or the corner portions may be chamfered in plan view (tapered). The corner portions may have a tapered shape in plan view so as to incline toward each side.

The shape of each of the third lead-out electrode portion 529a and fourth lead-out electrode portion 529b of the second internal electrode layer 516b is not limited and is preferably a rectangular or substantially rectangular shape in plan view. However, the corner portions in plan view may be rounded or the corner portions may be chamfered in plan view (tapered). The corner portions may have a tapered shape in plan view so as to incline toward each side.

In the present example embodiment, the first counter electrode portion 526a of the first internal electrode layer 516a and the second counter electrode portion 526b of the second internal electrode layer 516b face each other with the inner resin layer 514a interposed therebetween to generate a capacitance, so the characteristics of the capacitor are provided.

The first internal electrode layer 516a and the second internal electrode layer 516b can include a suitable conductive material, for example, a metal such as Ni, Cu, Ag, Pd, or Au or an alloy that includes one of these metals, such as Ag—Pd. However, the first internal electrode layer 516a and the second internal electrode layer 516b are not limited thereto. In the present example embodiment, the first internal electrode layer 516a and the second internal electrode layer 516b include, for example, Cu having high conductivity as a main component. Thus, it is possible to reduce the ESR of the multilayer capacitor 510.

The dielectric constant of the inner resin layer 514a is lower than those of dielectric materials used in existing multilayer capacitors, so, in order to provide a capacitor of the same capacitance, it is necessary to increase the areas of the counter electrode portions 526a, 526b accordingly. Therefore, it is necessary to increase the number of the first internal electrode layers 516a and the second internal electrode layers 516b. As a result, the total area of the internal electrode layers 516 increases, so it is possible to reduce the ESR of the multilayer capacitor 510. Furthermore, since the multilayer body 512 includes the inner resin layers 514a and the outer resin layers 514b, even when warpage occurs in the multilayer capacitor 510, the warpage can be absorbed by the inner resin layers 514a and the outer resin layers 514b, so the warpage strength can be improved. Therefore, compared to the existing multilayer capacitors, the mechanical strength can be improved.

Furthermore, when a multilayer ceramic capacitor, which is an example of the existing multilayer capacitor, is manufactured, the sintering temperature of the dielectric ceramic is higher than the sintering temperature of the internal electrode 516 when the dielectric ceramic is fired. As a result, there is a risk that particles couple together due to over-sintering of the internal electrodes 516 to form voids in the internal electrodes 516, which may lead to a reduction in effective area and a decrease in the linearity of the end portions of the internal electrodes 516. However, since it is possible to form the multilayer capacitor 510 without including a firing process at a temperature exceeding the melting point of the inner resin layer 514a, there is no reduction in effective area or linearity due to over-sintering of the first internal electrode layer 516a and the second internal electrode layer 516b. Therefore, the area of the internal electrodes 516 per unit number of sheets can be maximized, so the maximum capacitance can be obtained. Furthermore, since the linearity of the end portions of the internal electrodes 516 can be improved, the ESR reduces.

The first internal electrode layer 516a and the second internal electrode layer 516b preferably have no voids. Thus, the current path of the multilayer capacitor 510 shortens, with the result that the ESR can be reduced.

The linearity of each of the end portions of the first internal electrode layer 516a or the second internal electrode layer 516b, where the first internal electrode layer 516a or the second internal electrode layer 516b is in contact with the inner resin layer 514a, is, for example, preferably greater than or equal to about 1.0 and less than or equal to about 1.5. Furthermore, the linearity of each of the end portions of the first internal electrode layer 516a or the second internal electrode layer 516b, where the first internal electrode layer 516a or the second internal electrode layer 516b is in contact with the inner resin layer 514a is, for example, preferably about 1.0. Thus, the current path can be provided in a route close to the shortest path, so the ESR can be reduced.

Here, the linearity of each of the end portions in the width direction y, where the first internal electrode layer 516a is in contact with the inner resin layer 514a, can be calculated using, for example, a method the same as or similar to a calculation method for the linearity of each of the end portions, in the width direction y, of the internal electrode layer 16 according to the first example embodiment.

The linearity of each of the end portions in the width direction y, where the second internal electrode layer 516b is in contact with the inner resin layer 514a, can be calculated using, for example, a method the same as or similar to a calculation method for the linearity of each of the end portions, in the width direction y, of the internal electrode layer 16 according to the first example embodiment. An SEM image of the measurement point is taken at a magnification of about 2000 times centered on about 1/4L of the multilayer capacitor 510, and the perimeter, average vertical chord length, and image width are measured.

Furthermore, the linearity of each of the end portions in the length direction z, where the second internal electrode layer 516b is in contact with the inner resin layer 514a, can be calculated using, for example, a method the same as or similar to a calculation method for the linearity of each of the end portions, in the length direction z, of the internal electrode layer 16 according to the first example embodiment.

As shown in FIG. 31, among the end portions of the first internal electrode layer 516a, the first end surface 512e-side end portion that is the end portion exposed at any of the first side surface 512c, the second side surface 512d, the first end surface 512e, and the second end surface 512f of the multilayer body 512 is reduced in thickness in the lamination direction x toward the surface (the second end surface 512f) opposite the surface at which the first internal electrode layer 516a is exposed. Similarly, among the end portions of the first internal electrode layer 516a, the second end surface 512f-side end portion that is the end portion exposed at any of the first side surface 512c, the second side surface 512d, the first end surface 512e, and the second end surface 512f of the multilayer body 512 is reduced in thickness in the lamination direction x toward the surface (the first end surface 512e) opposite the surface at which the first internal electrode layer 516a is exposed. In other words, the first internal electrode layer 516a is exposed at the first end surface 512e and the second end surface 512f, and, in the cross section of the lamination direction x and the length direction z (LT cross section), a portion of the first internal electrode layer 516a, exposed at the first end surface 512e, is configured to have a triangular or substantially triangular shape that reduces in length in the lamination direction x from the first end surface 512e toward the second end surface 512f, and a portion of the first internal electrode layer 516a, exposed at the second end surface 512f, is configured to have a triangular or substantially triangular shape that reduces in length in the lamination direction x from the second end surface 512f toward the first end surface 512e. As a result, the bonding area between both the first outer electrode 530a and the second outer electrode 530b and the first internal electrode layer 516a is increased, so the adhesion strength is increased, and the ESR is reduced.

Where a region in which, among the end portions of the first internal electrode layer 516a, the first end surface 512e-side end portion that is the end portion exposed at any of the first side surface 512c, the second side surface 512d, the first end surface 512e, and the second end surface 512f of the multilayer body 512 is reduced in thickness in the lamination direction x toward the surface (the second end surface 512f) opposite the surface at which the first internal electrode layer 516a is exposed is a first exposed end region 550a, the entire or substantially the entire first exposed end region 550a is preferably exposed from the multilayer body 512. Similarly, where a region in which, among the end portions of the first internal electrode layer 516a, the second end surface 512f-side end portion that is the end portion exposed at any of the first side surface 512c, the second side surface 512d, the first end surface 512e, and the second end surface 512f of the multilayer body 512 is reduced in thickness in the lamination direction x toward the surface (the first end surface 512e) opposite the surface at which the first internal electrode layer 516a is exposed is a second exposed end region 550b, the entire or substantially the entire second exposed end region 550b is preferably exposed from the multilayer body 512. By exposing the entire or substantially the entire first exposed end region 550a and the entire or substantially the entire second exposed end region 550b from the multilayer body 512, the bonding area between both the first outer electrode 530a and the second outer electrode 530b and the first internal electrode layer 516a is increased, so the adhesion strength is increased, and the ESR is reduced.

At this time, among the thicknesses of the first internal electrode layer 516a in the lamination direction x, the ratio between the thickest portion and the thinnest portion is, for example, preferably such that the thickest portion is about 1.5 times or more and about 2.5 times or less the thinnest portion. With such a configuration, the adhesion strength between both the first outer electrode 530a and the second outer electrode 530b and the first internal electrode layer 516a can be increased without increasing the thickness of the multilayer body 512 in the lamination direction x.

The first exposed end region 550a and the second exposed end region 550b can be formed, for example, by immersing the first end surface 512e and second end surface 512f of the multilayer body 512 in an etchant to etch the inner resin layer 514a.

As shown in FIG. 32, among the end portions of the second internal electrode layer 516b, the first side surface 512c-side end portion that is the end portion exposed at any of the first side surface 512c, the second side surface 512d, the first end surface 512e, and the second end surface 512f of the multilayer body 512 is reduced in thickness in the lamination direction x toward the surface (the second side surface 512d) opposite the surface at which the second internal electrode layer 516b is exposed. Similarly, among the end portions of the second internal electrode layer 516b, the second side surface 512d-side end portion that is the end portion exposed at any of the first side surface 512c, the second side surface 512d, the first end surface 512e, and the second end surface 512f of the multilayer body 512 is reduced in thickness in the lamination direction x toward the surface (the first side surface 512c) opposite the surface at which the second internal electrode layer 516b is exposed. In other words, the second internal electrode layer 516b is exposed at the first side surface 512c and the second side surface 512d, and, in the cross section of the lamination direction x and the width direction y (WT cross section), a portion of the second internal electrode layer 516b, exposed at the first side surface 512c, is configured to have a triangular or substantially triangular shape that reduces in length in the lamination direction x from the first side surface 512c toward the second side surface 512d, and a portion of the second internal electrode layer 516b, exposed at the second side surface 512d, is configured to have a triangular or substantially triangular shape that reduces in length in the lamination direction x from the second side surface 512d toward the first side surface 512c. As a result, the bonding area between both the third outer electrode 530c and the fourth outer electrode 530d and the second internal electrode layer 516b is increased, so the adhesion strength is increased, and the ESR is reduced.

Where a region in which, among the end portions of the second internal electrode layer 516b, the first side surface 512c-side end portion that is the end portion exposed at any of the first side surface 512c, the second side surface 512d, the first end surface 512e, and the second end surface 512f of the multilayer body 512 is reduced in thickness in the lamination direction x toward the surface (the second side surface 512d) opposite the surface at which the second internal electrode layer 516b is exposed is a third exposed end region 551a, the entire or substantially the entire third exposed end region 551a is preferably exposed from the multilayer body 512. Where a region in which, among the end portions of the second internal electrode layer 516b, the second side surface 512d-side end portion that is the end portion exposed at any of the first side surface 512c, the second side surface 512d, the first end surface 512e, and the second end surface 512f of the multilayer body 512 is reduced in thickness in the lamination direction x toward the surface (the first side surface 512c) opposite the surface at which the second internal electrode layer 516b is exposed is a fourth exposed end region 551b, the entire or substantially the entire fourth exposed end region 551b is preferably exposed from the multilayer body 512. By exposing the entire or substantially the entire third exposed end region 551a and the entire or substantially the entire fourth exposed end region 551b from the multilayer body 512, the bonding area between both the third outer electrode 530c and the fourth outer electrode 530d and the second internal electrode layer 516b is increased, so the adhesion strength is increased, and the ESR is reduced.

At this time, among the thicknesses of the second internal electrode layer 516b in the lamination direction x, the ratio between the thickest portion and the thinnest portion is, for example, preferably such that the thickest portion is about 1.5 times or more and about 2.5 times or less the thinnest portion. With such a configuration, the adhesion strength between both the third outer electrode 530c and the fourth outer electrode 530d and the second internal electrode layer 516b can be increased without increasing the thickness of the multilayer body 512 in the lamination direction x.

The third exposed end region 551a and the fourth exposed end region 551b can be formed, for example, by immersing the first side surface 512c and second side surface 512d of the multilayer body 512 in an etchant to etch the inner resin layer 514a.

The thickness, in the lamination direction x, of each of the end portions of the first internal electrode layer 516a in the width direction y is preferably thicker than the thickness, in the lamination direction x, of the center portion of the first internal electrode layer 516a in the width direction y. Similarly, the thickness, in the lamination direction x, of each of the end portions of the second internal electrode layer 516b in the width direction y is preferably thicker than the thickness, in the lamination direction x, of the center portion of the second internal electrode layer 516b in the width direction y. Current flows along the end portions of the first internal electrode layer 516a in the width direction y and the end portions of the second internal electrode layer 516b in the width direction y, so, when the thickness, in the lamination direction x, of each of the end portions of each of the internal electrode layers 516a, 516b in the width direction y is made thicker than the thickness, in the lamination direction x, of the center side of each of the internal electrode layers 516a, 516b, it is possible to allow more current to flow. Thus, the ESR can be reduced.

The number of the first internal electrode layers 516a and the second internal electrode layers 516b is, for example, preferably greater than or equal to 15 in total and less than or equal to 200 in total.

The multilayer body 512 may include first notches extending from the first end surface 512e, at which the first internal electrode layers 516a are exposed, toward the second end surface 512f that is the opposite surface. Similarly, the multilayer body 512 may include second notches extending from the second end surface 512f, at which the first internal electrode layers 516a are exposed, toward the first end surface 512e that is the opposite surface.

Furthermore, the multilayer body 512 may include third notches extending from the first side surface 512c, at which the second internal electrode layers 516b are exposed, toward the second side surface 512d that is the opposite surface. Similarly, the multilayer body 512 may include fourth notches extending from the second side surface 512d, at which the second internal electrode layers 516b are exposed, toward the first side surface 512c that is the opposite surface.

As a result, the outer electrodes 530 can enter the first notches, the second notches, the third notches, and the fourth notches to improve the adhesion strength between the multilayer body 512 and the outer electrodes 530 due to the anchor effect.

The first notches, the second notches, the third notches, and the fourth notches can be formed, for example, by immersing the first side surface 512c, the second side surface 512d, the first end surface 512e, and the second end surface 512f of the multilayer body 512 in an etchant to etch the inner resin layer 514a.

The outer electrodes 530 include the first outer electrode 530a, the second outer electrode 530b, the third outer electrode 530c, and the fourth outer electrode 530d.

The first outer electrode 530a is disposed on the first end surface 512e and is connected to the first internal electrode layers 516a. The first outer electrode 530a may also be disposed on a portion of the first principal surface 512a, a portion of the second principal surface 512b, a portion of the first side surface 512c, and a portion of the second side surface 512d.

The second outer electrode 530b is disposed on the second end surface 512f and is connected to the first internal electrode layers 516a. The second outer electrode 530b may also be disposed on a portion of the first principal surface 512a, a portion of the second principal surface 512b, a portion of the first side surface 512c, and a portion of the second side surface 512d.

The third outer electrode 530c is disposed on the first side surface 512c and is connected to the second internal electrode layers 516b. The third outer electrode 530c may also be disposed on a portion of the first principal surface 512a and a portion of the second principal surface 512b.

The fourth outer electrode 530d is disposed on the second side surface 512d and is connected to the second internal electrode layers 516b. The fourth outer electrode 530d may also be disposed on a portion of the first principal surface 512a and a portion of the second principal surface 512b.

Each of the first outer electrode 530a, the second outer electrode 530b, the third outer electrode 530c, and the fourth outer electrode 530d includes a base electrode layer 532 and a plating layer 534.

In other words, the first outer electrode 530a includes a first base electrode layer 532a and a first plating layer 534a. The second outer electrode 530b includes a second base electrode layer 532b and a second plating layer 534b. The third outer electrode 530c includes a third base electrode layer 532c and a third plating layer 534c. The fourth outer electrode 530d includes a fourth base electrode layer 532d and a fourth plating layer 534d.

The materials of the base electrode layer 532 and plating layer 534 and a formation method for the base electrode layer 532 and the plating layer 534 are, for example, the same as or similar to those of the base electrode layer 32 and plating layer 34 of the first example embodiment, so the description is omitted. Hereinafter, an example of a manufacturing method for the multilayer capacitor 510 according to the sixth example embodiment will be described.

First, raw materials for the inner resin layers 514a and the outer resin layers 514b are prepared. The inner resin layers 514a and the outer resin layers 514b are resin sheets mainly made of thermoplastic resin, such as liquid crystal polymer (LCP), for example.

Subsequently, a conductor pattern that becomes the internal electrode layer 516 is formed on each of the resin sheets that become the multiple inner resin layers 514a. More specifically, a metal foil, such as Cu foil, for example, is laminated on one side of the resin sheet that becomes the inner resin layer 514a, and the metal foil is patterned using, for example, photolithography and then laminated. At this time, the adhesion between the inner resin layer 514a and the internal electrode layer 516 may be improved, for example, by roughening in advance the surface of one side of the resin sheet that becomes the inner resin layer 514a and laminating a Cu foil on top of the resin sheet. Thus, a block for an inner layer portion is formed. Multiple or single block for a first principal surface-side outer layer portion and multiple or single block for a second principal surface-side outer layer portion are formed by laminating the resin sheets that become the outer resin layers 514b.

Subsequently, a multilayer body block is manufactured by laminating the block for an inner layer portion so as to be sandwiched between the block for a first principal surface-side outer layer and the block for a second principal surface-side outer layer and then applying hot press (simultaneous pressing).

The manufactured multilayer body block is divided into individual pieces, for example, by die cutting to form the multilayer body 512. To expose the end portions of the internal electrode layers 516 on the multilayer body 512, for example, the first side surface 512c, the second side surface 512d, the first end surface 512e, and the second end surface 512f may be immersed in an etchant. By doing this, the inner resin layer 514a can be etched to expose the end portions of the internal electrode layers 516, with the result that the first exposed end regions 550a, the second exposed end regions 550b, the third exposed end regions 551a, and the fourth exposed end regions 551b can be formed.

When, for example, baked layers are formed as the base electrode layers 532, the base electrode layers 532 are formed by applying low-temperature curable conductive paste to the first end surface 512e, the second end surface 512f, the first side surface 512c, and the second side surface 512d of the obtained multilayer body 512 and performing a baking process, for example, at a temperature higher than or equal to about 100° C. and lower than or equal to about 250° C.

Here, when the first base electrode layer 532a and the second base electrode layer 532b are formed, for example, conductive paste can be applied to the first end surface 512e and the second end surface 512f of the obtained multilayer body 512 using a dipping method or the like. At this time, by changing the amount of pressing and the pressing time in dipping and the amount of conductive paste, it is possible to control the thicknesses of the first base electrode layer 532a and second base electrode layer 532b and the amount by which the first base electrode layer 532a and the second base electrode layer 532b extend onto the first principal surface 512a, the second principal surface 512b, the first side surface 512c, and the second side surface 512d of the multilayer body 512. Not limited to this, conductive paste can also be applied using screen printing, for example.

When the third base electrode layer 532c and the fourth base electrode layer 532d are formed, for example, a method of applying conductive paste to the first side surface 512c and the second side surface 512d of the obtained multilayer body 512 by extruding the conductive paste through a slit can be used. In the case of this method, by increasing the amount of extrusion of the conductive paste, the third base electrode layer 532c and the fourth base electrode layer 532d can be formed not only on the first side surface 512c and the second side surface 512d but also on a portion of the first principal surface 512a and a portion of the second principal surface 512b. The third base electrode layer 532c and the fourth base electrode layer 532d can also be formed using a roller transfer method, for example. In the case of the roller transfer method, it is possible to form the third base electrode layer 532c and the fourth base electrode layer 532d on a portion of the first principal surface 512a and a portion of the second principal surface 512b by increasing the pressing pressure during roller transfer. Not limited to this, conductive paste can also be applied using screen printing, for example.

When, for example, conductive resin layers are formed as the base electrode layers 532, the base electrode layers 532 are formed by applying conductive resin paste including thermosetting resin and metal components to the first end surface 512e, the second end surface 512f, the first side surface 512c, and the second side surface 512d of the obtained multilayer body 512 and performing heat treatment, for example, at a temperature of lower than or equal to about 250° C. to cure the thermosetting resin. At this time, for example, a condition in an Ne atmosphere is preferable as a heat treatment atmosphere, and the oxygen concentration is, for example, preferably suppressed to about 100 ppm or lower.

When, for example, thin film layers are formed as the base electrode layers 532, the base electrode layers 532 formed of deposited metal particles can be formed on the first end surface 512e, the second end surface 512f, the first side surface 512c, and the second side surface 512d of the obtained multilayer body 512, for example, by sputtering. Thus, for example, thin films less than or equal to about 1.0 μm can be formed as the base electrode layers 532. At this time, by controlling the positional relationship such as the angle and distance with respect to the multilayer body 512, it is possible to control the thickness of each of the base electrode layers 532 and the amount by which the base electrode layers 532 extend onto the first principal surface 512a, the second principal surface 512b, the first side surface 512c, and the second side surface 512d of the multilayer body 512. It is also possible to apply sputtering not only to one surface but also individually to the surfaces.

When, for example, plating layers are directly formed as the base electrode layers 532, electrolytic plating, electroless plating, or the like, is used. For example, barrel plating is preferable for electrolytic plating.

Subsequently, plating layers 534 are formed on the formed base electrode layers 532, for example, by barrel plating.

When each of the plating layers 534 has a two-layer structure, for example, Ni plating and Sn plating are arranged in this order from the multilayer body 512 side. However, the types of metal are not limited thereto. When each of the plating layers 534 has a three-layer structure, for example, Sn plating, Ni plating, and Sn plating are arranged in this order from the multilayer body 512 side.

In this way, the multilayer capacitor 510 according to the present example embodiment is manufactured.

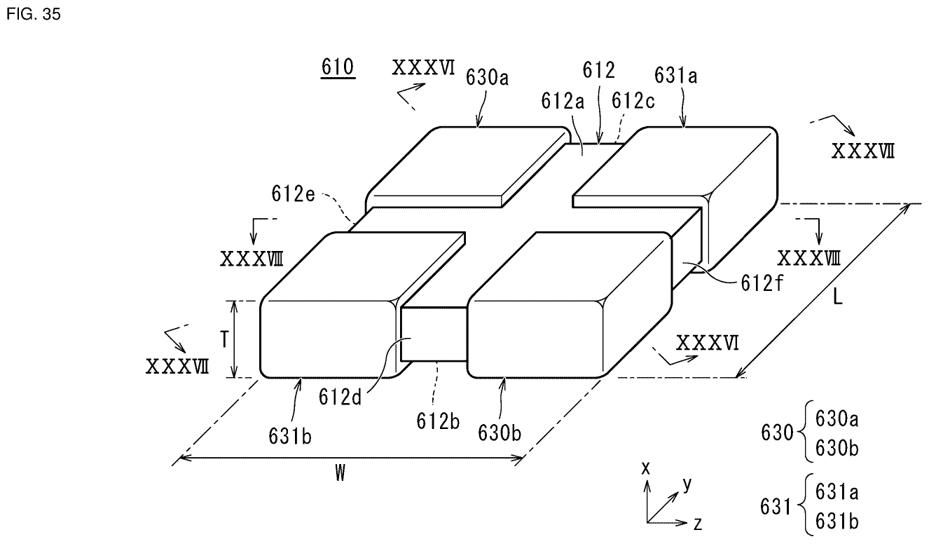

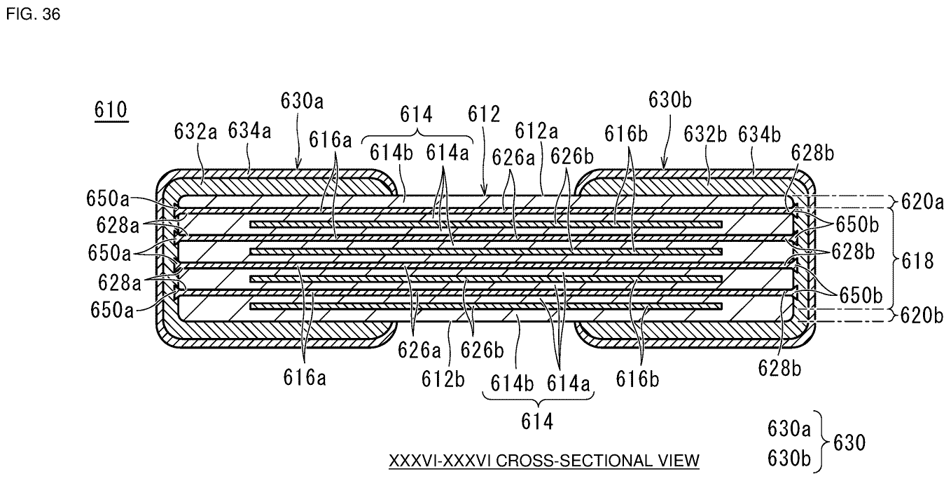

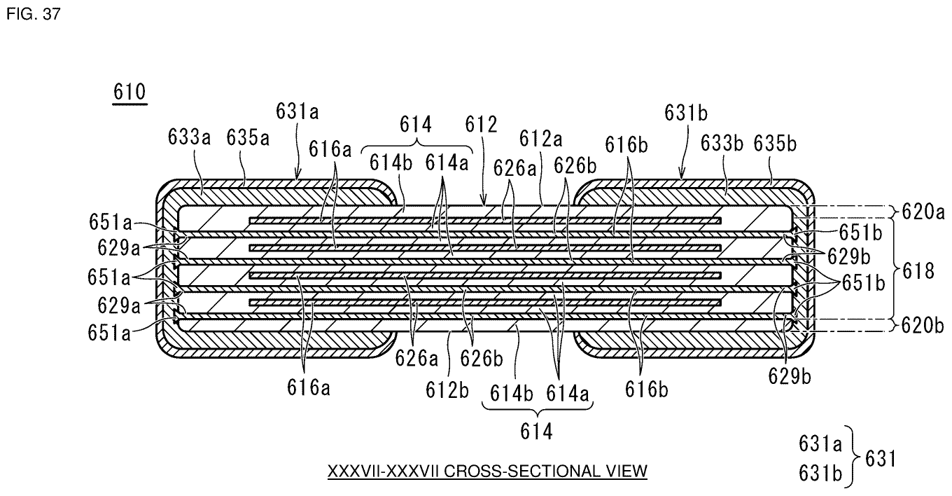

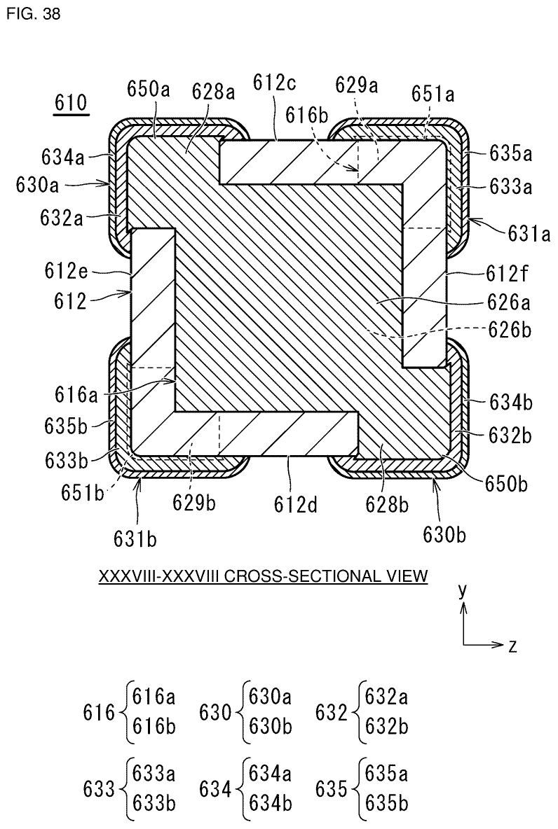

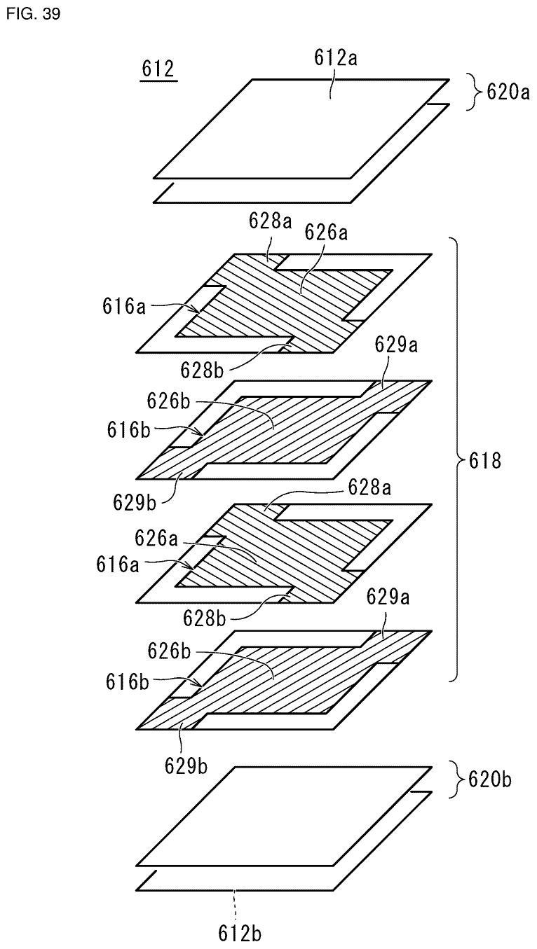

Next, a multilayer capacitor 610 according to a seventh example embodiment of the present invention will be described. FIG. 35 is an external perspective view of the multilayer capacitor according to the seventh example embodiment of the present invention. FIG. 36 is a cross-sectional view taken along the line XXXVI-XXXVI in FIG. 35. FIG. 37 is a cross-sectional view taken along the line XXXVII-XXXVII in FIG. 35. FIG. 38 is a cross-sectional view taken along the line XXXVIII-XXXVIII in FIG. 35. FIG. 39 is an exploded perspective view of a multilayer body shown in FIG. 35.

The multilayer capacitor 610 includes a multilayer body 612 and outer electrodes 630, 631.

The multilayer body 612 includes a first principal surface 612a and a second principal surface 612b opposite to each other in a lamination direction x, a first side surface 612c and a second side surface 612d opposite to each other in a width direction orthogonal or substantially orthogonal to the lamination direction x, and a first end surface 612e and a second end surface 612f opposite to each other in a length direction z orthogonal or substantially orthogonal to the lamination direction x and the width direction y. The first principal surface 612a and the second principal surface 612b each extend in the width direction y and the length direction z. The first side surface 612c and the second side surface 612d each extend in the lamination direction x and the length direction z. The first end surface 612e and the second end surface 612f each extend in the lamination direction x and the width direction y. Therefore, the lamination direction x is a direction that connects the first principal surface 612a and the second principal surface 612b, the width direction y is a direction that connects the first side surface 612c and the second side surface 612d, and the length direction z is a direction that connects the first end surface 612e and the second end surface 612f. The surfaces of the first principal surface 612a and the second principal surface 612b, the first side surface 612c and the second side surface 612d, and the first end surface 612e and the second end surface 612f may include irregularities, and the surfaces may be roughened to be rough surfaces.

In the multilayer body 612, corner portions and ridge portions are preferably rounded. Here, the corner portion refers to a portion where three sides of the multilayer body 612 intersect, and the ridge portion refers to a portion where two sides of the multilayer body 612 intersect. By rounding the corner portions and ridge portions of the multilayer body 612, it is possible to reduce or prevent chipping and cracking of the multilayer body 612.

The multilayer body 612 includes multiple resin layers 614 and multiple internal electrode layers 616, which are laminated. The resin layers 614 include inner resin layers 614a and outer resin layers 614b. The internal electrode layers 616 include first internal electrode layers 616a and second internal electrode layers 616b.

As shown in FIGS. 36 and 37, in the lamination direction x connecting the first principal surface 612a and the second principal surface 612b, the multilayer body 612 includes an inner layer portion 618 in which the multiple internal electrode layers 616 face each other, a first principal surface-side outer layer portion 620a including multiple outer resin layers 614b positioned between the internal electrode layer 616 closest to the first principal surface 612a side and the first principal surface 612a, and a second principal surface-side outer layer portion 620b including multiple outer resin layers 614b positioned between the internal electrode layer 616 closest to the second principal surface 612b side and the second principal surface 612b.

The first principal surface-side outer layer portion 620a is an assembly of multiple outer resin layers 614b positioned on the first principal surface 612a side of the multilayer body 612 between the first principal surface 612a and the internal electrode layer 616 closest to the first principal surface 612a.

The second principal surface-side outer layer portion 620b is an assembly of multiple outer resin layers 614b positioned on the second principal surface 612b side of the multilayer body 612 between the second principal surface 612b and the internal electrode layer 616 closest to the second principal surface 612b.

The region sandwiched between the first principal surface-side outer layer portion 620a and the second principal surface-side outer layer portion 620b is the inner layer portion 618.

The inner layer portion 618 includes first internal electrode layers 616a with both ends exposed on the first end surface 612e and the second end surface 612f, second internal electrode layers 616b with both ends exposed on the first end surface 612e and the second end surface 612f, and inner resin layers 614a that are alternately laminated with the internal electrode layers 616.

For example, resins, such as liquid crystal polymer (LCP) resin, epoxy resin, or polyimide resin, which are excellent in heat resistance, can be used as the components of the resin layers 614, that is, the inner resin layers 614a and the outer resin layers 614b. However, the components are not limited thereto.

The outer resin layers 614b of each of the first principal surface-side outer layer portion 620a and the second principal surface-side outer layer portion 620b include the same type of resin material as the inner resin layers 614a. Each of the first principal surface-side outer layer portion 620a and the second principal surface-side outer layer portion 620b may include multiple outer resin layers 614b or may include a single outer resin layer 614b.

The inner resin layers 614a and the outer resin layers 614b may include different components. For example, the inner resin layers 614a may include a resin with a high dielectric constant, and the outer resin layers 614b may include components with good moisture resistance, weather resistance, and strength.

The number of inner resin layers 614a and outer resin layers 614b laminated is not limited and is, for example, preferably greater than or equal to 15 and less than or equal to 200, including the outer resin layers 614b. The thickness of the inner resin layer 614a is, for example, preferably greater than or equal to about 0.2 μm and less than or equal to about 10.0 μm.

As shown in FIGS. 36 to 38, the internal electrode layers 616 include the multiple first internal electrode layers 616a and the multiple second internal electrode layers 616b. The first internal electrode layer 616a and the second internal electrode layer 616b are alternately laminated with the inner resin layer 614a interposed therebetween.

Each of the first internal electrode layers 616a is disposed on the surface of a corresponding one of the inner resin layers 614a. Each of the first internal electrode layers 616a includes a first counter electrode portion 626a facing the first principal surface 612a and the second principal surface 612b and facing the second internal electrode layer 616b. The first internal electrode layers 616a are laminated in the lamination direction x.

Each of the second internal electrode layers 616b is disposed on the surface of a corresponding one of the inner resin layers 614a, different from the inner resin layer 614a where the first internal electrode layer 616a is disposed. Each of the second internal electrode layers 616b includes a second counter electrode portion 626b facing the first principal surface 612a and the second principal surface 612b. The second internal electrode layers 616b are laminated in the lamination direction x.

As shown in FIG. 38, the first internal electrode layer 616a is extended to the first side surface 612c and first end surface 612e of the multilayer body 612 by a first lead-out electrode portion 628a, and is extended to the second side surface 612d and second end surface 612f of the multilayer body 612 by a second lead-out electrode portion 628b. The width by which the first lead-out electrode portion 628a is extended to the first side surface 612c may be equal or approximately equal to the width by which the first lead-out electrode portion 628a is extended to the first end surface 612e, and the width by which the second lead-out electrode portion 628b is extended to the second side surface 612d may be equal or approximately equal to the width by which the second lead-out electrode portion 628b is extended to the second end surface 612f.

The second internal electrode layer 616b is extended to the first side surface 612c and second end surface 612f of the multilayer body 612 by a third lead-out electrode portion 629a, and is extended to the second side surface 612d and first end surface 612e of the multilayer body 612 by a fourth lead-out electrode portion 629b. The width by which the third lead-out electrode portion 629a is extended to the first side surface 612c may be equal or approximately equal to the width by which the third lead-out electrode portion 629a is extended to the second end surface 612f, and the width by which the fourth lead-out electrode portion 629b is extended to the second side surface 612d may be example or approximately equal to the width by which the fourth lead-out electrode portion 629b is extended to the first end surface 612e.

In the present example embodiment, the first counter electrode portion 626a of the first internal electrode layer 616a and the second counter electrode portion 626b of the second internal electrode layer 616b face each other with the inner resin layer 614a interposed therebetween to generate a capacitance, so the characteristics of the capacitor are provided.

The first internal electrode layer 616a and the second internal electrode layer 616b can include a suitable conductive material, for example, a metal such as Ni, Cu, Ag, Pd, or Au or an alloy that includes one of these metals, such as Ag—Pd. However, the first internal electrode layer 616a and the second internal electrode layer 616b are not limited thereto. In the present example embodiment, the first internal electrode layer 616a and the second internal electrode layer 616b include Cu having high conductivity as a main component. Thus, it is possible to reduce the ESR of the multilayer capacitor 610.

The dielectric constant of the inner resin layer 614a is lower than those of dielectric materials used in existing multilayer capacitors, so, in order to provide a capacitor of the same capacitance, it is necessary to increase the areas of the counter electrode portions 626a, 626b accordingly. Therefore, it is necessary to increase the number of the first internal electrode layers 616a and the second internal electrode layers 616b. As a result, the total area of the internal electrode layers 616 increases, so it is possible to reduce the ESR of the multilayer capacitor 610. Furthermore, since the multilayer body 612 includes the inner resin layers 614a and the outer resin layers 614b, even when warpage occurs in the multilayer capacitor 610, the warpage can be absorbed by the inner resin layers 614a and the outer resin layers 614b, so the warpage strength can be improved. Therefore, compared to the existing multilayer capacitors, the mechanical strength can be improved.

Furthermore, when a multilayer ceramic capacitor, which is an example of the existing multilayer capacitor, is manufactured, the sintering temperature of the dielectric ceramic is higher than the sintering temperature of the internal electrode 616 when the dielectric ceramic is fired. As a result, there is a risk that particles couple together due to over-sintering of the internal electrodes 616 to form voids in the internal electrodes 616, which may lead to a reduction in effective area and a decrease in the linearity of the end portions of the internal electrodes 616. However, since it is possible to form the multilayer capacitor 610 without including a firing process at a temperature exceeding the melting point of the inner resin layer 614a, there is no reduction in effective area or linearity due to over-sintering of the first internal electrode layer 616a and the second internal electrode layer 616b. Therefore, the area of the internal electrodes 616 per unit number of sheets can be maximized, so the maximum capacitance can be obtained. Furthermore, since the linearity of the end portions of the internal electrodes 616 can be improved, the ESR reduces.

The first internal electrode layer 616a and the second internal electrode layer 616b preferably have no voids. Thus, the current path of the multilayer capacitor 610 shortens, with the result that the ESR can be reduced.

The linearity of each of the end portions of the first internal electrode layer 616a or the second internal electrode layer 616b, where the first internal electrode layer 616a or the second internal electrode layer 616b is in contact with the inner resin layer 614a, is, for example, preferably greater than or equal to about 1.0 and less than or equal to about 1.5. Furthermore, the linearity of each of the end portions of the first internal electrode layer 616a or the second internal electrode layer 616b, where the first internal electrode layer 616a or the second internal electrode layer 616b is in contact with the inner resin layer 614a, is, for example, preferably about 1.0. Thus, the current path can be provided in a route close to the shortest path, so the ESR can be reduced.

Here, the linearity of each of the end portions in the width direction y and the length direction z, where the first internal electrode layer 616a and the second internal electrode layer 616b are in contact with the inner resin layer 614a, can be calculated using a method the same as or similar to a calculation method for the linearity of each of the end portions, in the width direction y and the length direction z, of the internal electrode layer 16 according to the first example embodiment.

As shown in FIGS. 36 and 38, among the end portions of the first internal electrode layer 616a, the first side surface 612c-side end portion that is the end portion exposed at any of the first side surface 612c, the second side surface 612d, the first end surface 612e, and the second end surface 612f of the multilayer body 612 is reduced in thickness in the lamination direction x toward the surface (the second side surface 612d) opposite the surface at which the first internal electrode layer 616a is exposed. Among the end portions of the first internal electrode layer 616a, the second side surface 612d-side end portion that is the end portion exposed at any of the first side surface 612c, the second side surface 612d, the first end surface 612e, and the second end surface 612f of the multilayer body 612 is reduced in thickness in the lamination direction x toward the surface (the first side surface 612c) opposite the surface at which the first internal electrode layer 616a is exposed. In other words, the first internal electrode layer 616a is exposed at the first side surface 612c and the second side surface 612d, and, in the cross section of the lamination direction x and the width direction y (WT cross section), a portion of the first internal electrode layer 616a, exposed at the first side surface 612c, is configured to have a triangular or substantially triangular shape that reduces in length in the lamination direction x from the first side surface 612c toward the second side surface 612d, and a portion of the first internal electrode layer 616a, exposed at the second side surface 612d, is configured to have a rectangular or substantially triangular shape that reduces in length in the lamination direction x from the second side surface 612d toward the first side surface 612c.

Similarly, among the end portions of the first internal electrode layer 616a, the first end surface 612e-side end portion that is the end portion exposed at any of the first side surface 612c, the second side surface 612d, the first end surface 612e, and the second end surface 612f of the multilayer body 612 is reduced in thickness in the lamination direction x toward the surface (the second end surface 612f) opposite the surface at which the first internal electrode layer 616a is exposed. Among the end portions of the first internal electrode layer 616a, the second end surface 612f-side end portion that is the end portion exposed at any of the first side surface 612c, the second side surface 612d, the first end surface 612e, and the second end surface 612f of the multilayer body 612 is reduced in thickness in the lamination direction x toward the surface (the first end surface 612e) opposite the surface at which the first internal electrode layer 616a is exposed. In other words, the first internal electrode layer 616a is exposed at the first end surface 612e and the second end surface 612f, and, in the cross section of the lamination direction x and the length direction z (LT cross section), a portion of the first internal electrode layer 616a, exposed at the first end surface 612e, is configured to have a triangular or substantially triangular shape that reduces in length in the lamination direction x from the first end surface 612e toward the second end surface 612f, and a portion of the first internal electrode layer 616a, exposed at the second end surface 612f, is configured to have a triangular or substantially triangular shape that reduces in length in the lamination direction x from the second end surface 612f toward the first end surface 612e.

As a result, the bonding area between both the first outer electrode 630a and the second outer electrode 630b and the first internal electrode layer 616a is increased, so the adhesion strength is increased, and the ESR is reduced.

Where a region in which, among the end portions of the first internal electrode layer 616a, the first side surface 612c-side end portion that is the end portion exposed at any of the first side surface 612c, the second side surface 612d, the first end surface 612e, and the second end surface 612f of the multilayer body 612 is reduced in thickness in the lamination direction x toward the surface (the second side surface 612d) opposite the surface at which the first internal electrode layer 616a is exposed and a region in which, among the end portions of the first internal electrode layer 616a, the first end surface 612e-side end portion that is the end portion exposed at any of the first side surface 612c, the second side surface 612d, the first end surface 612e, and the second end surface 612f of the multilayer body 612 is reduced in thickness in the lamination direction x toward the surface (the second end surface 612f) opposite the surface at which the first internal electrode layer 616a is exposed are first exposed end regions 650a, the entire or substantially the entire first exposed end regions 650a are exposed from the multilayer body 612.

Similarly, where a region in which, among the end portions of the first internal electrode layer 616a, the second side surface 612d-side end portion that is the end portion exposed at any of the first side surface 612c, the second side surface 612d, the first end surface 612e, and the second end surface 612f of the multilayer body 612 is reduced in thickness in the lamination direction x toward the surface (the first side surface 612c) opposite the surface at which the first internal electrode layer 616a is exposed and a region in which, among the end portions of the first internal electrode layer 616a, the second end surface 612f-side end portion that is the end portion exposed at any of the first side surface 612c, the second side surface 612d, the first end surface 612e, and the second end surface 612f of the multilayer body 612 is reduced in thickness in the lamination direction x toward the surface (the first end surface 612e) opposite the surface at which the first internal electrode layer 616a is exposed are second exposed end regions 650b, the entire or substantially the entire second exposed end regions 650b are exposed from the multilayer body 612.

By exposing the entire or substantially the entire first exposed end regions 650a and the entire or substantially the entire second exposed end regions 650b from the multilayer body 612, the bonding area between both the first outer electrode 630a and the second outer electrode 630b and the first internal electrode layer 616a is increased, so the adhesion strength is increased, and the ESR is reduced.

At this time, among the thicknesses of the first internal electrode layer 616a in the lamination direction x, the ratio between the thickest portion and the thinnest portion is, for example, preferably such that the thickest portion is about 1.5 times or more and about 2.5 times or less the thinnest portion. With such a configuration, the adhesion strength between both the first outer electrode 630a and the second outer electrode 630b and the first internal electrode layer 616a can be increased without increasing the thickness of the multilayer body 612 in the lamination direction x.

The first exposed end regions 650a and the second exposed end regions 650b can be formed, for example, by immersing the first side surface 612c and the second side surface 612d, and the first end surface 612e and second end surface 612f of the multilayer body 612 in an etchant to etch the inner resin layer 614a.

As shown in FIGS. 37 and 38, among the end portions of the second internal electrode layer 616b, the first side surface 612c-side end portion that is the end portion exposed at any of the first side surface 612c, the second side surface 612d, the first end surface 612e, and the second end surface 612f of the multilayer body 612 is reduced in thickness in the lamination direction x toward the surface (the second side surface 612d) opposite the surface at which the second internal electrode layer 616b is exposed. Among the end portions of the second internal electrode layer 616b, the second side surface 612d-side end portion that is the end portion exposed at any of the first side surface 612c, the second side surface 612d, the first end surface 612e, and the second end surface 612f of the multilayer body 612 is reduced in thickness in the lamination direction x toward the surface (the first side surface 612c) opposite the surface at which the second internal electrode layer 616b is exposed. In other words, the second internal electrode layer 616b is exposed at the first side surface 612c and the second side surface 612d, and, in the cross section of the lamination direction x and the width direction y (WT cross section), a portion of the second internal electrode layer 616b, exposed at the first side surface 612c, is configured to have a triangular or substantially triangular shape that reduces in length in the lamination direction x from the first side surface 612c toward the second side surface 612d, and a portion of the second internal electrode layer 616b, exposed at the second side surface 612d, is configured to have a triangular or substantially triangular shape that reduces in length in the lamination direction x from the second side surface 612d toward the first side surface 612c.

Similarly, among the end portions of the second internal electrode layer 616b, the first end surface 612e-side end portion that is the end portion exposed at any of the first side surface 612c, the second side surface 612d, the first end surface 612e, and the second end surface 612f of the multilayer body 612 is reduced in thickness in the lamination direction x toward the surface (the second end surface 612f) opposite the surface at which the second internal electrode layer 616b is exposed. Among the end portions of the second internal electrode layer 616b, the second end surface 612f-side end portion that is the end portion exposed at any of the first side surface 612c, the second side surface 612d, the first end surface 612e, and the second end surface 612f of the multilayer body 612 is reduced in thickness in the lamination direction x toward the surface (the first end surface 612e) opposite the surface at which the second internal electrode layer 616b is exposed. In other words, the second internal electrode layer 616b is exposed at the first end surface 612e and the second end surface 612f, and, in the cross section of the lamination direction x and the length direction z (LT cross section), a portion of the second internal electrode layer 616b, exposed at the first end surface 612e, is configured to have a triangular or substantially triangular shape that reduces in length in the lamination direction x from the first end surface 612e toward the second end surface 612f, and a portion of the second internal electrode layer 616b, exposed at the second end surface 612f, is configured to have a triangular or substantially triangular shape that reduces in length in the lamination direction x from the second end surface 612f toward the first end surface 612e.

As a result, the bonding area between both the third outer electrode 631a and the fourth outer electrode 631b and the second internal electrode layer 616b is increased, so the adhesion strength is increased, and the ESR is reduced.

Where a region in which, among the end portions of the second internal electrode layer 616b, the first side surface 612c-side end portion that is the end portion exposed at any of the first side surface 612c, the second side surface 612d, the first end surface 612e, and the second end surface 612f of the multilayer body 612 is reduced in thickness in the lamination direction x toward the surface (the second side surface 612d) opposite the surface at which the second internal electrode layer 616b is exposed and a region in which, among the end portions of the second internal electrode layer 616b, the second end surface 612f-side end portion that is the end portion exposed at any of the first side surface 612c, the second side surface 612d, the first end surface 612e, and the second end surface 612f of the multilayer body 612 is reduced in thickness in the lamination direction x toward the surface (the first end surface 612e) opposite the surface at which the second internal electrode layer 616b is exposed are third exposed end regions 651a, the entire or substantially the entire third exposed end regions 651a are exposed from the multilayer body 612.

Similarly, where a region in which, among the end portions of the second internal electrode layer 616b, the second side surface 612d-side end portion that is the end portion exposed at any of the first side surface 612c, the second side surface 612d, the first end surface 612e, and the second end surface 612f of the multilayer body 612 is reduced in thickness in the lamination direction x toward the surface (the first side surface 612c) opposite the surface at which the second internal electrode layer 616b is exposed and a region in which, among the end portions of the second internal electrode layer 616b, the first end surface 612e-side end portion that is the end portion exposed at any of the first side surface 612c, the second side surface 612d, the first end surface 612e, and the second end surface 612f of the multilayer body 612 is reduced in thickness in the lamination direction x toward the surface (the second end surface 612f) opposite the surface at which the second internal electrode layer 616b is exposed are fourth exposed end regions 651b, the entire or substantially the entire fourth exposed end regions 651b are exposed from the multilayer body 612.

By exposing the entire or substantially the entire third exposed end regions 651a and the entire or substantially the entire fourth exposed end regions 651b from the multilayer body 612, the bonding area between both the third outer electrode 631a and the fourth outer electrode 631b and the second internal electrode layer 616b is increased, so the adhesion strength is increased, and the ESR is reduced.

At this time, among the thicknesses of the second internal electrode layer 616b in the lamination direction x, the ratio between the thickest portion and the thinnest portion is, for example, preferably such that the thickest portion is about 1.5 times or more and about 2.5 times or less the thinnest portion. With such a configuration, the adhesion strength between both the third outer electrode 631a and the fourth outer electrode 631b and the second internal electrode layer 616b can be increased without increasing the thickness of the multilayer body 612 in the lamination direction x.

The third exposed end regions 651a and the fourth exposed end regions 651b can be formed, for example, by immersing the first side surface 612c and the second side surface 612d, and the first end surface 612e and second end surface 612f of the multilayer body 612 in an etchant to etch the inner resin layer 614a.

The number of the first internal electrode layers 616a and the second internal electrode layers 616b is, for example, preferably greater than or equal to 15 in total and less than or equal to 200 in total.

The multilayer body 612 may include first notches extending from the first side surface 612c, at which the first lead-out electrode portions 628a of the first internal electrode layers 616a are exposed, toward the second side surface 612d that is the opposite surface, and first notches extending from the first end surface 612e, at which the first lead-out electrode portions 628a of the first internal electrode layers 616a are exposed, toward the second end surface 612f that is the opposite surface.

Similarly, the multilayer body 612 may include second notches extending from the second side surface 612d, at which the second lead-out electrode portions 628b of the first internal electrode layers 616a are exposed, toward the first side surface 612c that is the opposite surface, and second notches extending from the second end surface 612f, at which the second lead-out electrode portions 628b of the first internal electrode layers 616a are exposed, toward the first end surface 612e that is the opposite surface.

Furthermore, the multilayer body 612 may include third notches extending from the first side surface 612c, at which the third lead-out electrode portions 629a of the second internal electrode layers 616b are exposed, toward the second side surface 612d that is the opposite surface, and third notches extending from the second end surface 612f, at which the third lead-out electrode portions 629a of the second internal electrode layers 616b are exposed, toward the first end surface 612e that is the opposite surface.

Similarly, the multilayer body 612 may include fourth notches extending from the second side surface 612d, at which the fourth lead-out electrode portions 629b of the second internal electrode layers 616b are exposed, toward the first side surface 612c that is the opposite surface, and fourth notches extending from the first end surface 612e, at which the fourth lead-out electrode portions 629b of the second internal electrode layers 616b are exposed, toward the second end surface 612f that is the opposite surface.

As a result, the outer electrodes 630, 631 can enter the first notches, the second notches, the third notches, and the fourth notches to improve the adhesion strength between the multilayer body 612 and the outer electrodes 630, 631 due to the anchor effect.

The first notches, the second notches, the third notches, and the fourth notches can be formed, for example, by immersing the first side surface 612c, the second side surface 612d, the first end surface 612e, and the second end surface 612f of the multilayer body 612 in an etchant to etch the inner resin layer 614a.

As shown in FIGS. 35 to 38, the outer electrodes 630, 631 are disposed on the multilayer body 612.

Each of the outer electrodes 630 includes a base electrode layer 632 and a plating layer 634 provided so as to cover the base electrode layer 632.

Each of the outer electrodes 631 includes a base electrode layer 633 and a plating layer 635 provided so as to cover the base electrode layer 633.

The outer electrodes 630 include the first outer electrode 630a and the second outer electrode 630b.

The first outer electrode 630a is disposed so as to cover the first lead-out electrode portions 628a at the first side surface 612c and the first end surface 612e, and is disposed so as to cover a portion of the first principal surface 612a and the second principal surface 612b. The first outer electrode 630a is electrically connected to the first lead-out electrode portions 628a of the first internal electrode layers 616a.

The second outer electrode 630b is disposed so as to cover the second lead-out electrode portions 628b at the second side surface 612d and the second end surface 612f, and is disposed so as to cover a portion of the first principal surface 612a and the second principal surface 612b. The second outer electrode 630b is electrically connected to the second lead-out electrode portions 628b of the first internal electrode layers 616a. The outer electrodes 631 include the third outer electrode 631a and the fourth outer electrode 631b.

The third outer electrode 631a is disposed so as to cover the third lead-out electrode portions 629a at the first side surface 612c and the second end surface 612f, and is disposed so as to cover a portion of the first principal surface 612a and the second principal surface 612b. The third outer electrode 631a is electrically connected to the third lead-out electrode portions 629a of the second internal electrode layers 616b.

The fourth outer electrode 631b is disposed so as to cover the fourth lead-out electrode portions 629b at the second side surface 612d and the first end surface 612e, and is disposed so as to cover a portion of the first principal surface 612a and the second principal surface 612b. The fourth outer electrode 631b is electrically connected to the fourth lead-out electrode portions 629b of the second internal electrode layers 616b.

In the multilayer body 612, each of the first counter electrode portions 626a of the first internal electrode layers 616a and a corresponding one of the second counter electrode portions 626b of the second internal electrode layers 616b face each other with the inner resin layer 614a interposed therebetween, so the capacitance is generated. Therefore, it is possible to obtain capacitance between the first outer electrode 630a and the second outer electrode 630b that are connected to the first internal electrode layers 616a and capacitance between the third outer electrode 631a and the fourth outer electrode 631b that are connected to the second internal electrode layers 616b, so the characteristics of the capacitor are provided.

The base electrode layers 632 include a first base electrode layer 632a and a second base electrode layer 632b.

The first base electrode layer 632a covers a portion of the first principal surface 612a, a portion of the second principal surface 612b, a portion of the first side surface 612c, and a portion of the first end surface 612e.

The second base electrode layer 632b covers a portion of the first principal surface 612a, a portion of the second principal surface 612b, a portion of the second side surface 612d, and a portion of the second end surface 612f.

The base electrode layers 633 include a third base electrode layer 633a and a fourth base electrode layer 633b.

The third base electrode layer 633a covers a portion of the first principal surface 612a, a portion of the second principal surface 612b, a portion of the first side surface 612c, and a portion of the second end surface 612f.

The fourth base electrode layer 633b covers a portion of the first principal surface 612a, a portion of the second principal surface 612b, a portion of the second side surface 612d, and a portion of the first end surface 612e.

The material of the base electrode layers 632, 633 and a manufacturing method for the base electrode layers 632, 633 are, for example, the same or similar to those of the base electrode layer 32 of the first example embodiment, so the description is omitted.

The plating layers 634 include a first plating layer 634a and a second plating layer 634b.

The first plating layer 634a is disposed so as to cover the first base electrode layer 632a.

The second plating layer 634b is disposed so as to cover the second base electrode layer 632b.

The plating layers 635 include a third plating layer 635a and a fourth plating layer 635b.

The third plating layer 635a is disposed so as to cover the third base electrode layer 633a.

The fourth plating layer 635b is disposed so as to cover the fourth base electrode layer 633b.

Each of the plating layer 634 and the plating layer 635 may include multiple layers.

The material of the plating layers 634, 635 and a manufacturing method for the plating layers 634, 635 are, for example, the same as or similar to those of the plating layer 34 of the first example embodiment, so the description is omitted.

Next, an example of a manufacturing method for the multilayer capacitor 610 according to the seventh example embodiment will be described.

First, raw materials for the inner resin layers 614a and the outer resin layers 614b are prepared. The inner resin layers 614a and the outer resin layers 614b are, for example, resin sheets mainly made of thermoplastic resin, such as liquid crystal polymer (LCP).

Subsequently, a conductor pattern that becomes the internal electrode layer 616 is formed on each of the resin sheets that become the multiple inner resin layers 614a. More specifically, a metal foil, such as copper foil, for example, is laminated on one side of the resin sheet that becomes the inner resin layer 614a, and the metal foil is patterned using, for example, photolithography and then laminated. At this time, the adhesion between the inner resin layer 614a and the internal electrode layer 616 may be improved, for example, by roughening in advance the surface of one side of the resin sheet that becomes the inner resin layer 614a and laminating a Cu foil on top of the resin sheet. Thus, a block for an inner layer portion is formed. Multiple or single block for a first principal surface-side outer layer portion and multiple or single block for a second principal surface-side outer layer portion are formed by laminating the resin sheets that become the outer resin layers 614b.

Subsequently, a multilayer body block is manufactured by laminating the block for an inner layer portion so as to be sandwiched between the block for a first principal surface-side outer layer and the block for a second principal surface-side outer layer and then applying hot press (simultaneous pressing).

The manufactured multilayer body block is divided into individual pieces, for example, by die cutting to form the multilayer body 612. To expose the end portions of the internal electrode layers 616 on the multilayer body 612, for example, the first side surface 612c, the second side surface 612d, the first end surface 612e, and the second end surface 612f may be immersed in an etchant. By doing this, the inner resin layer 614a can be etched to expose the end portions of the internal electrode layers 616, with the result that the first exposed end region 650a, the second exposed end region 650b, the third exposed end region 651a, and the fourth exposed end region 651b can be formed.

When, for example, thin film layers are formed as the base electrode layers 632, 633, the base electrode layers 632, 633 formed of deposited metal particles can be formed on the first principal surface 612a and the second principal surface 612b of the obtained multilayer body 612, for example, by sputtering. Thus, for example, thin films less than or equal to about 1.0 μm can be formed as the base electrode layers 632, 633. At this time, by controlling the positional relationship such as the angle and distance with respect to the multilayer body 612, it is possible to control the thicknesses of the base electrode layers 632, 633 and the amount by which the base electrode layers 632, 633 extend onto the first side surface 612c and the second side surface 612d, the first end surface 612e and the second end surface 612f of the multilayer body 612. It is also possible to apply sputtering not only to one surface but also individually to the surfaces.

When, for example, plating layers are directly formed as the base electrode layers 632, 633, electrolytic plating, electroless plating, or the like, is used. For example, barrel plating is preferable for electrolytic plating.

Subsequently, plating layers 634, 635 are formed on the formed base electrode layers 632, 633, for example, by barrel plating.

When each of the plating layers 634, 635 has a two-layer structure, for example, Ni plating and Sn plating are arranged in this order from the multilayer body 612 side. However, the types of metal are not limited thereto. When each of the plating layers 634, 635 has a three-layer structure, for example, Sn plating, Ni plating, and Sn plating are arranged in this order from the multilayer body 612 side.

In this way, the multilayer capacitor 610 according to the present example embodiment is manufactured.

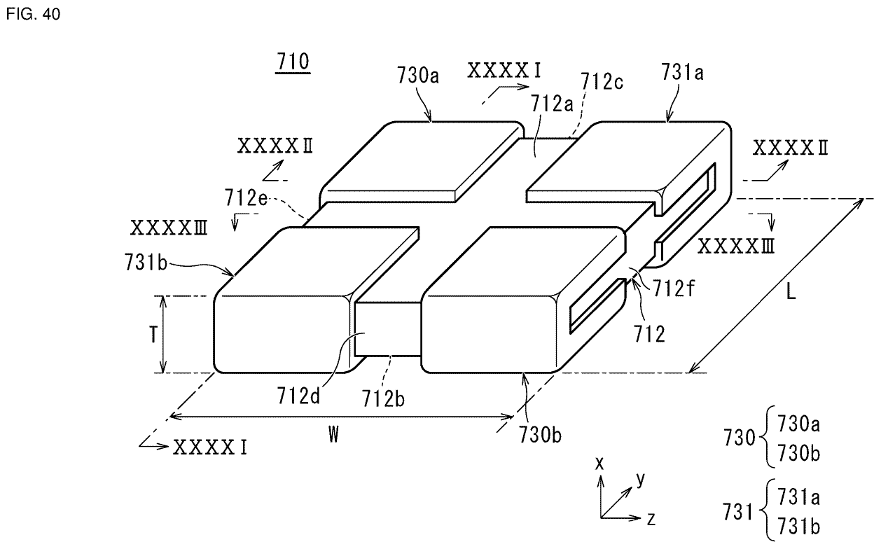

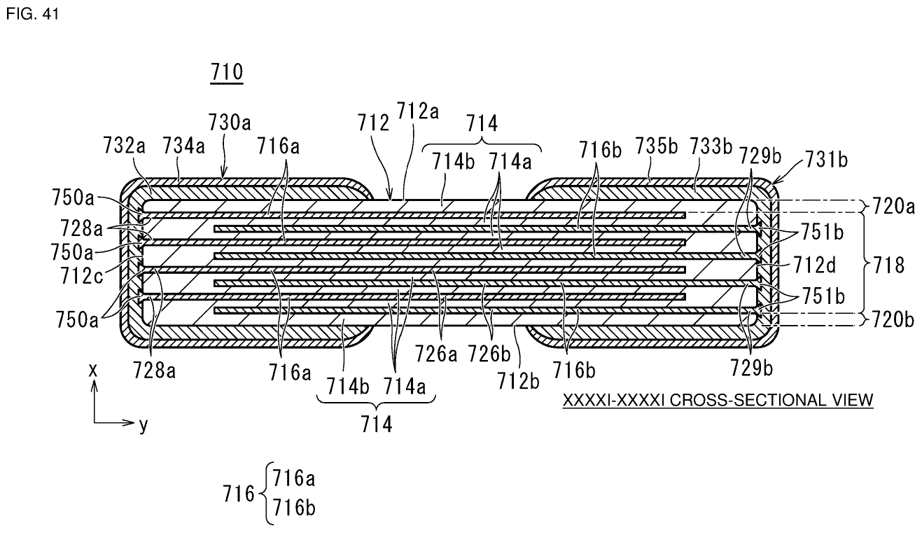

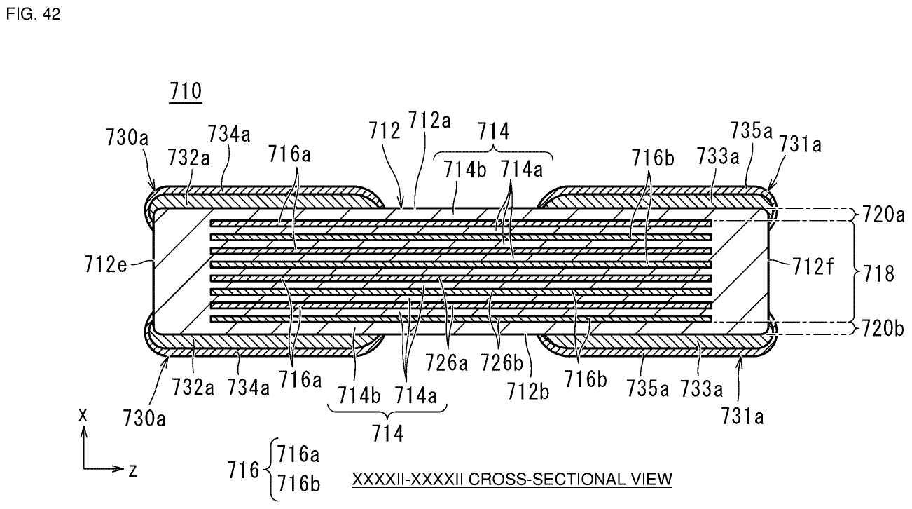

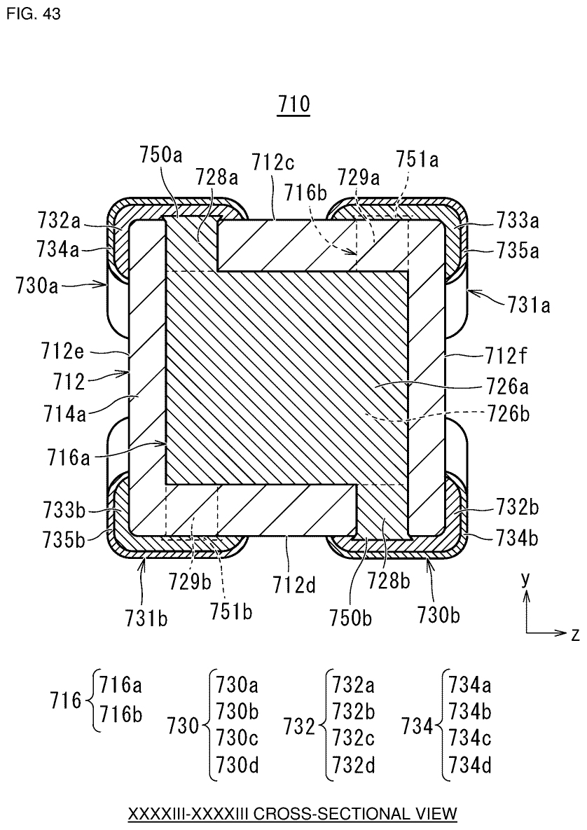

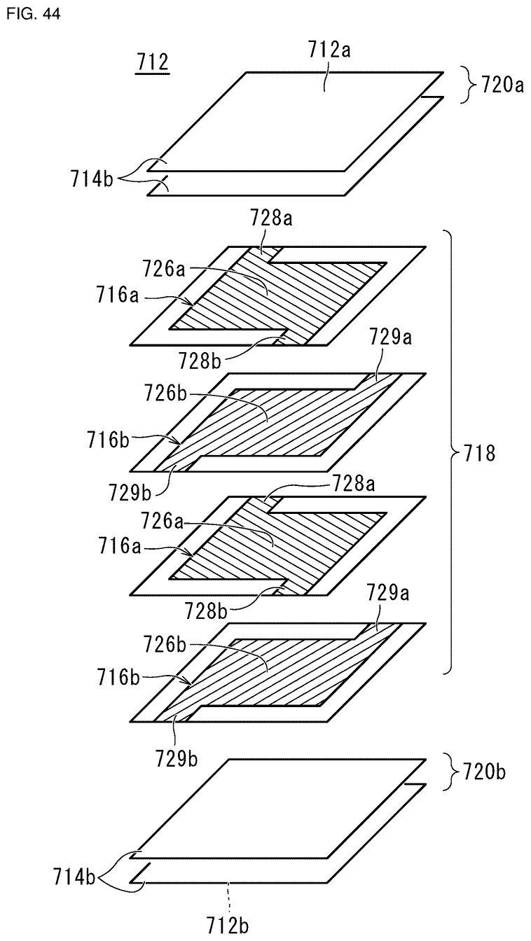

Next, a multilayer capacitor 710 according to an eighth example embodiment of the present invention will be described. FIG. 40 is an external perspective view of the multilayer capacitor according to the eighth example embodiment of the present invention. FIG. 41 is a cross-sectional view taken along the line XXXXI-XXXXI in FIG. 40. FIG. 42 is a cross-sectional view taken along the line XXXXII-XXXXII in FIG. 40. FIG. 43 is a cross-sectional view taken along the line XXXXIII-XXXXIII in FIG. 40. FIG. 44 is an exploded perspective view of a multilayer body shown in FIG. 40.

The multilayer capacitor 710 includes a multilayer body 712 and outer electrodes 730, 731.

The multilayer body 712 includes a first principal surface 712a and a second principal surface 712b opposite to each other in a lamination direction x, a first side surface 712c and a second side surface 712d opposite to each other in a width direction y orthogonal or substantially orthogonal to the lamination direction x, and a first end surface 712e and a second end surface 712f opposite to each other in a length direction z orthogonal or substantially orthogonal to the lamination direction x and the width direction y. The first principal surface 712a and the second principal surface 712b each extend in the width direction y and the length direction z. The first side surface 712c and the second side surface 712d each extend in the lamination direction x and the length direction z. The first end surface 712e and the second end surface 712f each extend in the lamination direction x and the width direction y. Therefore, the lamination direction x is a direction that connects the first principal surface 712a and the second principal surface 712b, the width direction y is a direction that connects the first side surface 712c and the second side surface 712d, and the length direction z is a direction that connects the first end surface 712e and the second end surface 712f. The surfaces of the first principal surface 712a and the second principal surface 712b, the first side surface 712c and the second side surface 712d, and the first end surface 712e and the second end surface 712f may include irregularities, and the surfaces may be roughened to be rough surfaces.

In the multilayer body 712, corner portions and ridge portions are preferably rounded. Here, the corner portion refers to a portion where three sides of the multilayer body 712 intersect, and the ridge portion refers to a portion where two sides of the multilayer body 712 intersect. By rounding the corner portions and ridge portions of the multilayer body 712, it is possible to reduce or prevent chipping and cracking of the multilayer body 712.

The multilayer body 712 includes multiple resin layers 714 and multiple internal electrode layers 716, which are laminated. The resin layers 714 include inner resin layers 714a and outer resin layers 714b. The internal electrode layers 716 include first internal electrode layers 716a and second internal electrode layers 716b.

As shown in FIGS. 41 and 42, in the lamination direction x connecting the first principal surface 712a and the second principal surface 712b, the multilayer body 712 includes an inner layer portion 718 in which the multiple internal electrode layers 716 face each other, a first principal surface-side outer layer portion 720a including multiple outer resin layers 714b positioned between the internal electrode layer 716 closest to the first principal surface 712a side and the first principal surface 712a, and a second principal surface-side outer layer portion 720b including multiple outer resin layers 714b positioned between the internal electrode layer 716 closest to the second principal surface 712b side and the second principal surface 712b.

The first principal surface-side outer layer portion 720a is an assembly of multiple outer resin layers 714b positioned on the first principal surface 712a side of the multilayer body 712 between the first principal surface 712a and the internal electrode layer 716 closest to the first principal surface 712a.

The second principal surface-side outer layer portion 720b is an assembly of multiple outer resin layers 714b positioned on the second principal surface 712b side of the multilayer body 712 between the second principal surface 712b and the internal electrode layer 716 closest to the second principal surface 712b.

The region sandwiched between the first principal surface-side outer layer portion 720a and the second principal surface-side outer layer portion 720b is the inner layer portion 718.

The inner layer portion 718 includes inner resin layers 714a, first internal electrode layers 716a alternately laminated with the inner resin layers 714a, and second internal electrode layers 716b alternately laminated with the inner resin layers 714a.

For example, resins, such as liquid crystal polymer (LCP) resin, epoxy resin, or polyimide resin, which are excellent in heat resistance, can be used as the components of the resin layers 714, that is, the inner resin layers 714a and the outer resin layers 714b. However, the components are not limited thereto.

The outer resin layers 714b of each of the first principal surface-side outer layer portion 720a and the second principal surface-side outer layer portion 720b include the same type of resin material as the inner resin layers 714a. Each of the first principal surface-side outer layer portion 720a and the second principal surface-side outer layer portion 720b may include multiple outer resin layers 714b or may include a single outer resin layer 714b.

The inner resin layers 714a and the outer resin layers 714b may include different components. For example, the inner resin layers 714a may include a resin with a high dielectric constant, and the outer resin layers 714b may include components with good moisture resistance, weather resistance, and strength.

The number of inner resin layers 714a and outer resin layers 714b laminated is not limited and is, for example, preferably greater than or equal to 15 and less than or equal to 200, including the outer resin layers 714b. The thickness of the inner resin layer 714a is, for example, preferably greater than or equal to about 0.2 μm and less than or equal to about 10.0 μm.

As shown in FIGS. 41 to 43, the internal electrode layers 716 include the multiple first internal electrode layers 716a and the multiple second internal electrode layers 716b. The first internal electrode layer 716a and the second internal electrode layer 716b are alternately laminated with the inner resin layer 714a interposed therebetween.

Each of the first internal electrode layers 716a is disposed on the surface of a corresponding one of the inner resin layers 714a. Each of the first internal electrode layers 716a includes a first counter electrode portion 726a facing the first principal surface 712a and the second principal surface 712b and facing the second internal electrode layer 716b. The first internal electrode layers 716a are laminated in the lamination direction x.

Each of the second internal electrode layers 716b is disposed on the surface of a corresponding one of the inner resin layers 714a, different from the inner resin layer 714a where the first internal electrode layer 716a is disposed. Each of the second internal electrode layers 716b includes a second counter electrode portion 726b facing the first principal surface 712a and the second principal surface 712b. The second internal electrode layers 716b are laminated in the lamination direction x.

As shown in FIG. 43, the first internal electrode layer 716a is extended to the first side surface 712c of the multilayer body 712 by a first lead-out electrode portion 728a, and is extended to the second side surface 712d of the multilayer body 712 by a second lead-out electrode portion 728b.

The second internal electrode layer 716b is extended to the first side surface 712c of the multilayer body 712 by a third lead-out electrode portion 729a, and is extended to the second side surface 712d of the multilayer body 712 by a fourth lead-out electrode portion 729b.

In the present example embodiment, the first counter electrode portion 726a of the first internal electrode layer 716a and the second counter electrode portion 726b of the second internal electrode layer 716b face each other with the inner resin layer 714a interposed therebetween to generate a capacitance, so the characteristics of the capacitor are provided.

The first internal electrode layer 716a and the second internal electrode layer 716b can include a suitable conductive material, for example, a metal such as Ni, Cu, Ag, Pd, or Au or an alloy that includes one of these metals, such as Ag—Pd. However, the first internal electrode layer 716a and the second internal electrode layer 716b are not limited thereto. In the present example embodiment, the first internal electrode layer 716a and the second internal electrode layer 716b include, for example, Cu having high conductivity as a main component. Thus, it is possible to reduce the ESR of the multilayer capacitor 710.

The dielectric constant of the inner resin layer 714a is lower than those of dielectric materials used in existing multilayer capacitors, so, in order to provide a capacitor of the same capacitance, it is necessary to increase the areas of the counter electrode portions 726a, 726b accordingly. Therefore, it is necessary to increase the number of the first internal electrode layers 716a and the second internal electrode layers 716b. As a result, the total area of the internal electrode layers 716 increases, so it is possible to reduce the ESR of the multilayer capacitor 710. Furthermore, since the multilayer body 712 includes the inner resin layers 714a and the outer resin layers 714b, even when warpage occurs in the multilayer capacitor 710, the warpage can be absorbed by the inner resin layers 714a and the outer resin layers 714b, so the warpage strength can be improved. Therefore, compared to the existing multilayer capacitors, the mechanical strength can be improved.

Furthermore, when a multilayer ceramic capacitor, which is an example of the existing multilayer capacitor, is manufactured, the sintering temperature of the dielectric ceramic is higher than the sintering temperature of the internal electrode 716 when the dielectric ceramic is fired. As a result, there is a risk that particles couple together due to over-sintering of the internal electrodes 716 to form voids in the internal electrodes 716, which may lead to a reduction in effective area and a decrease in the linearity of the end portions of the internal electrodes 716. However, since it is possible to form the multilayer capacitor 710 without including a firing process at a temperature exceeding the melting point of the inner resin layer 714a, there is no reduction in effective area or linearity due to over-sintering of the first internal electrode layer 716a and the second internal electrode layer 716b. Therefore, the area of the internal electrodes 716 per unit number of sheets can be maximized, so the maximum capacitance can be obtained. Furthermore, since the linearity of the end portions of the internal electrodes 716 can be improved, the ESR reduces.

The first internal electrode layer 716a and the second internal electrode layer 716b preferably have no voids. Thus, the current path of the multilayer capacitor 710 shortens, with the result that the ESR can be reduced.

The linearity of each of the end portions of the first internal electrode layer 716a or the second internal electrode layer 716b, where the first internal electrode layer 716a or the second internal electrode layer 716b is in contact with the inner resin layer 714a, is, for example, preferably greater than or equal to about 1.0 and less than or equal to about 1.5. Furthermore, the linearity of each of the end portions of the first internal electrode layer 716a or the second internal electrode layer 716b, where the first internal electrode layer 716a or the second internal electrode layer 716b is in contact with the inner resin layer 714a, is, for example, preferably about 1.0. Thus, the current path can be formed in a route close to the shortest path, so the ESR can be reduced.

Here, the linearity of each of the end portions in the width direction y and the length direction z, where the first internal electrode layer 716a and the second internal electrode layer 716b are in contact with the inner resin layer 714a, can be calculated using a method the same as or similar to a calculation method for the linearity of each of the end portions, in the width direction y and the length direction z, of the internal electrode layer 16 according to the first example embodiment.

As shown in FIGS. 41 and 43, among the end portions of the first internal electrode layer 716a, the first side surface 712c-side end portion that is the end portion exposed at any of the first side surface 712c, the second side surface 712d, the first end surface 712e, and the second end surface 712f of the multilayer body 712 is reduced in thickness in the lamination direction x toward the surface (the second side surface 712d) opposite the surface at which the first internal electrode layer 716a is exposed. Among the end portions of the first internal electrode layer 716a, the second side surface 712d-side end portion that is the end portion exposed at any of the first side surface 712c, the second side surface 712d, the first end surface 712e, and the second end surface 712f of the multilayer body 712 is reduced in thickness in the lamination direction x toward the surface (the first side surface 712c) opposite the surface at which the first internal electrode layer 716a is exposed. In other words, the first internal electrode layer 716a is exposed at the first side surface 712c and the second side surface 712d, and, in the cross section of the lamination direction x and the width direction y (WT cross section), a portion of the first internal electrode layer 716a, exposed at the first side surface 712c, is configured to have a triangular or substantially triangular shape that reduces in length in the lamination direction x from the first side surface 712c toward the second side surface 712d, and a portion of the first internal electrode layer 716a, exposed at the second side surface 712d, is configured to have a triangular or substantially triangular shape that reduces in length in the lamination direction x from the second side surface 712d toward the first side surface 712c. As a result, the bonding area between both the first outer electrode 730a and the second outer electrode 730b and the first internal electrode layer 716a is increased, so the adhesion strength is increased, and the ESR is reduced.

Where a region in which, among the end portions of the first internal electrode layer 716a, the first side surface 712c-side end portion that is the end portion exposed at any of the first side surface 712c, the second side surface 712d, the first end surface 712e, and the second end surface 712f of the multilayer body 712 is reduced in thickness in the lamination direction x toward the surface (the second side surface 712d) opposite the surface at which the first internal electrode layer 716a is exposed is a first exposed end region 750a, the entire or substantially the entire first exposed end region 750a is preferably exposed from the multilayer body 712. Similarly, where a region in which, among the end portions of the first internal electrode layer 716a, the second side surface 712d-side end portion that is the end portion exposed at any of the first side surface 712c, the second side surface 712d, the first end surface 712e, and the second end surface 712f of the multilayer body 712 is reduced in thickness in the lamination direction x toward the surface (the first side surface 712c) opposite the surface at which the first internal electrode layer 716a is exposed is a second exposed end region 750b, the entire or substantially the entire second exposed end region 750b is preferably exposed from the multilayer body 712. By exposing the entire first exposed end region 750a and the entire or substantially the entire second exposed end region 750b from the multilayer body 712, the bonding area between both the first outer electrode 730a and the second outer electrode 730b and the first internal electrode layer 716a increases, so the adhesion strength increases, and the ESR reduces.

At this time, among the thicknesses of the first internal electrode layer 716a in the lamination direction x, the ratio between the thickest portion and the thinnest portion is, for example, preferably such that the thickest portion is about 1.5 times or more and about 2.5 times or less the thinnest portion. With such a configuration, the adhesion strength between both the first outer electrode 730a and the second outer electrode 730b and the first internal electrode layer 716a can be increased without increasing the thickness of the multilayer body 712 in the lamination direction x.

The first exposed end region 750a and the second exposed end region 750b can be formed, for example, by immersing the first side surface 712c and second side surface 712d of the multilayer body 712 in an etchant to etch the inner resin layer 714a.

As shown in FIGS. 41 and 43, among the end portions of the second internal electrode layer 716b, the first side surface 712c-side end portion that is the end portion exposed at any of the first side surface 712c, the second side surface 712d, the first end surface 712e, and the second end surface 712f of the multilayer body 712 is reduced in thickness in the lamination direction x toward the surface (the second side surface 712d) opposite the surface at which the second internal electrode layer 716b is exposed. Among the end portions of the second internal electrode layer 716b, the second side surface 712d-side end portion that is the end portion exposed at any of the first side surface 712c, the second side surface 712d, the first end surface 712e, and the second end surface 712f of the multilayer body 712 is reduced in thickness in the lamination direction x toward the surface (the first side surface 712c) opposite the surface at which the second internal electrode layer 716b is exposed. In other words, the second internal electrode layer 716b is exposed at the first side surface 712c and the second side surface 712d, and, in the cross section of the lamination direction x and the width direction y (WT cross section), a portion of the second internal electrode layer 716b, exposed at the first side surface 712c, is configured to have a triangular or substantially triangular shape that reduces in length in the lamination direction x from the first side surface 712c toward the second side surface 712d, and a portion of the second internal electrode layer 716b, exposed at the second side surface 712d, is configured to have a triangular or substantially triangular shape that reduces in length in the lamination direction x from the second side surface 712d toward the first side surface 712c. As a result, the bonding area between both the third outer electrode 731a and the fourth outer electrode 731b and the second internal electrode layer 716b is increased, so the adhesion strength is increased, and the ESR is reduced.

Where a region in which, among the end portions of the second internal electrode layer 716b, the first side surface 712c-side end portion that is the end portion exposed at any of the first side surface 712c, the second side surface 712d, the first end surface 712e, and the second end surface 712f of the multilayer body 712 is reduced in thickness in the lamination direction x toward the surface (the second side surface 712d) opposite the surface at which the second internal electrode layer 716b is exposed is a third exposed end region 751a, the entire or substantially the entire third exposed end region 751a is preferably exposed from the multilayer body 712. Similarly, where a region in which, among the end portions of the second internal electrode layer 716b, the second side surface 712d-side end portion that is the end portion exposed at any of the first side surface 712c, the second side surface 712d, the first end surface 712e, and the second end surface 712f of the multilayer body 712 is reduced in thickness in the lamination direction x toward the surface (the first side surface 712c) opposite the surface at which the second internal electrode layer 716b is exposed is a fourth exposed end region 751b, the entire or substantially the entire fourth exposed end region 751b is preferably exposed from the multilayer body 712.

By exposing the entire or substantially the entire third exposed end region 751a and the entire or substantially the entire fourth exposed end region 751b from the multilayer body 712, the bonding area between both the third outer electrode 731a and the fourth outer electrode 731b and the second internal electrode layer 716b is increased, so the adhesion strength is increased, and the ESR is reduced.

At this time, among the thicknesses of the second internal electrode layer 716b in the lamination direction x, the ratio between the thickest portion and the thinnest portion is, preferably such that the thickest portion is about 1.5 times or more and about 2.5 times or less the thinnest portion. With such a configuration, the adhesion strength between both the third outer electrode 731a and the fourth outer electrode 731b and the second internal electrode layer 716b can be increased without increasing the thickness of the multilayer body 712 in the lamination direction x.

The third exposed end region 751a and the fourth exposed end region 751b can be formed, for example, by immersing the first side surface 712c and second side surface 712d of the multilayer body 712 in an etchant to etch the inner resin layer 714a.

The number of the first internal electrode layers 716a and the second internal electrode layers 716b is, for example, preferably greater than or equal to 15 in total and less than or equal to 200 in total.

The multilayer body 712 may include first notches extending from the first side surface 712c, at which the first lead-out electrode portions 728a of the first internal electrode layers 716a are exposed, toward the second side surface 712d that is the opposite surface. Similarly, the multilayer body 712 may include second notches extending from the second side surface 712d, at which the second lead-out electrode portions 728b of the first internal electrode layers 716a are exposed, toward the first side surface 712c that is the opposite surface.

Furthermore, the multilayer body 712 may include third notches extending from the first side surface 712c, at which the third lead-out electrode portions 729a of the second internal electrode layers 716b are exposed, toward the second side surface 712d that is the opposite surface. Similarly, the multilayer body 712 may include fourth notches extending from the second side surface 712d, at which the fourth lead-out electrode portions 729b of the second internal electrode layers 716b are exposed, toward the first side surface 712c that is the opposite surface.

As a result, the outer electrodes 730, 731 can enter the first notches, the second notches, the third notches, and the fourth notches to improve the adhesion strength between the multilayer body 712 and the outer electrodes 730, 731 due to the anchor effect.

The first notches, the second notches, the third notches, and the fourth notches can be formed, for example, by immersing the first side surface 712c and the second side surface 712d of the multilayer body 712 in an etchant to etch the inner resin layer 714a.

As shown in FIGS. 40 and 43, the outer electrodes 730, 731 are disposed on the multilayer body 712.

Each of the outer electrodes 730 includes a base electrode layer 732 and a plating layer 734 covering the base electrode layer 732.

Each of the outer electrodes 731 includes a base electrode layer 733 and a plating layer 735 covering the base electrode layer 733.

The outer electrodes 730 include the first outer electrode 730a and the second outer electrode 730b.

The first outer electrode 730a is disposed so as to cover the first lead-out electrode portions 728a at the first side surface 712c, and is disposed so as to cover a portion of the first principal surface 712a, the second principal surface 712b, and the first end surface 712e. The first outer electrode 730a is electrically connected to the first lead-out electrode portions 728a of the first internal electrode layers 716a.

The second outer electrode 730b is disposed so as to cover the second lead-out electrode portions 728b at the second side surface 712d, and is disposed so as to cover a portion of the first principal surface 712a, the second principal surface 712b, and the second end surface 712f. The second outer electrode 730b is electrically connected to the second lead-out electrode portions 728b of the first internal electrode layers 716a.

The outer electrodes 731 include the third outer electrode 731a and the fourth outer electrode 731b.

The third outer electrode 731a is disposed so as to cover the third lead-out electrode portions 729a at the first side surface 712c, and is disposed so as to cover a portion of the first principal surface 712a, the second principal surface 712b, and the second end surface 712f. The third outer electrode 731a is electrically connected to the third lead-out electrode portions 729a of the second internal electrode layers 716b.

The fourth outer electrode 731b is disposed so as to cover the fourth lead-out electrode portions 729b at the second side surface 712d, and is disposed so as to cover a portion of the first principal surface 712a, the second principal surface 712b, and the first end surface 712e. The fourth outer electrode 731b is electrically connected to the fourth lead-out electrode portions 729b of the second internal electrode layers 716b.

In the multilayer body 712, each of the first counter electrode portions 726a of the first internal electrode layers 716a and a corresponding one of the second counter electrode portions 726b of the second internal electrode layers 716b face each other with the inner resin layer 714a interposed therebetween, so the capacitance is generated. Therefore, it is possible to obtain capacitance between the first outer electrode 730a and the second outer electrode 730b that are connected to the first internal electrode layers 716a and capacitance between the third outer electrode 731a and the fourth outer electrode 731b that are connected to the second internal electrode layers 716b, so the characteristics of the capacitor are provided.

The base electrode layers 732 include a first base electrode layer 732a and a second base electrode layer 732b.

The first base electrode layer 732a covers a portion of the first principal surface 712a, a portion of the second principal surface 712b, a portion of the first side surface 712c, and a portion of the first end surface 712e.

The second base electrode layer 732b covers a portion of the first principal surface 712a, a portion of the second principal surface 712b, a portion of the second side surface 712d, and a portion of the second end surface 712f.

The base electrode layers 733 include a third base electrode layer 733a and a fourth base electrode layer 733b. The third base electrode layer 733a covers a portion of the first principal surface 712a, a portion of the second principal surface 712b, a portion of the first side surface 712c, and a portion of the second end surface 712f.

The fourth base electrode layer 733b covers a portion of the first principal surface 712a, a portion of the second principal surface 712b, a portion of the second side surface 712d, and a portion of the first end surface 712e.

The materials and formation methods of the base electrode layers 732, 733 are, for example, the same as or similar to those of the base electrode layers 632, 633 of the multilayer capacitor 610 according to the seventh example embodiment, so the description is omitted.

The plating layers 734 include a first plating layer 734a and a second plating layer 734b.

The first plating layer 734a covers the first base electrode layer 732a.

The second plating layer 734b covers the second base electrode layer 732b.

The plating layers 735 include a third plating layer 735a and a fourth plating layer 735b.

The third plating layer 735a covers the third base electrode layer 733a.

The fourth plating layer 735b covers the fourth base electrode layer 733b.

The plating layers 734, 735 may include multiple layers. The materials of the plating layers 734, 735 and a manufacturing method for the plating layers 734, 735 are, for example, the same as or similar to those of the plating layers 634, 635 of the multilayer capacitor 610 according to the seventh example embodiment, so the description is omitted.

As shown in FIG. 40, in the present example embodiment, the shape of each of the outer electrodes 730, 731 is a square U-shape when viewed from the first end surface 712e or the second end surface 712f of the multilayer body 712. However, not limited to this, the shape of each of the outer electrodes 730, 731 can also be a V-shape or U-shape when viewed from the first end surface 712e or the second end surface 712f of the multilayer body 712.

As described above, example embodiments of the present invention have been described. However, the present invention is not limited thereto.

Various modifications may be added to the example embodiments described above in terms of mechanism, shape, material, number, position, arrangement, or the like without departing from the scope of the present invention, and the present invention encompasses those modifications.

Example embodiments of the present invention relate to multilayer capacitors and can be used as multilayer capacitors each with reduced ESR and improved mechanical strength.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer capacitor comprising:
a multilayer body including a first principal surface and a second principal surface opposite to each other in a lamination direction, a first side surface and a second side surface opposite to each other in a width direction orthogonal or substantially orthogonal to the lamination direction, and a first end surface and a second end surface opposite to each other in a length direction orthogonal or substantially orthogonal to the lamination direction and the width direction;
a first outer electrode on one or more of the first principal surface, the second principal surface, the first side surface, the second side surface, the first end surface, and the second end surface of the multilayer body; and
a second outer electrode on one or more of the first principal surface, the second principal surface, the first side surface, the second side surface, the first end surface, and the second end surface of the multilayer body; wherein
the multilayer body includes an inner layer portion including:
multiple inner resin layers laminated in the lamination direction;
a first internal electrode layer between two of the multiple inner resin layers and exposed at any one or more of the first principal surface, the second principal surface, the first side surface, the second side surface, the first end surface, and the second end surface; and
a second internal electrode layer between two of the multiple inner resin layers and exposed at any one or more of the first principal surface, the second principal surface, the first side surface, the second side surface, the first end surface, and the second end surface.

2. The multilayer capacitor according to claim 1, wherein the first internal electrode layer and the second internal electrode layer do not contain any voids.

3. The multilayer capacitor according to claim 1, wherein a linearity of an end portion of the first internal electrode layer or the second internal electrode layer, at which the first internal electrode layer or the second internal electrode layer is in contact with the inner resin layer, is less than or equal to about 1.5.

4. The multilayer capacitor according to claim 3, wherein the linearity of the end portion of the first internal electrode layer or the second internal electrode layer, at which the first internal electrode layer or the second internal electrode layer is in contact with the inner resin layer, is greater than or equal to about 1.0.

5. The multilayer capacitor according to claim 1, wherein, among end portions of the first internal electrode layer or the second internal electrode layer, an end portion exposed at any of the first principal surface, the second principal surface, the first side surface, the second side surface, the first end surface, and the second end surface of the multilayer body is reduced in thickness in the lamination direction toward a surface opposite the surface at which the first internal electrode layer or the second internal electrode layer is exposed.

6. The multilayer capacitor according to claim 5, wherein
a region in which, among the end portions of the first internal electrode layer or the second internal electrode layer, the end portion exposed at any of the first principal surface, the second principal surface, the first side surface, the second side surface, the first end surface, and the second end surface of the multilayer body is reduced in thickness in the lamination direction toward a surface opposite the surface at which the first internal electrode layer or the second internal electrode layer is exposed is defined as an exposed end region; and
the exposed end region is entirely or substantially entirely exposed from the multilayer body.

7. The multilayer capacitor according to claim 1, wherein
the inner layer portion of the multilayer body includes multiple resin layers; and
the first and second internal electrode layer are interposed between two of the multiple resin layers.

8. The multilayer capacitor according to claim 7, wherein each of the multiple resin layers includes a liquid crystal polymer resin, an epoxy resin, or a polyimide resin.

9. The multilayer capacitor according to claim 7, wherein a thickness of each of the multiple resin layers is about 0.2 μm and less than or equal to about 10.0 μm.

10. The multilayer capacitor according to claim 1, wherein each of the first and second internal electrode layers includes Ni, Cu, Ag, Pd, or Au, or an alloy including at least one of Ni, Cu, Ag, Pd, or Au.

11. The multilayer capacitor according to claim 1, wherein a ratio of a thickness of a thickest portion of the first internal electrode layer to a thickness of a thinnest portion of the first internal electrode layer is about 1.5 times or more and about 2.5 times or less.

12. The multilayer capacitor according to claim 1, wherein a ratio of a thickness of a thickest portion of the second internal electrode layer to a thickness of a thinnest portion of the second internal electrode layer is about 1.5 times or more and about 2.5 times or less.

13. The multilayer capacitor according to claim 1, wherein a thickness of an end portion of the first internal electrode layer is greater than a thickness of a center portion of the first internal electrode layer.

14. The multilayer capacitor according to claim 1, wherein a thickness of an end portion of the second internal electrode layer is greater than a thickness of a center portion of the second internal electrode layer.

15. The multilayer capacitor according to claim 1, wherein a thickness of each of the first and second internal electrode layers is greater than or equal to about 1 μm and less than or equal to about 12 μm.

16. The multilayer capacitor according to claim 1, wherein the multilayer body includes first notches extending from the first end surface toward the second end surface.

17. The multilayer capacitor according to claim 1, wherein the multilayer body includes second notches extending from the second end surface toward the first end surface.

18. The multilayer capacitor according to claim 1, wherein each of the first and second outer electrodes includes a base electrode layer and a plating layer on the base electrode layer.

19. The multilayer capacitor according to claim 18, wherein the base electrode layer includes at least one of a baked layer, a conductive resin layer, or a thin film layer.

20. The multilayer capacitor according to claim 18, wherein the plating layer includes a Ni plating layer and an Sn plating layer on the Ni plating layer.
